(19) United States
(12) Patent Application Publication
(10) Pub. No.: US 2026/0019677 A1
(43) Pub. Date: Jan. 15, 2026

(54) INFORMATION PROCESSING APPARATUS AND METHOD

(71) Applicant: Sony Group Corporation, Tokyo (JP)

(72) Inventors: Mitsuhiro HIRABAYASHI, Tokyo (JP); Ryohei TAKAHASHI, Kanagawa (JP); Yusuke NAKAGAWA, Kanagawa (JP); Kentaro YOSHIDA, Kanagawa (JP); Masaki ORIHASHI, Kanagawa (JP); Shuichiro NISHIGORI, Tokyo (JP)

(73) Assignee: Sony Group Corporation, Tokyo (JP)

(21) Appl. No.: 18/992,422

(22) PCT Filed: Jul. 14, 2023
(86) PCT No.: PCT/JP2023/025992

§ 371 Date: Jan. 8, 2025

Related U.S. Application Data
(60) Provisional application No. 63/368,538, filed on Jul. 15, 2022.
(60) Provisional application No. 63/453,217, filed on Mar. 20, 2023.

(51) Int. Cl. H04N 21/472

(52) U.S. Cl. CPC H04N 21/47217

(57) ABSTRACT

The present disclosure relates to information processing apparatus and method that enable media to be interactively processed by a scene description. A scene description in which a description to specify that interactive media are to be interactively played and a description to specify an execution condition and processing contents of the interactive play are present is provided. Then, in a case where an execution condition of interactive play specified in a scene description has been met, interactive media specified to be interactively played in the scene description are interactively played in accordance with processing contents of the interactive play specified in the scene description. The present disclosure can be applied to an information processing apparatus, an information processing method, or the like.

### TECHNICAL FIELD

The present disclosure relates to information processing apparatus and method and, more particularly, relates to information processing apparatus and method that enable media to be interactively processed by a scene description.

### BACKGROUND ART

Conventionally, there has been a GL Transmission Format (glTF) (registered trademark) 2.0 which is a format of a scene description for arranging and rendering three-dimensional (3D) objects in a three-dimensional space (e.g., see Non-Patent Literature 1).

Moreover, in a Moving Picture Experts Group (MPEG)-I Scene Description, a method of extending glTF2.0 and handling dynamic content in a time direction has been proposed (e.g., see Non-Patent Literature 2).

Moreover, technology research and consideration to cope with interactive processing in the MPEG-I Scene Description have been developed (e.g., see Non-Patent Literature 3). Moreover, technology research and consideration for handling haptic media in the MPEG-I Scene Description has been developed in parallel with standardization of a compression and transmission technology for haptic media (e.g., see Non-Patent Literature 4).

Then, standardization of a compression and transmission technology for haptic media that compresses haptic information in addition to audio media and video media which are components of 2D video content, 3DoF video content, or 6DoF video content has been developed (e.g., see Non-Patent Literature 5).

### CITATION LIST

### Non-Patent Literature

Non-Patent Literature 1: Saurabh Bhatia, Patrick Cozzi, Alexey Knyazev, Tony Parisi, “Khronos glTF2.0,” https://github.com/KhronosGroup/glTF/tree/master/specification/2.0, Jun. 9, 2017
Non-Patent Literature 2: “Text of ISO/IEC CD 23090-14 Scene Description for MPEG Media,” ISO/IEC JTC 1/SC 29/WG 3 N00485, 2021 Oct. 12
Non-Patent Literature 3: “Exploration Experiments for the MPEG-I Scene Description,” ISO/IEC JTC 1/SC 29/WG 3 N 0540, 2022 Apr. 29
Non-Patent Literature 4: Quentin Galvane, Eric Vezzoli, Yeshwant Muthusamy, Philippe Guillotel, Titouan Rabu, “Haptic Support extensions for MPEG-I SD,” ISO/IEC JTC 1/SC 29/WG 3 m59268, April 2022
Non-Patent Literature 5: “Considerations for a WD on Haptics,” ISO/IEC JTC 1/SC 29/WG 2 N 0208, 2022 Apr. 29

### DISCLOSURE OF INVENTION

### Technical Problem

In an interactivity framework described in Non-Patent Literature 3, a trigger is defined as an interaction generating condition and an action is defined as an interaction to be generated. In addition, a behavior to enumerate a plurality of triggers and a plurality of actions is defined. For example, MPEG media (MPEG_media) that is an interactive processing target is played in such a framework.

However, in the MPEG-I Scene Description described in Non-Patent Literature 2, definitions of the MPEG media are only startTime and autoPlay. Therefore, it has been difficult to interactively process the MPEG media.

The present disclosure has been made in view of such a situation to enable media to be interactively processed by a scene description.

### Solution to Problem

An information processing apparatus according to an aspect of the present technology is an information processing apparatus including a play unit that interactively plays, in a case where an execution condition of interactive play specified in a scene description has been met, interactive media specified to be interactively played in the scene description in accordance with processing contents of the interactive play specified in the scene description, in which the interactive play is a play method of playing media as interactive processing, and the interactive processing is interaction-type processing of executing the processing contents specified in the scene description in a case where the execution condition specified in the scene description has been met.

An information processing method according to an aspect of the present technology is an information processing method including interactively playing, in a case where an execution condition of interactive play specified in a scene description has been met, interactive media specified to be interactively played in the scene description in accordance with processing contents of the interactive play specified in the scene description, in which the interactive play is a play method of playing media as interactive processing, and the interactive processing is interaction-type processing of executing the processing contents specified in the scene description in a case where the execution condition specified in the scene description has been met.

An information processing apparatus according to another aspect of the present technology is an information processing apparatus including a providing unit that provides a scene description in which a description to specify that interactive media are to be interactively played and a description to specify an execution condition and processing contents of the interactive play are present, in which the interactive play is a play method of playing media as interactive processing, and the interactive processing is interaction-type processing of executing the processing contents specified in the scene description in a case where the execution condition specified in the scene description has been met.

An information processing method according to another aspect of the present technology is an information processing method including providing a scene description in which a description to specify that interactive media are to be interactively played and a description to specify an execution condition and processing contents of the interactive play are present, in which the interactive play is a play method of playing media as interactive processing, and the interactive processing is interaction-type processing of executing the processing contents specified in the scene description in a case where the execution condition specified in the scene description has been met.

In the information processing apparatus and method according to the aspects of the present technology, in a case where the execution condition of the interactive play specified in the scene description has been met, the interactive media specified to be interactively played in the scene description are interactively played in accordance with the processing contents of the interactive play specified in the scene description.

In information processing apparatus and method according to another aspect of the present technology, the scene description in which the description to specify that interactive media are to be interactively played and the description to specify the execution condition and the processing contents of the interactive play are present is provided.

### BRIEF DESCRIPTION OF DRAWINGS

FIG. 1 A diagram showing a main configuration example of glTF2.0.

FIG. 2 A diagram showing an example of glTF objects and referencing relationships.

FIG. 3 A diagram showing a description example of a scene description.

FIG. 4 A diagram describing an access method to binary data.

FIG. 5 A diagram showing a description example of the scene description.

FIG. 6 A diagram describing a relationship between a buffer object, a buffer view object, and an accessor object.

FIG. 7 A diagram showing a description example of the buffer object, the buffer view object, and the accessor object.

FIG. 8 A diagram describing a configuration example of objects in the scene description.

FIG. 9 A diagram showing a description example of the scene description.

FIG. 10 A diagram describing an extension method for objects.

FIG. 11 A diagram describing a configuration of client processing.

FIG. 12 A diagram showing a configuration example of an extension for handling timed metadata.

FIG. 13 A diagram showing a description example of the scene description.

FIG. 14 A diagram showing a description example of the scene description.

FIG. 15 A diagram showing a configuration example of extension for handling the timed metadata.

FIG. 16 A diagram showing a main configuration example of a client.

FIG. 17 A flowchart describing an example of a flow of client processing.

FIG. 18 A diagram describing definitions of MPEG media.

FIG. 19 A diagram describing definitions of the MPEG media.

FIG. 20 A diagram describing definitions of the MPEG media.

FIG. 21 A diagram describing definitions of the MPEG media.

FIG. 22 A diagram describing an MPEG-I scene description interactivity framework.

FIG. 23 A diagram describing the overview of an interaction function.

FIG. 24 A diagram describing an architecture of a trigger and an action.

FIG. 25 A diagram describing definitions of the trigger.

FIG. 26 A diagram describing definitions of the action.

FIG. 27 A diagram describing definitions of the action.

FIG. 28 A diagram describing definitions of a behavior.

FIG. 29 A diagram showing an example of an extended structure of MPEG_scene_interaction.

FIG. 30 A diagram showing an example of a processing model.

FIG. 31 A diagram showing an example of the processing model.

FIG. 32 A diagram showing an extension example of the scene description for handling haptic media.

FIG. 33 A diagram showing an example of MPEG haptics.

FIG. 34 A diagram describing the overview of encoding of the haptic media.

FIG. 35 A diagram showing a configuration example of a binary header.

FIG. 36 A diagram showing an example of semantics of haptic file metadata.

FIG. 37 A diagram showing an example of semantics of avatar metadata.

FIG. 38 A diagram showing an example of semantics of perception metadata.

FIG. 39 A diagram showing an example of semantics of reference device metadata.

FIG. 40 A diagram showing an example of semantics of a track header.

FIG. 41 A diagram showing an example of semantics of a band header.

FIG. 42 A diagram showing an example of semantics of a transient band body and a curve band body.

FIG. 43 A diagram showing an example of semantics of a wave band body.

FIG. 44 A diagram showing a main configuration example of a general data model.

FIG. 45 A diagram showing an example of device definitions.

FIG. 46 A diagram showing an example of device definitions stored in a track.

FIG. 47 A diagram showing an example of band definitions.

FIG. 48 A diagram showing an example of effect definitions.

FIG. 49 A diagram showing an extension example of a media item in the scene description.

FIG. 50 A diagram showing an extension example of the media item in the scene description.

FIG. 51 A diagram showing an extension example of the interactive media.

FIG. 52 A diagram showing an extension example of the interactive media.

FIG. 53 A diagram showing an extension example of the interactive media.

FIG. 54 A diagram showing an extension example of the interactive media.

FIG. 55 A diagram showing an extension example of the interactive media.

FIG. 56 A diagram showing an extension example of the interactive media.

FIG. 57 A diagram showing an extension example of the interactive media.

FIG. 58 A diagram showing an extension example of the interactive media.

FIG. 59 A diagram showing an extension example of an action type.

FIG. 60 A diagram showing an extension example of parameters for setup.

FIG. 61 A diagram showing an extension example of the action type.

FIG. 62 A diagram showing an extension example of parameters for preliminary processing.

FIG. 63 A diagram showing an extension example of behavior definitions.

FIG. 64 A diagram showing an extension example of MPEG_scene_interactivity.

FIG. 65 A diagram showing an extension example of the behavior definitions.

FIG. 66 A block diagram showing a main configuration example of a file generation apparatus.

FIG. 67 A flowchart showing an example of a flow of a file generation processing.

FIG. 68 A flowchart showing an example of the flow of the file generation processing.

FIG. 69 A flowchart showing an example of the flow of the file generation processing.

FIG. 70 A flowchart showing an example of the flow of the file generation processing.

FIG. 71 A flowchart showing an example of the flow of the file generation processing.

FIG. 72 A flowchart showing an example of the flow of the file generation processing.

FIG. 73 A flowchart showing an example of the flow of the file generation processing.

FIG. 74 A flowchart showing an example of the flow of the file generation processing.

FIG. 75 A block diagram showing a main configuration example of a client apparatus.

FIG. 76 A flowchart showing an example of a flow of play processing.

FIG. 77 A flowchart showing an example of a flow of 3D object content play processing.

FIG. 78 A flowchart showing an example of a flow of interactive play processing.

FIG. 79 A flowchart showing an example of the flow of the interactive play processing.

FIG. 80 A flowchart showing an example of the flow of the interactive play processing.

FIG. 81 A flowchart showing an example of the flow of the interactive play processing.

FIG. 82 A flowchart showing an example of the flow of the interactive play processing.

FIG. 83 A block diagram showing a main configuration example of a computer.

### MODE(S) FOR CARRYING OUT THE INVENTION

Hereinafter, modes for carrying out the present disclosure (hereinafter, referred to as embodiments) will be described. It should be noted that the descriptions will be given in the following order.
1. Documents, etc. that Support Technical Contents and Technical Terminology
2. Interactive Play Control
3. Media Definition Extension for Interactive Play
4. First Embodiment (File Generation Apparatus)
5. Second Embodiment (Client Apparatus)
6. Appendix

### 1. DOCUMENTS, ETC. THAT SUPPORT TECHNICAL CONTENTS AND TECHNICAL TERMINOLOGY

The scope disclosed by the present technology includes not only the contents described in the embodiments, but also the contents described in Non-Patent Literatures below and the like which are well-known at the date of filing this application and the contents of other documents and the like referenced in Non-Patent Literatures below.
Non-Patent Literature 1: (mentioned above)
Non-Patent Literature 2: (mentioned above)
Non-Patent Literature 3: (mentioned above)
Non-Patent Literature 4: (mentioned above)
Non-Patent Literature 5: (mentioned above)
Non-Patent Literature 6: Yeshwant Muthusamy, Chris Ullrich, Manuel Cruz, “Everything You Wanted to Know About Haptics,” 2022 Mar. 21

That is, the contents described in Non-Patent Literatures above, the contents of the other documents referenced in Non-Patent Literatures above, and the like are also the basis for determining support requirements. It is assumed that for example, even in a case where the syntaxes and terms of glTF2.0, its extensions, and the like which are described in Non-Patent Literatures above are not directly defined in the present disclosure, they fall within the scope of the present disclosure and meet the support requirements for the scope of claims. It is also assumed that, for example, even in a case where technical terminology such as parse (Parsing), the syntax (Syntax), and the semantics (Semantics) are not directly defined in the present disclosure, they also fall within the scope of the present disclosure and meet the support requirements for the scope of claims.

### 2. INTERACTIVE PLAY CONTROL

<glTF2.0>

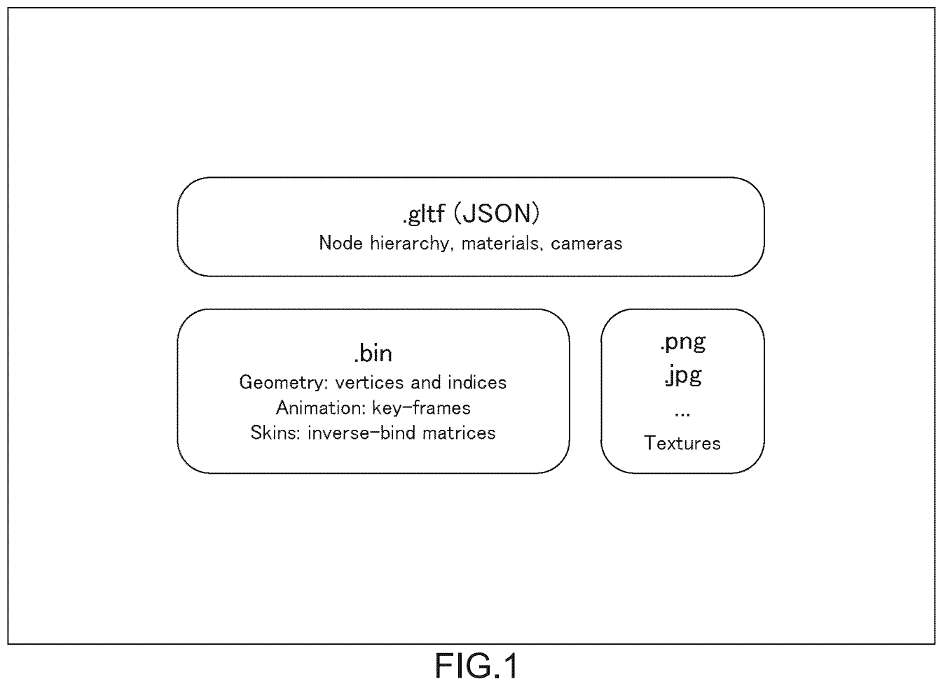

Conventionally, for example, as described in Non-Patent Literature 1, there has been a GL Transmission Format (glTF) (registered trademark) 2.0 that is a format for arranging three-dimensional (3D) objects in a three-dimensional space. GITF2.0 is, for example, as shown in FIG. 1, constituted by a JSON format file (.glTF), a binary file (.bin), and an image file (.png, .jpg, or the like). The binary file stores binary data such as geometry and animation. The image file stores data such as a texture.

The JSON format file is a scene description file described by JavaScript (registered trademark) Object Notation (JSON). The scene description refers to metadata that describes (a description of) a scene of 3D content. By description of this scene description, what the scene is like is defined. The scene description file is a file that stores such a scene description. In the present disclosure, the scene description file will be also referred to as a scene description file.

The description of the JSON format file is constituted by enumeration of pairs of a key (KEY) and a value (VALUE). An example of its form is shown below.
“KEY”:“VALUE”

The key is constituted by a string of characters. The value is constituted by a numeric value, a string of characters, a true/false value, an array, an object, null, or the like.

Moreover, a plurality of keys and a pair of values (“KEY”: “VALUE”) can be combined with { } (curly brackets). Those combined with these curly brackets will be also referred to as a JSON object. An example of its form is shown below.
“user”:{“id”: 1, “name”: “tanaka”}

In a case of this example, as a value corresponding to the key (user), the JSON object that combines a pair of “id”:1 and a pair of “name”:“tanaka” is defined.

Moreover, zero or more values can be changed into an array with [ ] (square brackets). This array will be also referred to as a JSON array. As an element of the JSON array, for example, the JSON object can also be applied. An example of its form is shown below.
test”:[“hoge,” “fuga,” “bar”] “users”:
[{“id”: 1, “name”:“tanaka”}, {“id”:2, “name”:“yamada”}, {“id”:3, “name”:“sato”}]

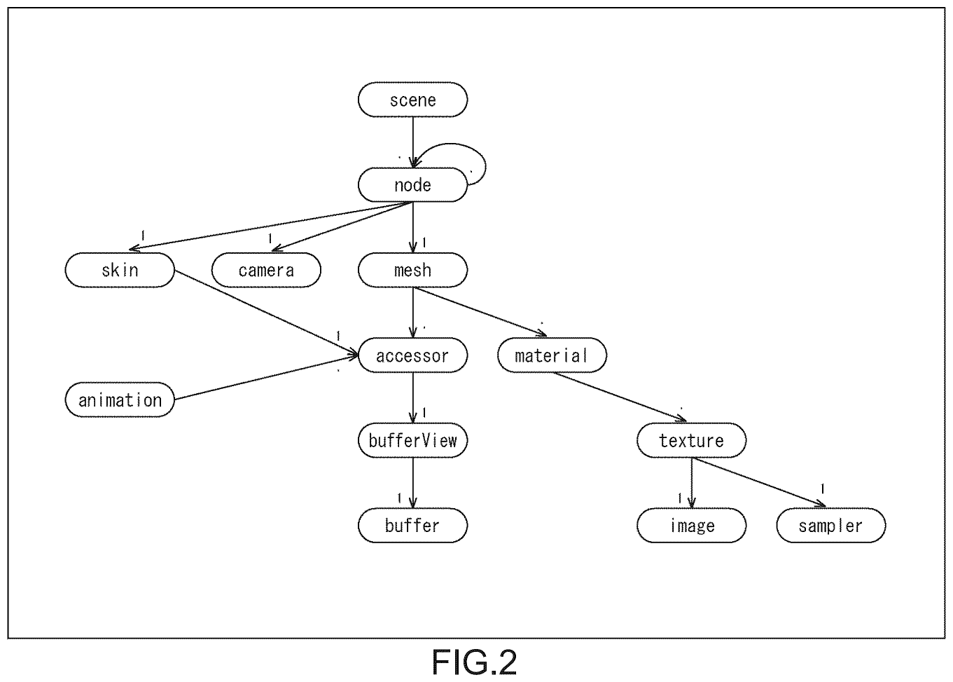

GITF objects that can be described at the top level of the JSON format file and referencing relationships that the glTF objects can have are shown in FIG. 2. Elongated circles of a tree structure shown in FIG. 2 indicate the objects and each arrow between the objects indicate the referencing relationship. As shown in FIG. 2, the objects such as “scene,” “node,” “mesh,” “camera,” “skin,” “material,” and “texture” are described at the top level of the JSON format file.

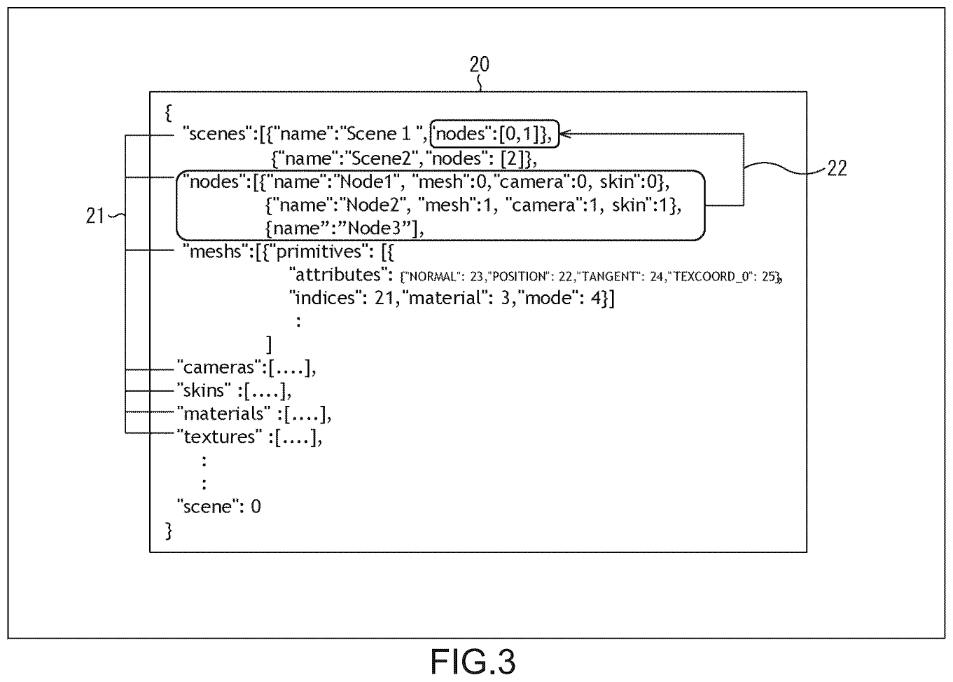

A description example of such a JSON format file (scene description) is shown in FIG. 3. A JSON format file 20 in FIG. 3 shows a description example of a part of the top level. In this JSON format file 20, top-level objects 21 to be used are all described at the top level. These top-level objects 21 are the glTF objects shown in FIG. 2. Moreover, in the JSON format file 20, a referencing relationship between the objects is shown as an arrow 22. More specifically, by specifying an index of an element of an array of an object to be referenced in a property of the uppermost-level object, its referencing relationship is shown.

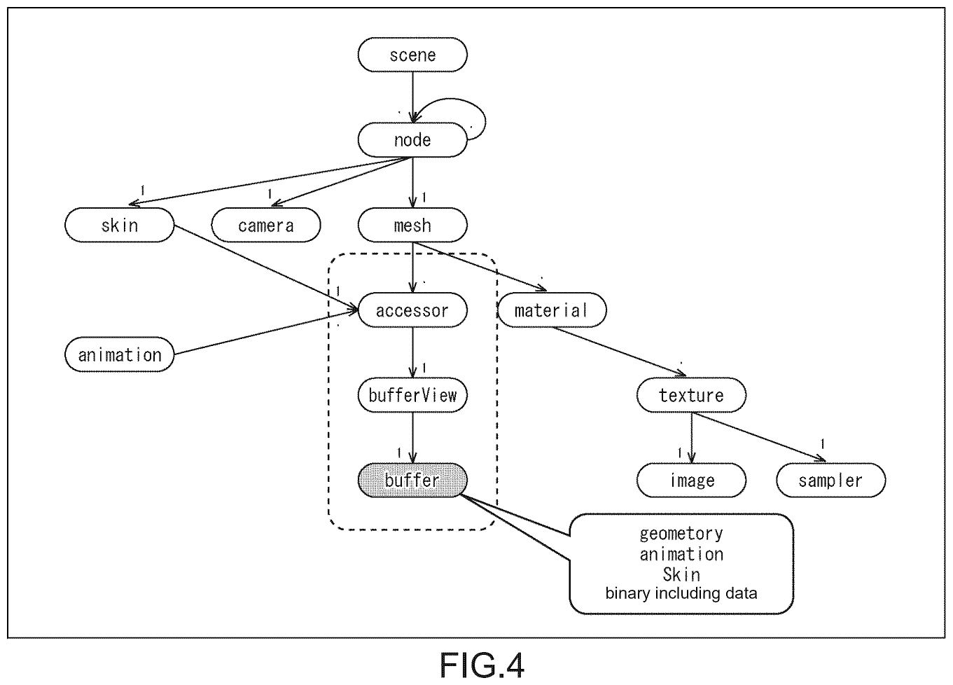

FIG. 4 is a diagram describing an access method to binary data. As shown in FIG. 4, the binary data is stored in a buffer object. That is, information (e.g., Uniform Resource Identifier (URI)) for accessing to the binary data in the buffer object is shown. In the JSON format file, as shown in FIG. 4, for example, from an object such as a mesh, a camera, and a skin, its buffer object can be accessed via an accessor object and a buffer view object (bufferView object).

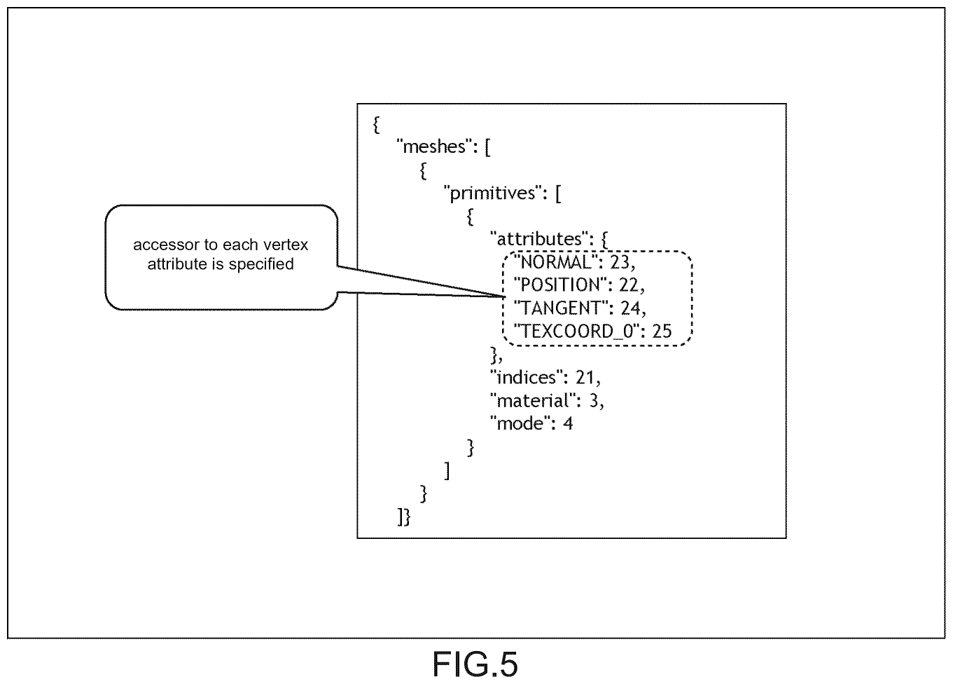

That is, in the object such as the mesh, the camera, or the skin, an accessor object to be referenced is specified. A description example of the mesh object (mesh) in the JSON format file is shown in FIG. 5. For example, as in FIG. 5, in the mesh object, attributes of a vertex, such as NORMAL, POSITION, TANGENT, and TEXCORD_0, are defined as keys and accessor objects to be referenced are specified as values for the respective attributes.

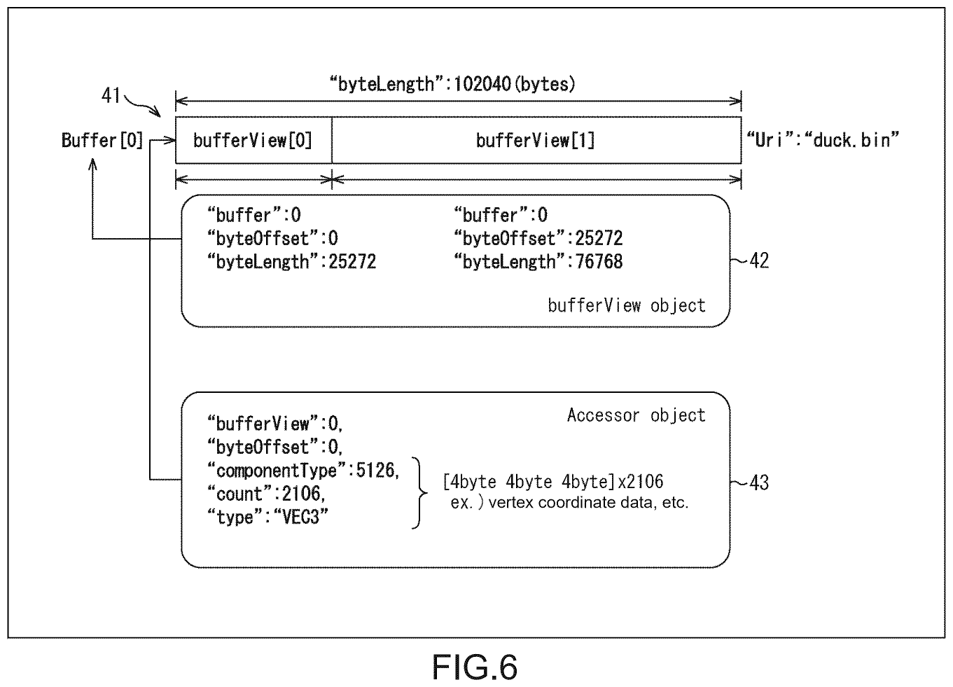

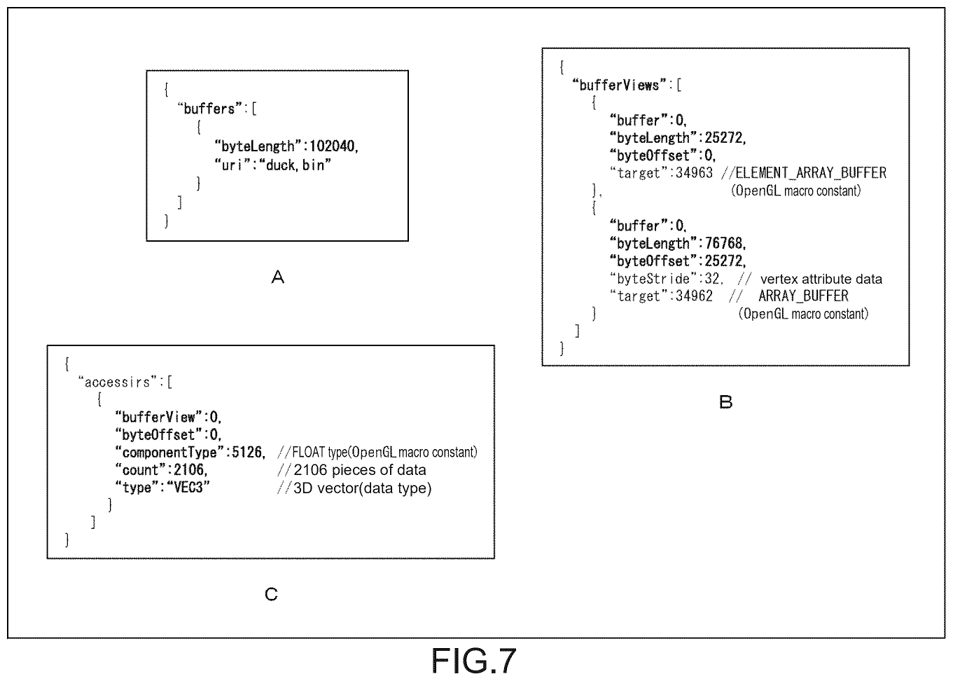

A relationship between the buffer object, the buffer view object, and the accessor object is shown in FIG. 6. Moreover, a description example of those objects in the JSON format file is shown in FIG. 7.

In FIG. 6, a buffer object 41 is an object that stores information (e.g., URI) for accessing to binary data that is real data and information indicating a data length (e.g., byte length) of the binary data. A of FIG. 7 shows a description example of a buffer object 41 thereof. ““bytelength”:102040” shown in A of FIG. 7 indicates that as shown in FIG. 6, the byte length of the buffer object 41 is 102040 bytes. Moreover, ““uri”: “duck.bin”” shown in A of FIG. 7 indicates that as shown in FIG. 6, the URI of the buffer object 41 is “duck.bin.”

In FIG. 6, a buffer view object 42 is an object that stores information regarding a subset area of the binary data specified in the buffer object 41 (i.e., information regarding an area of a part of the buffer object 41). B of FIG. 7 shows a description example of the buffer view object 42. As shown in FIG. 6 and B of FIG. 7, the buffer view object 42 stores information, e.g., identification information of the buffer object 41 to which the buffer view object 42 belongs, an offset (e.g., byte offset) indicating a position of the buffer view object 42 in the buffer object 41, and a length (e.g., byte length) indicating a data length (e.g., byte length) of the buffer view object 42.

In a case where there is a plurality of buffer view objects as shown in B of FIG. 7, information is described for each buffer view object (i.e., for each subset area). For example, information such as ““buffer”:0,” ““bytelength”:25272,” and ““byteOffset”:0,” which are shown on the upper side in B of FIG. 7, is information about a first buffer view object 42 (bufferView[0]) shown in the buffer object 41 in FIG. 6. Moreover, information such as ““buffer”:0,” ““bytelength”:76768,” and ““byteOffset”:25272,” which are shown on the lower side in B of FIG. 7, is information about a second buffer view object 42 (bufferView[1]), which is shown in the buffer object 41 in FIG. 6.

““buffer”:0” of the first buffer view object 42 (bufferView[0]) shown in B of FIG. 7 indicates that as shown in FIG. 6, the identification information of the buffer object 41 to which the buffer view object 42 (bufferView[0]) belongs is “0” (Buffer[0]). Moreover, ““bytelength”:25272” indicates that the byte length of the buffer view object 42 (bufferView[0]) is 25272 bytes. In addition, ““byteOffset”:0” indicates that the byte offset of the buffer view object 42 (bufferView[0]) is 0 bytes. ““buffer”:0” of the second buffer view object 42 (bufferView[1]) shown in B of FIG. 7 indicates that as shown in FIG. 6, the identification information of the buffer object 41 to which the buffer view object 42 (bufferView[0]) belongs is “0” (Buffer[0]). Moreover, ““bytelength”:76768” indicates that the byte length of the buffer view object 42 (bufferView[0]) is 76768 bytes. In addition, ““byteOffset”:25272” indicates that the byte offset of the buffer view object 42 (bufferView[0]) is 25272 bytes.

In FIG. 6, an accessor object 43 is an object that stores information regarding an interpretation method for data of the buffer view object 42. C of FIG. 7 shows a description example of the accessor object 43. As shown in FIG. 6 and C of FIG. 7, the accessor object 43 stores information, e.g., identification information of the buffer view object 42 to which the accessor object 43 belongs, an offset (e.g., byte offset) indicating a position of the buffer view object 42 in the buffer object 41, a component type of the buffer view object 42, the number of pieces of data stored in the buffer view object 42, and the type of data stored in the buffer view object 42. Such information is described for each buffer view object.

In the example in C of FIG. 7, information such as ““bufferView”:0,” ““byteOffset”:0,” ““componentType”:5126,” ““count”:2106,” and ““type”:“VEC3”” is shown. ““bufferView”:0” indicates that as shown in FIG. 6, identification information of the buffer view object 42 to which the accessor object 43 belongs is “0” (bufferView[0]). Moreover, ““byteOffset”:0” indicates that the byte offset of the buffer view object 42 (bufferView[0]) is 0 bytes. In addition, ““componentType”:5126” indicates that the component type is FLOAT-type (OpenGL macro constant). Moreover, ““count”:2106” indicates that the number of pieces of data stored in the buffer view object 42 (bufferView[0]) is 2106. In addition, ““type”:“VEC3”” indicates that (the type of) the data stored in the buffer view object 42 (bufferView[0]) is a three-dimensional vector.

Accesses to data other than the image are all defined by referencing the accessor object 43 (by specifying the index of the accessor).

Next, in a scene description (JSON format file) according to such glTF2.0, a method of specifying a 3D object of a point cloud will be described. The point cloud is 3D content expressing a stereoscopic structure body (object in a three-dimensional shape) as a set of multiple points. The data of the point cloud is constituted by positional information (also referred to as geometry) and attribute information (also referred to as attribute) of each point. The attribute can include any information. For example, color information, reflectance information, normal-line information, and the like of each point may be included in the attribute. Thus, the point cloud has a relatively simple data structure and is capable of expressing any stereoscopic structure body with sufficient accuracy by using a sufficient number of points.

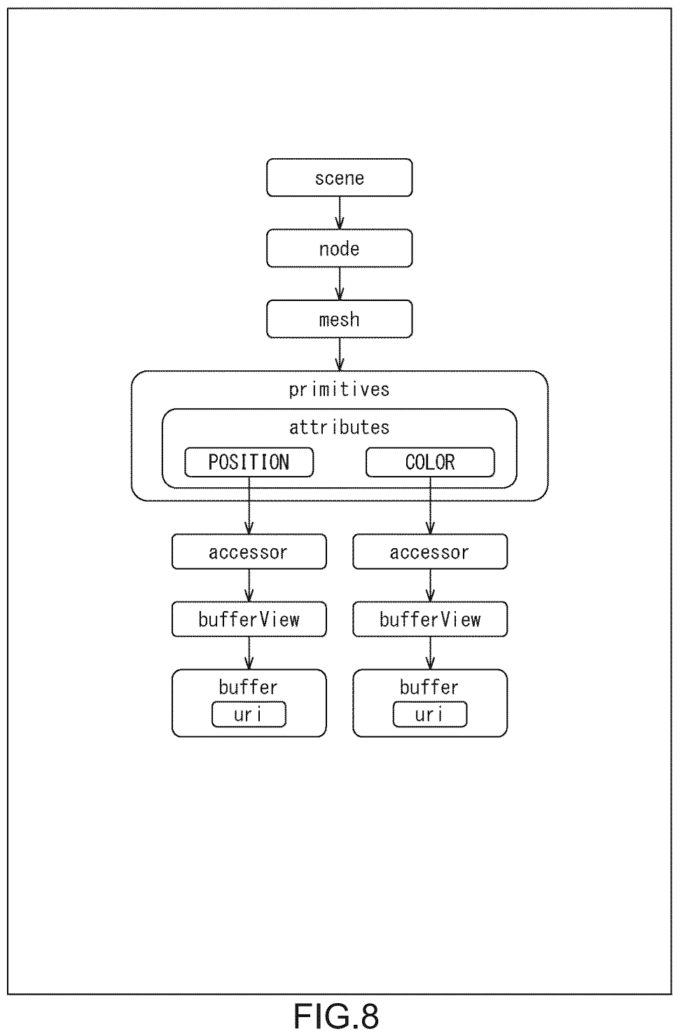

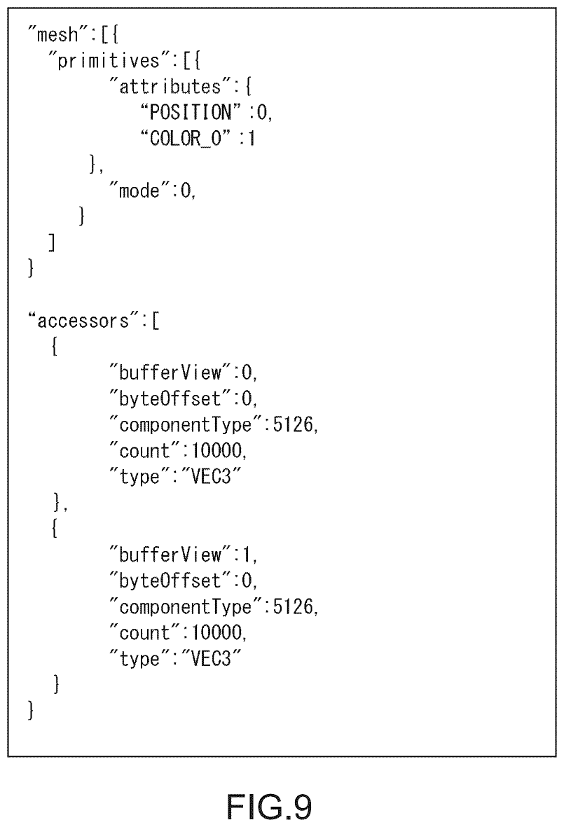

In a case where the point cloud does not change in the time direction (also referred to as being static), the 3D object is specified by using a mesh.primitives object of glTF2.0. FIG. 8 is a diagram showing a configuration example of objects in the scene description in a case where the point cloud is static. FIG. 9 is a diagram showing a description example of the scene description.

As shown in FIG. 9, the mode of the primitives object is specified to be 0 indicating that the data is handled as a point of the point cloud. As shown in FIGS. 8 and 9, in a position property (POSITION property) of an attributes object in the mesh.primitives, an accessor to a buffer that stores the positional information of the point (Point) is specified. Similarly, in a color property (COLOR property) of the attributes object, an accessor to a buffer that stores the color information of the point (Point) is specified. The buffer and a buffer view (bufferView) may be one (data may be stored in a single file).

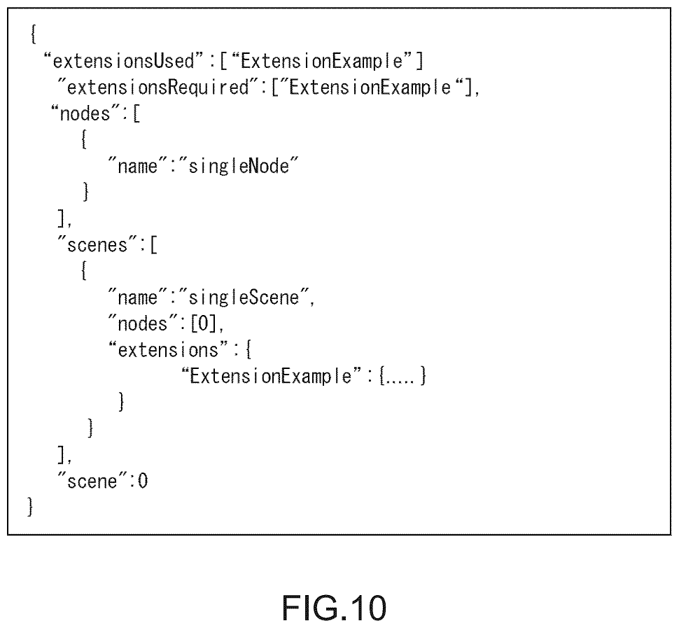

Next, an extension of objects of such a scene description will be described. Each object of glTF2.0 is capable of storing an object newly defined in an extension object. FIG. 10 shows a description example in a case of defining a newly defined object (ExtensionExample). As shown in FIG. 10, in a case of using a newly defined extension, its extension object name (in a case of the example in FIG. 10, ExtensionExample) is described in “extensionUsed” and “extensionRequired.” Accordingly, it indicates that this extension is an extension to be used or that this extension is an extension necessary for load.

### <Client Processing>

Next, processing of a client apparatus in an MPEG-I Scene Description will be described. The client apparatus acquires a scene description, acquires data about a 3D object on the basis of the scene description, and generates a display image by using the scene description and the data about the 3D object.

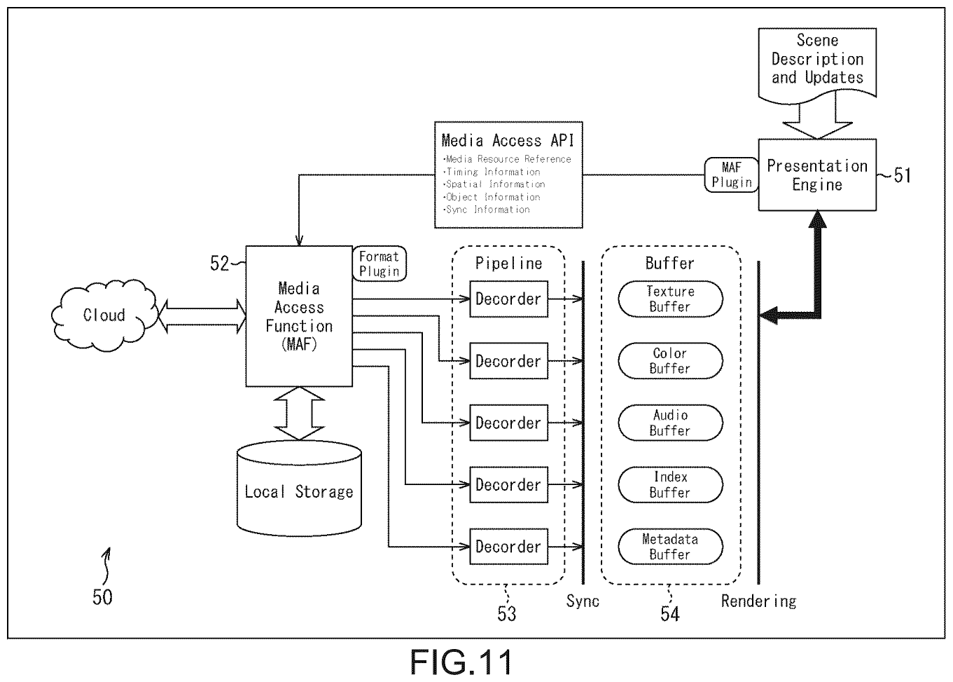

As described in Non-Patent Literature 2, in the client apparatus, a presentation engine, a media access function, and the like perform processing. For example, as shown in FIG. 11, a presentation engine 51 of a client apparatus 50 acquires an initial value of a scene description and information (hereinafter, also referred to as update information) for updating the scene description and generates a scene description of a processing target time. Then, the presentation engine 51 analyzes the scene description and identifies media to be played (moving images, sounds, and the like). Then, the presentation engine 51 requests a media access function 52 to acquire the media via a media access application program interface (API). Moreover, the presentation engine 51 also performs setting of pipeline processing, specification of a buffer, and the like.

A media access function 52 acquires various types of data of the media requested by the presentation engine 51 from a cloud, local storage, or the like. The media access function 52 provides various types of data (encoded data) of the acquired media to a pipeline 53.

The pipeline 53 decodes the various types of provided data (encoded data) of the media by the pipeline processing and provides the decoding result to a buffer (Buffer) 54. The buffer 54 retains the various types of provided data of the media.

The presentation engine 51 performs rendering and the like by using the various types of data of the media retained in the buffer 54.

### <Application of Timed Media>

In recent years, for example, as shown in Non-Patent Literature 2, extending glTF2.0 in an MPEG-I Scene Description and applying timed media (Timed media) as 3D object content have been considered. The timed media refers to media data that changes in the time axis direction as in a moving image of two-dimensional images.

GITF has been applicable only to still image data as media data (3D object content). That is, glTF has not been adapted for media data of a moving image. In a case of moving a 3D object, an animation (method of switching still images along the time axis) has been applied.

In the MPEG-I Scene Description, applying the glTF2.0, applying a JSON format file as a scene description, and extending glTF so that timed media (e.g., video data) can be handled as the media data have been considered. In order to handle the timed media, for example, the following extension is performed.

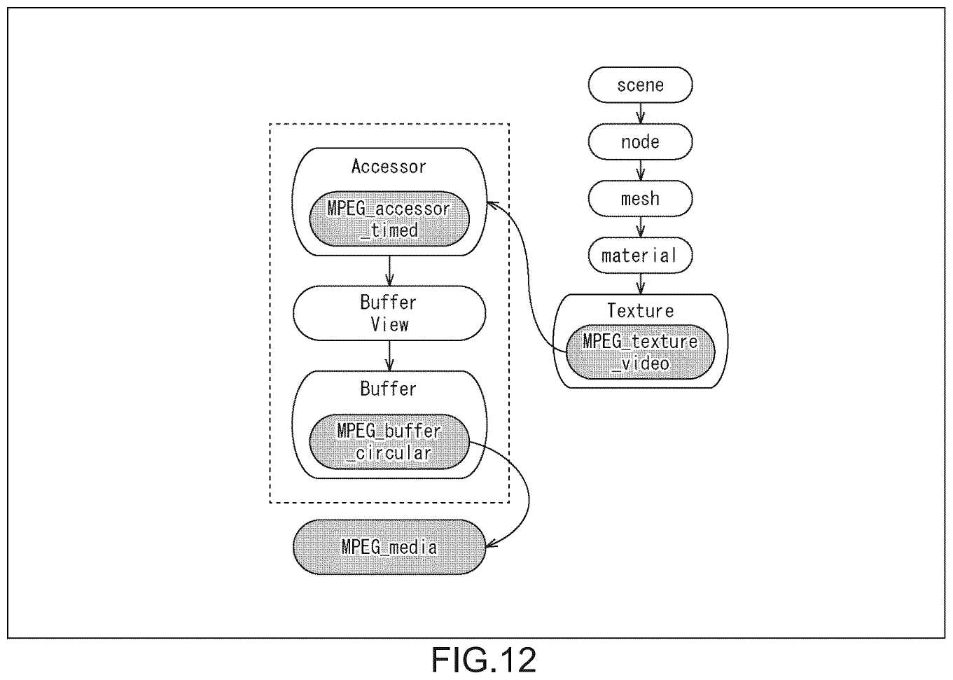

FIG. 12 is a diagram describing an extension for handling timed media. In the example of FIG. 12, the MPEG media object (MPEG_media) is an extension of glTF and is an object that specifies attributes of the MPEG media such as video data, e.g., uri, track, renderingRate, and startTime.

Moreover, as shown in FIG. 12, an MPEG texture video object (MPEG_texture_video) is provided as an extension object (extensions) of a texture object (texture). In the MPEG_texture_video object, information about an accessor corresponding to a buffer object to be accessed is stored. That is, the MPEG texture video object is an object that specifies an index of an accessor corresponding to a buffer in which a texture media specified by the MPEG media object (MPEG_media) is decoded and stored.

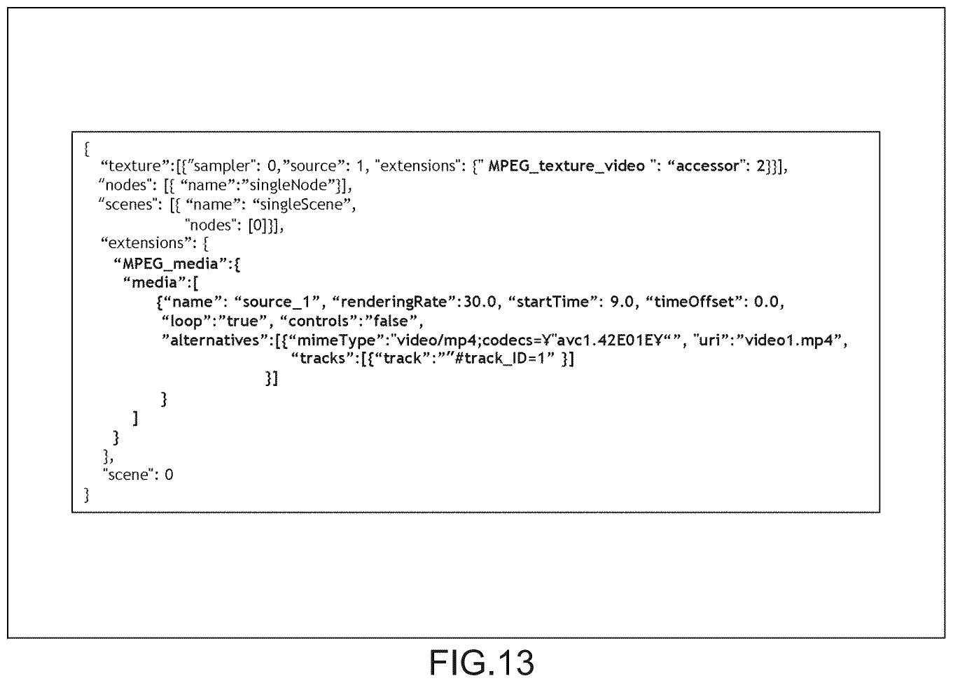

FIG. 13 is a diagram showing a description example of the MPEG media object (MPEG_media) and the MPEG texture video object (MPEG_texture_video) in the scene description for describing the extension for handling timed media. In a case of the example in FIG. 13, an MPEG texture video object (MPEG_texture_video) has been set as an extension object (extensions) of a texture object (texture) in the second line from above as described below. Then, an index of the accessor (in this example, “2”) has been specified as a value of the MPEG video texture object.

“texture”:[{“sampler”:0, “source”:1, “extensions”:{“MPEG_texture_video”: “accessor”:2}}],

Moreover, in a case of the example in FIG. 13, as an extension object (extensions) of glTF, an MPEG media object (MPEG_media) has been set in the seventh line to the sixteenth line from above as described below. Then, as a value of the MPEG media object, various types of information regarding the MPEG media object, e.g., encoding and URI of the MPEG media object, have been stored.
“MPEG_media”:{
“media”:[{
“name”:“source 1,” “renderingRate”:30.0,
“startTime”:9.0, “timeOffset”:0.0,
“loop”:“true,” “controls”: “false,”
“alternatives”:[{“mimeType”: “video/mp4; codecs=
¥“avc1.42E01E¥”,” “uri”:“video1.mp4,”
“tracks”:[{“track”:““#track_ID=1”}]
}]
}
]
}

Moreover, although respective pieces of frame data are decoded and sequentially stored in the buffer, their positions and the like change, and therefore a system of storing the changed information in the scene description so that a renderer can read out the data is provided. For example, as shown in FIG. 12, an MPEG buffer circular object (MPEG_buffer_circular) is provided as an extension object (extensions) of a buffer object (buffer). In the MPEG buffer circular object, information for dynamically storing the data in the buffer object is stored. For example, information such as information indicating a data length of a buffer header (bufferHeader) and information indicating the number of frames are stored in the MPEG buffer circular object. It should be noted that the buffer header stores information, e.g., an index and time stamp and data length of frame data to be stored.

Moreover, as shown in FIG. 12, an MPEG accessor timed object (MPEG_timed_accessor) is provided as an extension object (extensions) of an accessor object (accessor). In this case, the media data is a moving image, and therefore a buffer view object (bufferView) to be referenced can change in the time direction (the position can change). In view of this, information indicating the buffer view object to be referenced is stored in the MPEG accessor timed object. For example, in the MPEG accessor timed object, information indicating the reference to the buffer view object (bufferView) in which a timed accessor information header (timedAccessor information header) is described is stored. It should be noted that the timed accessor information header is, for example, header information that stores information in the accessor object and the buffer view object that dynamically change.

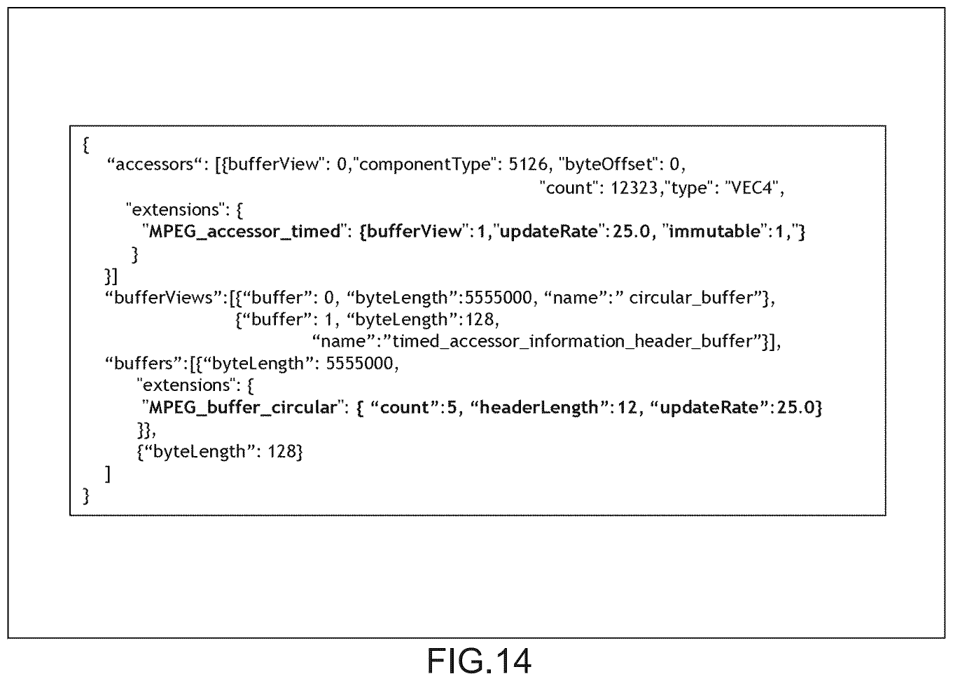

FIG. 14 is a diagram showing a description example of an MPEG buffer circular object (MPEG_buffer_circular) and an MPEG accessor timed object (MPEG_accessor timed) in a scene description for describing the extension for handling timed media. In a case of the example in FIG. 14, an MPEG accessor timed object (MPEG_accessor_timed) has been set as an extension object (extensions) of an accessor object (accessor) in the fifth line from above as described below. Then, as values of the MPEG accessor timed object, parameters such as an index (in this example, “1”), an update rate (updataRate), and immutable information (immutable) of the buffer view object and their values have been specified.

“MPEG_accessor_timed”:{“bufferView”:1, “updateRate”:25.0, “immutable”:1,”}

Moreover, in a case of the example in FIG. 14, an MPEG_buffer_circular object (MPEG_buffer_circular) has been set as an extension object (extensions) of the buffer object (buffer) in the thirteenth line from above as described below. Then, parameters such as a buffer frame count (count), a header length (headerLength), and an update rate (updataRate) and their values have been specified as values of the MPEG buffer circular object.

“MPEG_buffer_circular”:{“count”:5, “headerLength”:12, “updateRate”:25.0}

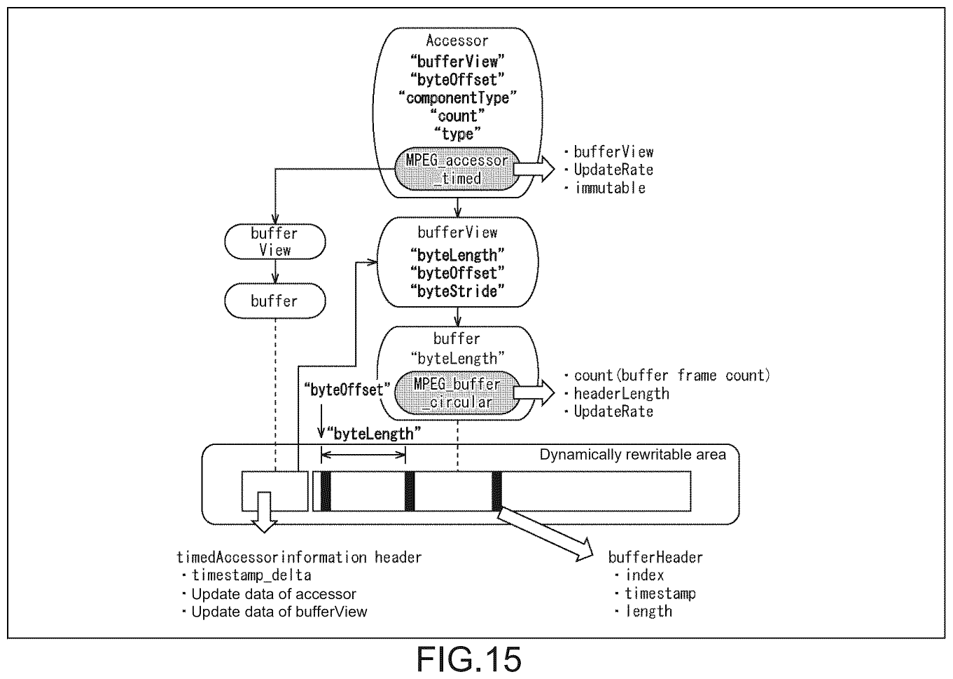

FIG. 15 is a diagram for describing the extension for handling timed media. FIG. 15 shows an example of a relationship between the MPEG accessor timed object and MPEG buffer circular object and the accessor object, buffer view object, and buffer object.

In the MPEG buffer circular object of the buffer object, information necessary for storing data that changes over time in the buffer area indicated by the buffer object, such as a buffer frame count (count), a header length (headerLength), and an update rate (updataRate) as described above, is stored. Moreover, in a buffer header (bufferHeader) that is a header of the buffer area, parameters such as an index (index), a time stamp (timestamp), and a data length (length) are stored.

In the MPEG accessor timed object of the accessor object, information regarding a buffer view object to be referenced, such as an index (bufferView), an update rate (updataRate), and immutable information (immutable) of the buffer view object as described above is stored. Moreover, in this MPEG accessor timed object, information regarding the buffer view object in which the timed accessor information header to be referenced is stored is stored. In the timed accessor information header, time stamp delta (timestamp_delta), update data of the accessor object, update data of the buffer view object, and the like can be stored.

### <Client Processing During Usage of MPEG_texture_video>

The scene description is space arrangement information for arranging one or more 3D objects in a 3D space. This scene description enables its contents to be updated along the time axis. That is, the scene description enables arrangement of 3D objects to be updated along with elapse of time. Client processing performed in the client apparatus at that time will be described.

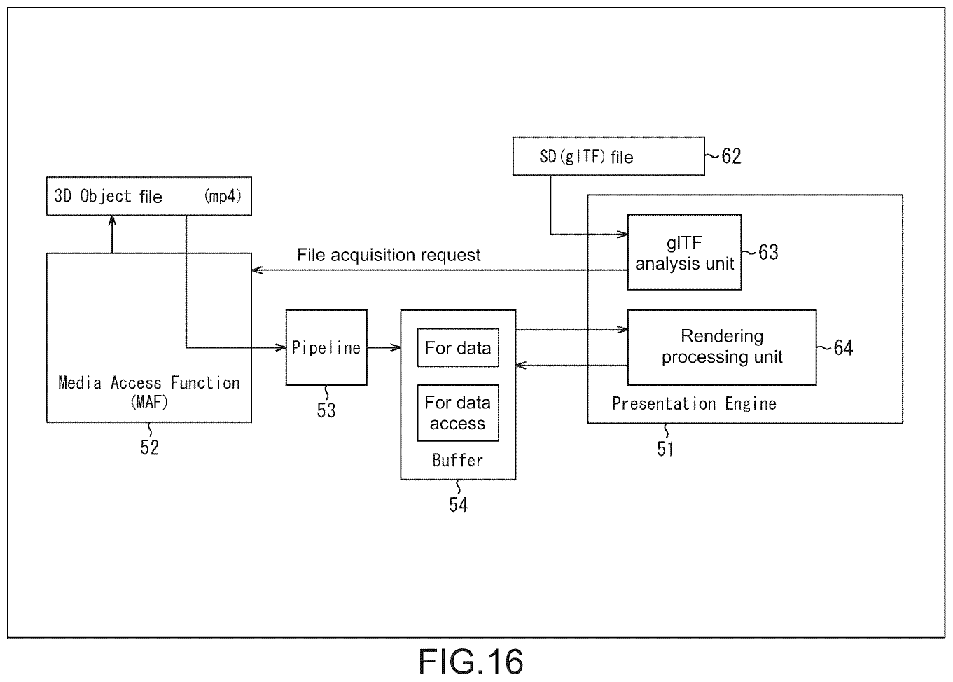

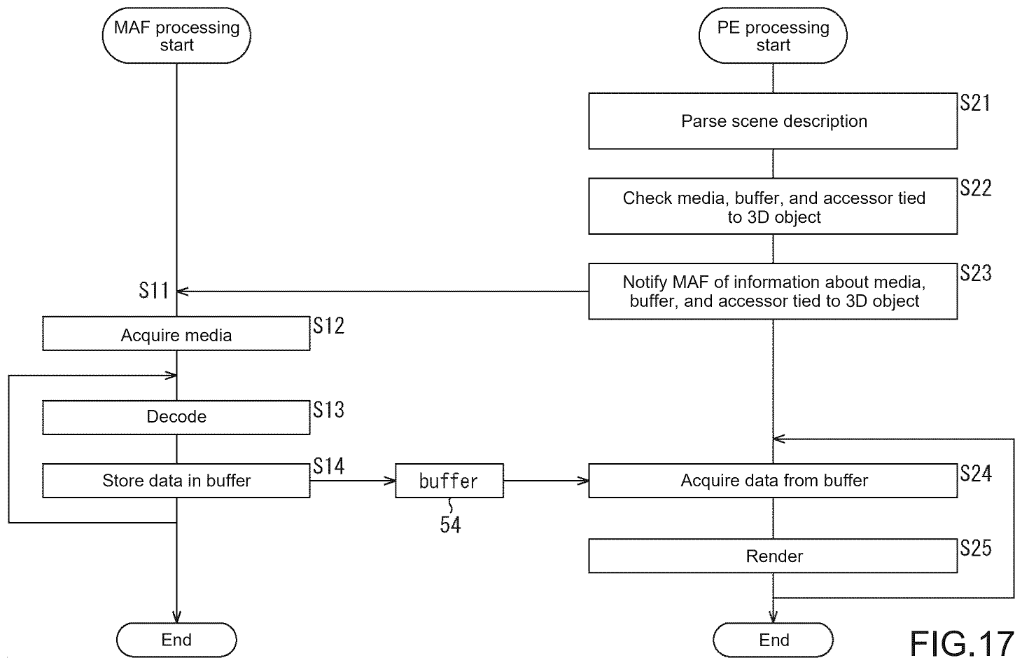

FIG. 16 shows a main configuration example related to the client processing of the client apparatus and FIG. 17 is a flowchart showing an example of a flow of the client processing. As shown in FIG. 16, the client apparatus includes a presentation engine (hereinafter, also referred to as PE) 51, a media access function (hereinafter, also referred to as MAF) 52, a pipeline 53, and a buffer 54. The presentation engine (PE) 51 includes a glTF analysis unit 63 and a rendering processing unit 64.

The presentation engine (PE) 51 causes the media access function 52 to acquire media, acquires the data via the buffer 54, and performs display-related processing and the like. Specifically, for example, the processing is performed in accordance with a flow as follows.

When the client processing has been started, the glTF analysis unit 63 of the presentation engine (PE) 51 starts PE processing as in the example of FIG. 17 and in Step S21, acquires an SD (glTF) file 62 that is a scene description file, and parses the scene description.

In Step S22, the glTF analysis unit 63 checks media tied to a 3D object (texture), a buffer that stores the media after processing, and an accessor. In Step S23, the glTF analysis unit 63 notifies the media access function 52 of that information as a file acquisition request.

The media access function (MAF) 52 starts MAF processing as in the example of FIG. 17 and acquires the notification in Step S11. In Step S12, the media access function 52 acquires media (3D object file (mp4)) on the basis of the notification.

In Step S13, the media access function 52 decodes the acquired media (3D object file (mp4)). In Step S14, the media access function 52 stores data of the media obtained by decoding in the buffer 54 on the basis of a notification from the presentation engine (PE) 51.

In Step S24, the rendering processing unit 64 of the presentation engine 51 reads out (acquires) the data from the buffer 54 at a suitable timing. In Step S25, the rendering processing unit 64 performs rendering by using the acquired data to generate an image to be displayed.

The media access function 52 repeats the processing in Steps S13 and S14, thereby executing such processing with respect to each time (each frame). Moreover, the rendering processing unit 64 of the presentation engine 51 repeats the processing in Steps S24 and S25, thereby executing such processing with respect to each time (each frame). When the processing ends for all frames, the media access function 52 terminates the MAF processing and the presentation engine 51 terminates the PE processing. That is, the client processing ends.

### <Definition of MPEG_Media>

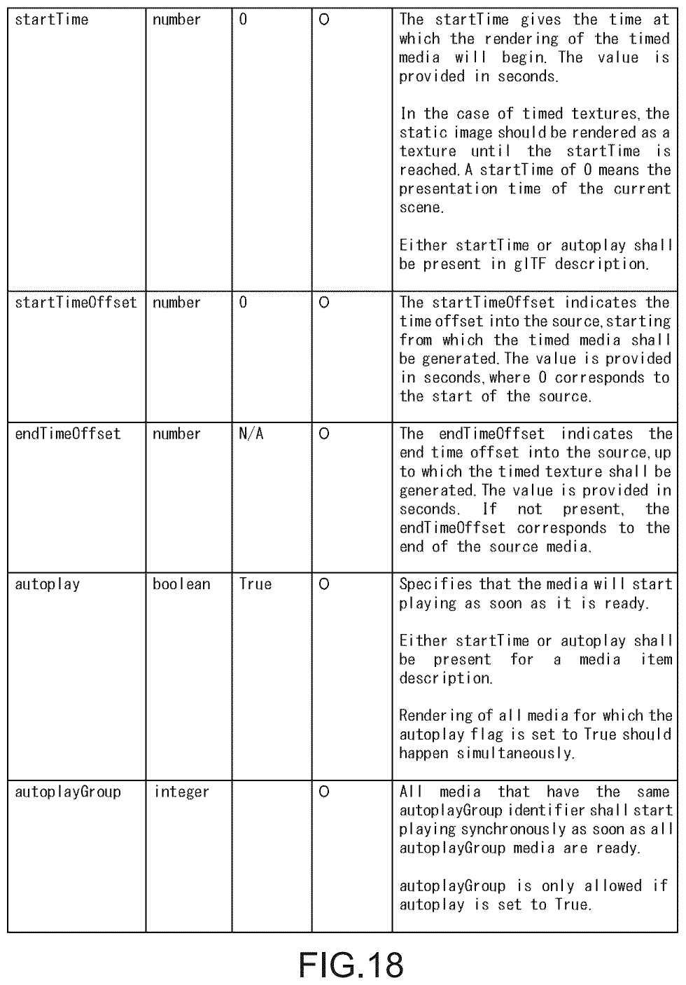

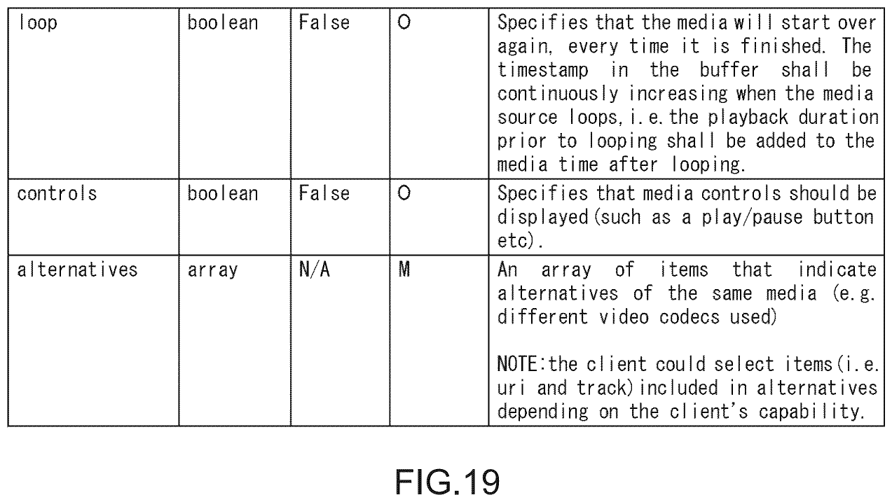

Non-Patent Literature 2 has also described an extension of MPEG media (MPEG_media). The extension of the MPEG media is provided as an array of media items to be referenced in a scene description. An example of definitions of items to be used in a media array of the MPEG media is shown in FIGS. 18 and 19. For example, startTime indicates a time at which rendering the media for which the time has been specified is started. The value is specified in seconds. In a case of a texture for which the time is limited, it is necessary to render a static image until startTime is reached as the texture. In a case where startTime is “0,” it means a presentation time of the current scene. Autoplay specifies to start playing as soon as the media are ready. AutoplayGroup is a function capable of specifying autoplay on a group-by-group basis. Loop specifies loop. Controls specifies display of a user interface related to playing the media. Alternatives indicates an alternative means of the same media (e.g., video codec different from the used one). It should be noted that it is necessary that any of startTime or autoplay is present with respect to a media item.

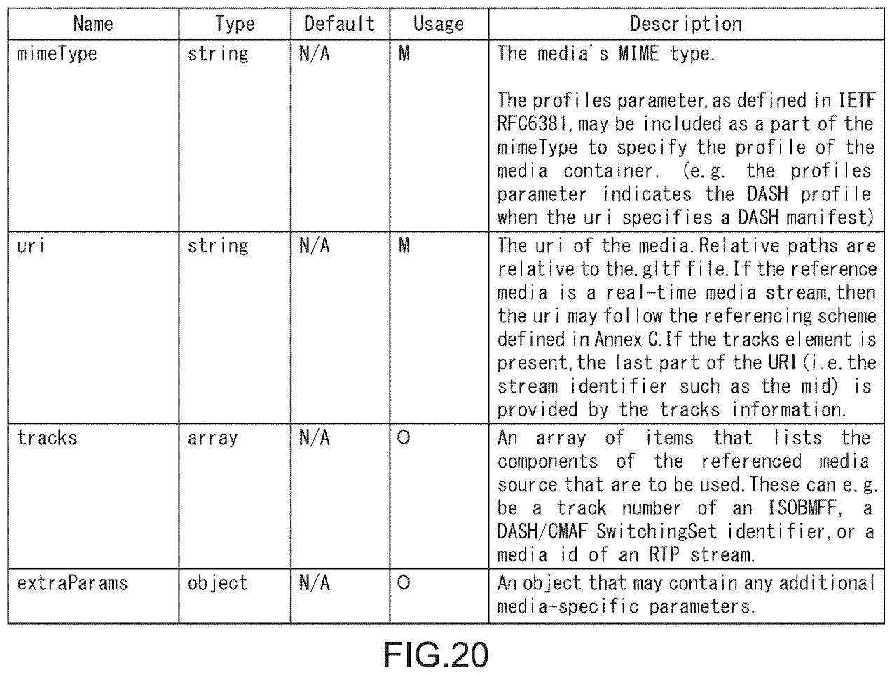

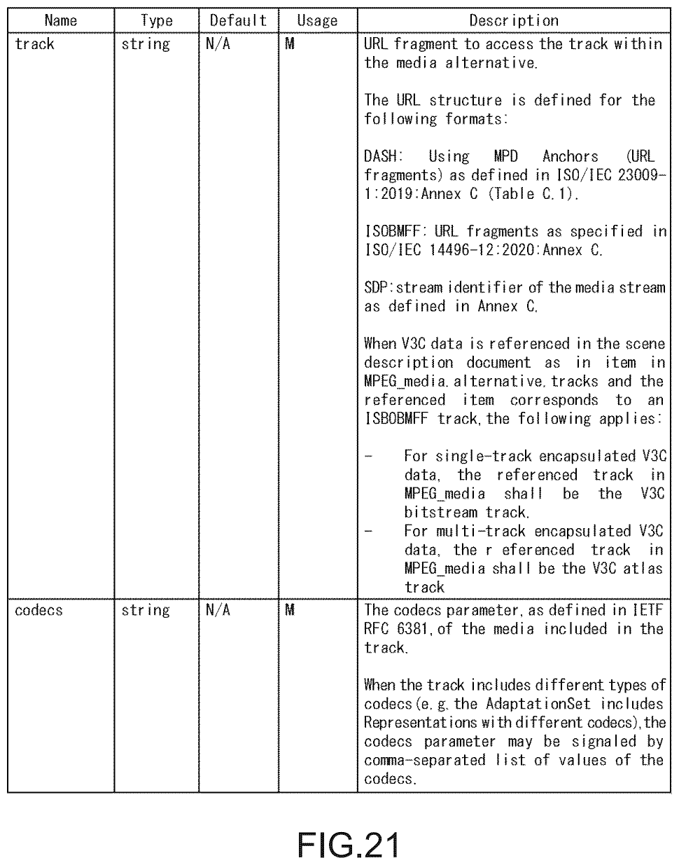

FIG. 20 shows an extension example of the alternative array. In the alternative array, items as defined in FIG. 20 are used. FIG. 21 shows an extension example of a tracks array. In the tracks, items as defined in FIG. 21 are used.

### <MPEG-I Scene Description Interactivity Framework>

In Non-Patent Literature 3, an MPEG-I Scene Description Interactivity Framework has been described. In this framework, interactive processing of the media is defined. The interactive processing refers to interaction-type processing in which media processing (action) is executed, triggered when a certain execution condition has been met. In this framework, this execution condition (trigger) and the processing contents (action) are provided in the scene description (MPEG-I Scene Description). That is, Non-Patent Literature 3 has described a framework for controlling the interactive processing of the media by the scene description.

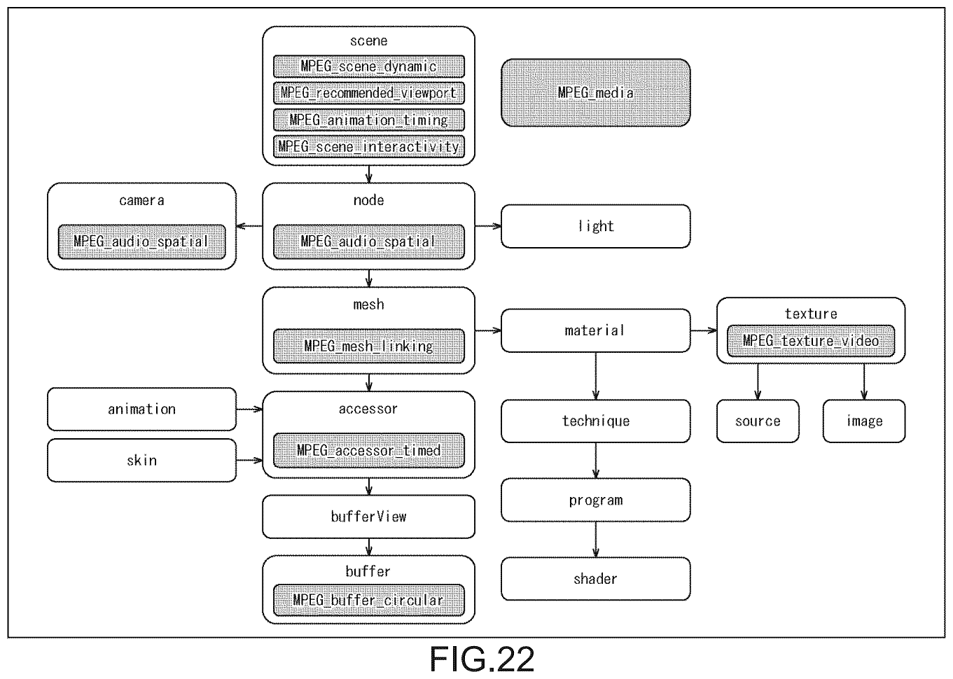

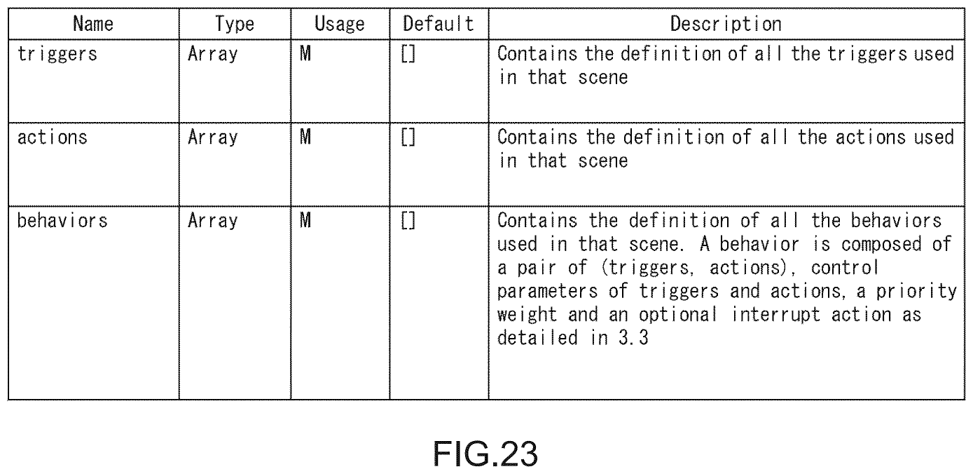

As shown in FIG. 22, a glTF extension function of MPEG interactivity which is called MPEG_scene_interactivity is introduced at a scene level. An extension of this MPEG_scene_interactivity at the scene level has employed an approach of semantics based on the definitions of the behavior, the trigger, and the action. FIG. 23 shows an example of the semantics.

The behavior defines which type of interactivity is allowed at the time of execution with respect to a dedicated virtual object corresponding to a glTF node. The behavior has a function of associating one or more triggers with one or more actions. The trigger defines an execution condition that should be met before executing the action. That is, the trigger indicates an execution condition of the interactive processing. The action defines how operation influences the scene. That is, the action indicates processing contents of the interactive processing. The behavior expresses the interactive processing (what processing is executed under what conditions) by associating the trigger with the action.

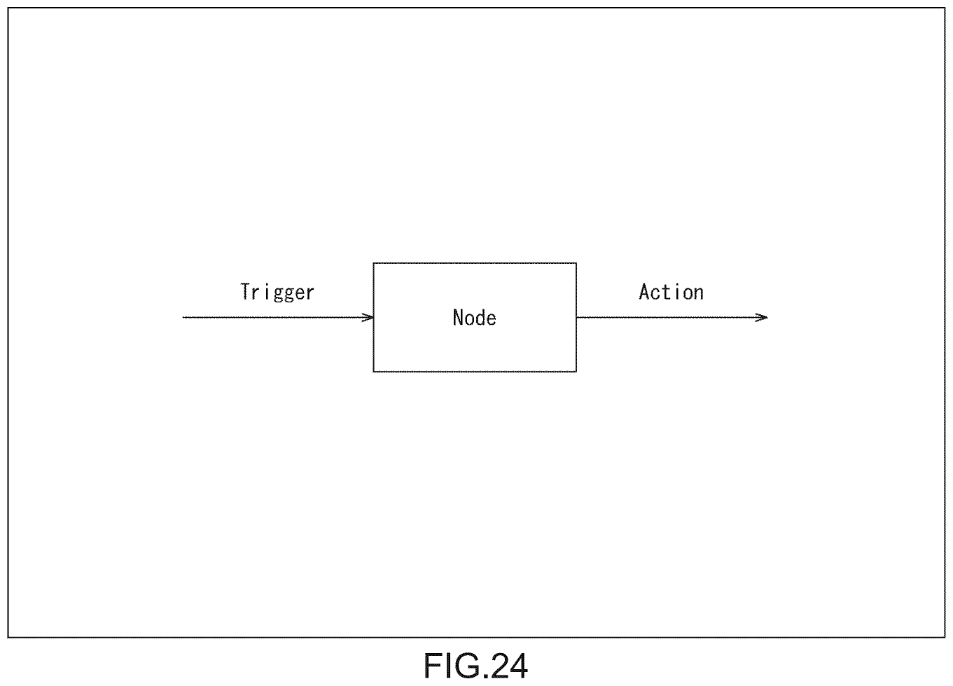

An example of an architecture of the trigger and the action is shown in FIG. 24. When a trigger is provided to a node, an action is sent back. That is, the trigger is an event that triggers some type of interactivity and the action is an interaction-type feedback to the trigger. For example, when a collision between 3D objects has been detected in a (virtual) three-dimensional space, a feedback (interaction-type action) such as an animation, a sound, or a tactile sensation (e.g., a vibration) is sent back.

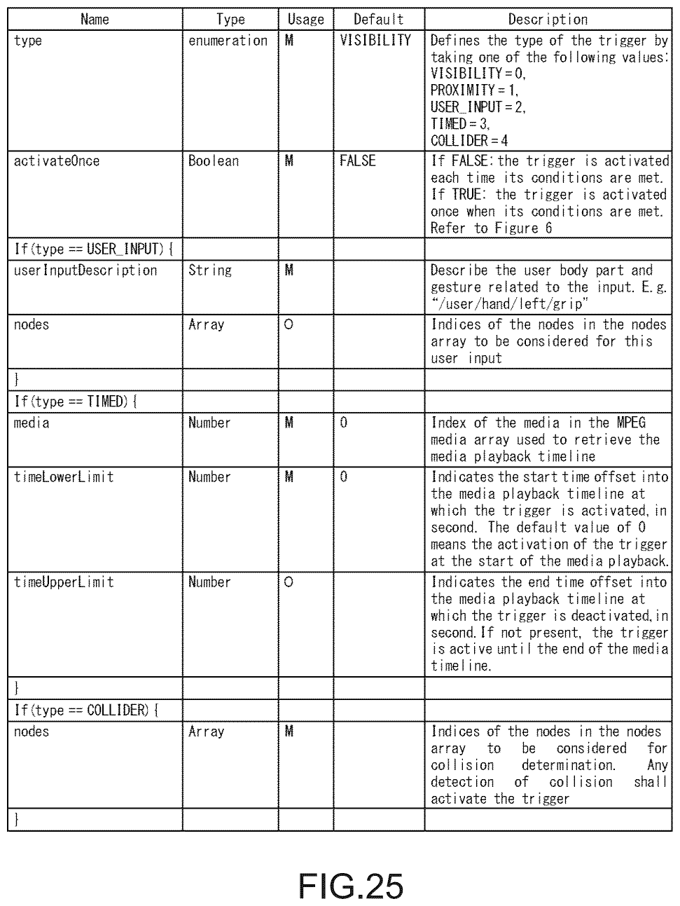

An example of semantics of this trigger is shown in FIG. 25. As shown in FIG. 25, types of execution conditions are defined and details (various items) about each type are also defined. For example, This trigger type includes VISIBIRITY, PROXIMITY, USER_INPUT, TIMED, COLLIDER, and the like. VISIBIRITY is a trigger that is activated by a frustum (angle of view). PROXIMITY is a trigger that is activated by a distance between a virtual scene and an avatar. USER_INPUT is a trigger that is activated by user interaction such as a hand gesture. TIMED is a trigger that is activated by timed media at a particular time. COLLIDER is a trigger that is activated by a collision between objects in a scene.

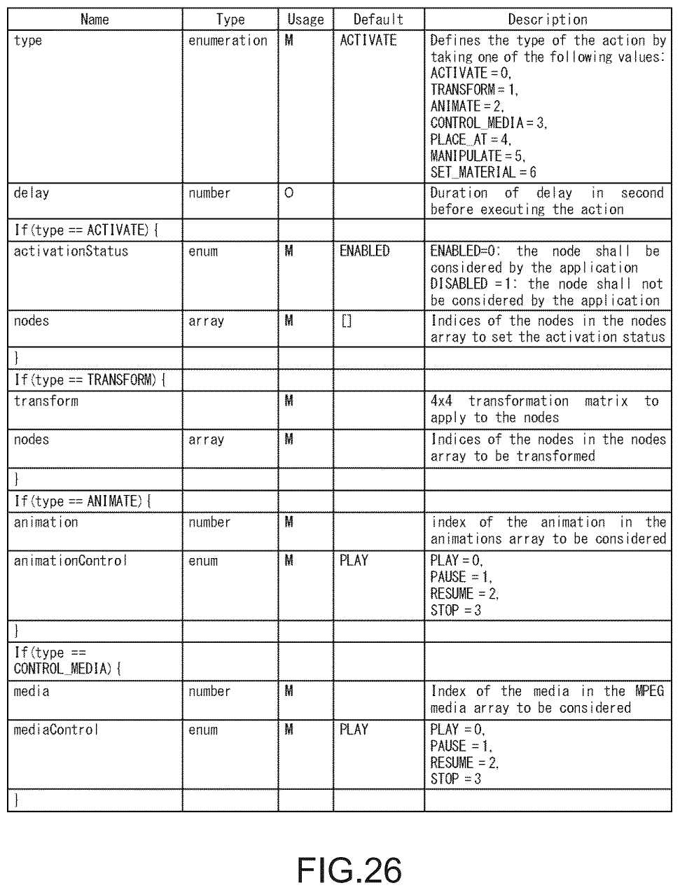

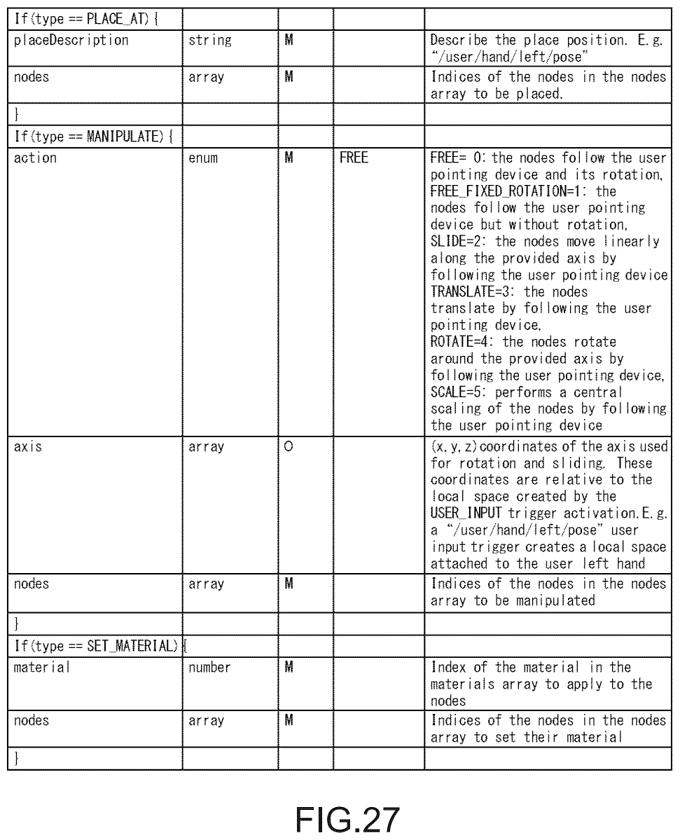

Moreover, an example of semantics of the action is shown in FIGS. 26 and 27. As shown in FIGS. 26 and 27, types of processing contents are defined and details (various items) are defined with respect to each type. For example, this action type includes ACTIVATE, TRANSFORM, ANIMATE, CONTROL_MEDIA, PLACE_AT, MANIPULATE, SET_MATERIAL, and the like. ACTIVATE is an action related to activation by an application with respect to the node. TRANSFORM is an action related to an application of a transformation matrix applied to the node. ANIMATE is an action related to play operations of an animation (e.g., Play, Pause, Resume, and Stop). CONTROL_MEDIA is an action related to play operations of media (e.g., Play, Pause, Resume, and Stop). PLACE_AT is an action related to arranging the node at a specified position. MANIPULATE is an action related to operations (e.g., tracking, movement, translation, rotation, and scale transformation) with respect to the node by a pointing device of the user. SET_MATERIAL is an action related to setting of a material with respect to the node.

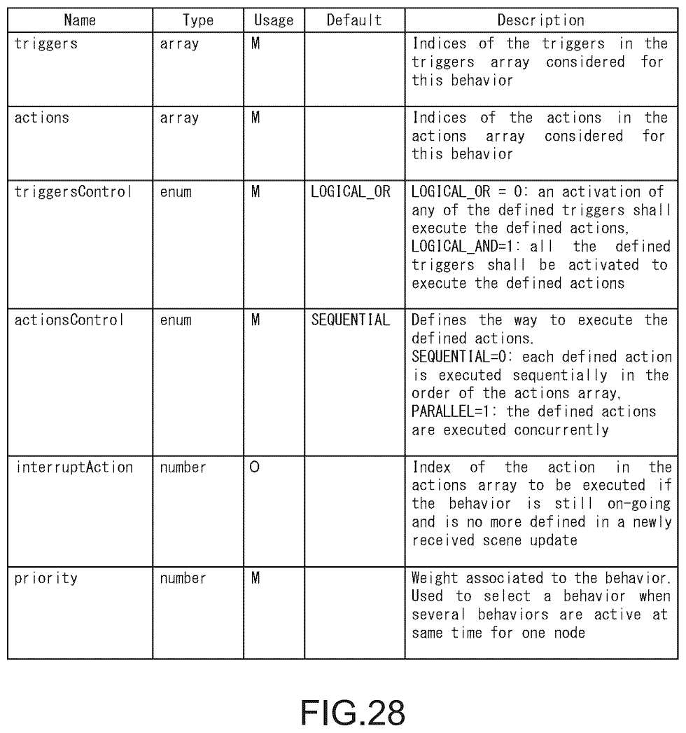

Moreover, an example of semantics of the behavior is shown in FIG. 28. In a behavior, a combination of a trigger and an action is provided. Each of the trigger and the action may be singular or may be plural. That is, execution under a plurality of conditions (and/or) and execution of a plurality of operations (sequential/simultaneous) are possible. Priority indicates a priority in a case where a plurality of behaviors is simultaneously enabled. TriggersControl is flag information indicating combined conditions (AND/OR) of a plurality of triggers (trigger array). ActionsControl is flag information indicating combined patterns of a plurality of actions (action array) (whether to sequentially execute them, whether to execute them in parallel, and the like). InterruptAction is an action to be executed in a case where a behavior is “still-on-going” when updating a scene (SceneUpdate).

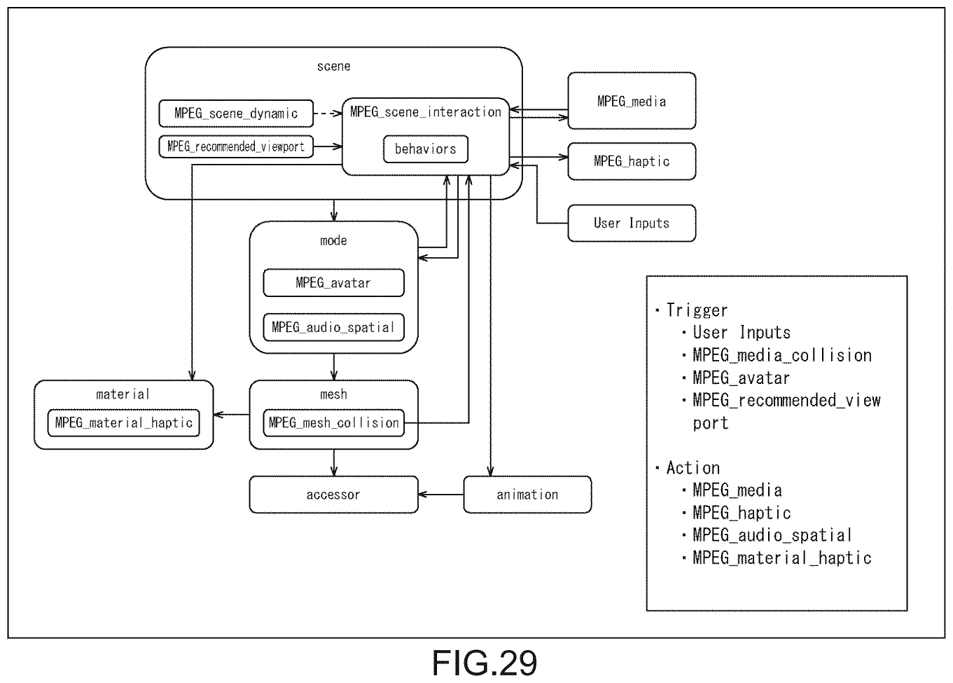

An example of an extended structure of MPEG_scene_interaction is shown in FIG. 29. In FIG. 29, those that can be trigger targets are User Inputs, MPEG_media_collision, MPEG_avatar, and MPEG_recommended_viewport. Moreover, those that can be action targets are MPEG_media, MPEG_haptic, MPEG_audio_spatial, and MPEG_material_haptic.

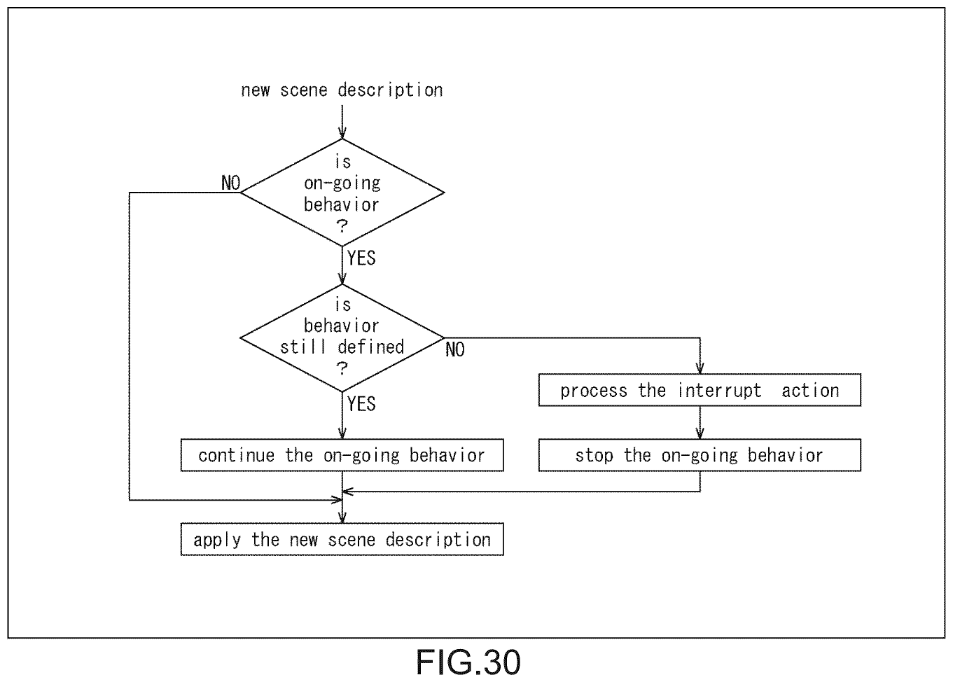

At the time of execution, the application repeats respective defined operations and checks realization of a relative trigger in accordance with the procedure as shown in FIG. 30. First of all, when a defined trigger of a behavior has been activated, the corresponding action is activated. The behavior waits for an “on-going” status for the time from the activation to the completion of the defined action. In a case where a plurality of behaviors simultaneously influences the same node, a behavior with the highest priority is processed with respect to this node. The other behaviors are not simultaneously processed. Such processing is repeatedly executed.

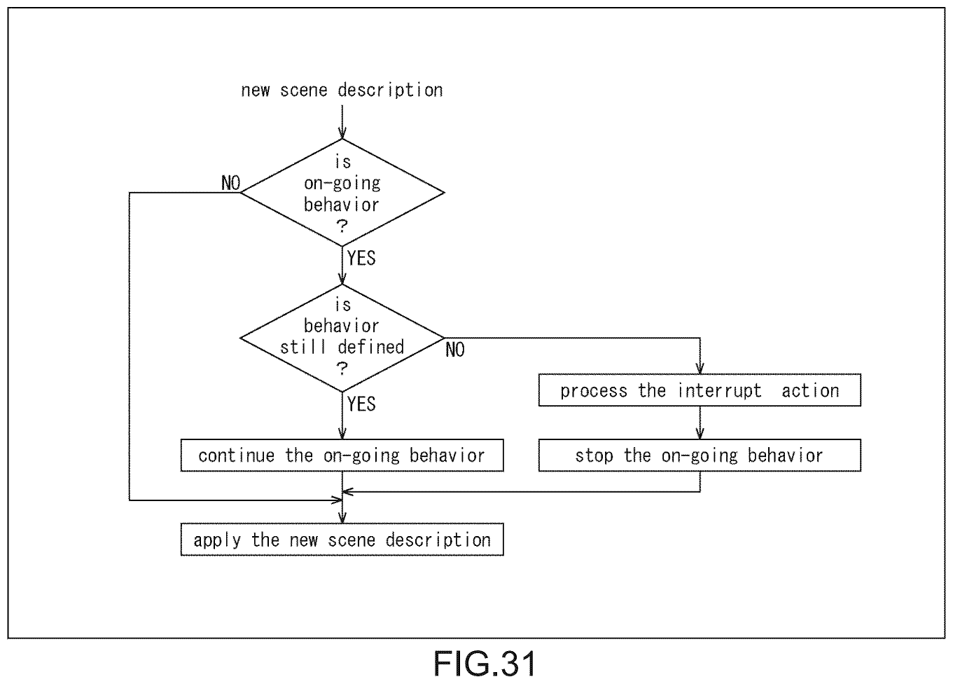

Moreover, when a new scene description is provided, the application performs processing in accordance with the procedure as shown in FIG. 31. In a case where a relative action is under execution when a scene is updated, it is considered that the behavior is on-going. In a case where unique association of a trigger and an action has been described even after the scene is updated, it is considered that the behavior is “still defined.” In a case where the behavior has not been “yet defined,” its interrupt action is executed. When all interrupt actions (if present) have been completed, the application deletes old scene data and considers that new data is identical to the updated scene description.

### <Haptic Media>

By the way, for example, as described in Non-Patent Literature 4, standardization of an encoding and transmission technology for haptic information (also referred to as haptic media) in addition to audio media and video media that are 2D video content and 3 Degree of Freedom (DoF)/6DoF video content components has begun. The haptic media is information that expresses a virtual sensation by using a vibration, for example. The haptic media is used in association with 3D data which is, for example, information that expresses a three-dimensional space. The 3D data includes, for example, content (e.g., a mesh and a point cloud) that expresses a three-dimensional shape of an 3D object arranged in the three-dimensional space, video content and audio content (e.g., video and audio 6DoF content) that are deployed to the three-dimensional space, and the like.

It should be noted that the media associated with the 3D data may be any information and is not limited to this haptic media. For example, images, sounds, and the like may be included in this media. The media associated with the 3D data (e.g., images, sounds, and vibrations) include synchronization-type media that are played in synchronization with the progress (change) of a scene (state of the three-dimensional space) in the time direction and interaction-type media that are played in a case where a predetermined condition is satisfied in a scene such as a user's operation (i.e., played with respect to a predetermined event). Haptic media that are the synchronization-type media will be also referred to as synchronization-type haptic media. Moreover, the haptic media of the interaction-type media will be also referred to as interaction-type haptic media. In a case where, for example, a wind blows or a 3D object moves, the synchronization-type haptic media is a vibration or the like that happens in accordance with its state (to express a changed state of its scene). For example, in a case where a user's avatar touches a 3D object, in a case where the avatar moves the 3D object, or in a case where the avatar hits the 3D object, the interaction-type haptic media is a vibration or the like that happens to express its sensation. As a matter of course, these are examples of the haptic media, and the haptic media are not limited to these examples.

Moreover, the media associated with the 3D data are media that do not change media can change in the time direction.

The “media can change in the time direction” may include, for example, media can change in play contents (action) in the time direction. The “media can change in the play contents in the time direction” may include, for example, a moving image and audio information and vibration information for a long time. Moreover, the “media can change in the play contents in the time direction” may include, for example, media that is played only in a predetermined time zone and media for which contents according to the time are played (e.g., media for which an image to be displayed, a sound to be played, how to vibrate, and the like switch depending on the time). Moreover, the “media can change in the time direction” may include, for example, media can change in a tied play condition (event) in the time direction. The “media can change in the tied play condition in the time direction” may include, for example, media can change in the contents of an event such as touch, push, or push down in the time direction. Moreover, the “media can change in the tied play condition in the time direction” may include, for example, media can change in a position at which the event happens in the time direction. For example, it may include media that is played when touching the right side of the object at a time T1 and played when touching the left side of the object at a time T2. As a matter of course, it may be any media as long as they are those that change in the time direction, and it is not limited to these examples. On the other hand, the “media that does not change in the time direction” may include, for example, media that does not change in play contents (action) in the time direction (media for which the action is the same at any time). Moreover, the “media that does not change in the time direction” may include, for example, media that does not change in a tied play condition (event) in the time direction (media for which the contents of the event and the position at which the event happens are the same at any time). In this specification, the fact that it can change in the time direction will be also referred to as “dynamic.” For example, the media can change in the time direction (Timed media) will be also referred to as dynamic media. For example, the haptic media can change in the time direction will be also referred to as dynamic haptic media. Moreover, the fact that it cannot change in the time direction will be also referred to as “static.” For example, the media that does not change in the time direction will be also referred to as static media. For example, the haptic media that does not change in the time direction will be also referred to as static haptic media.

### <Extension for Haptic Media of Scene Description

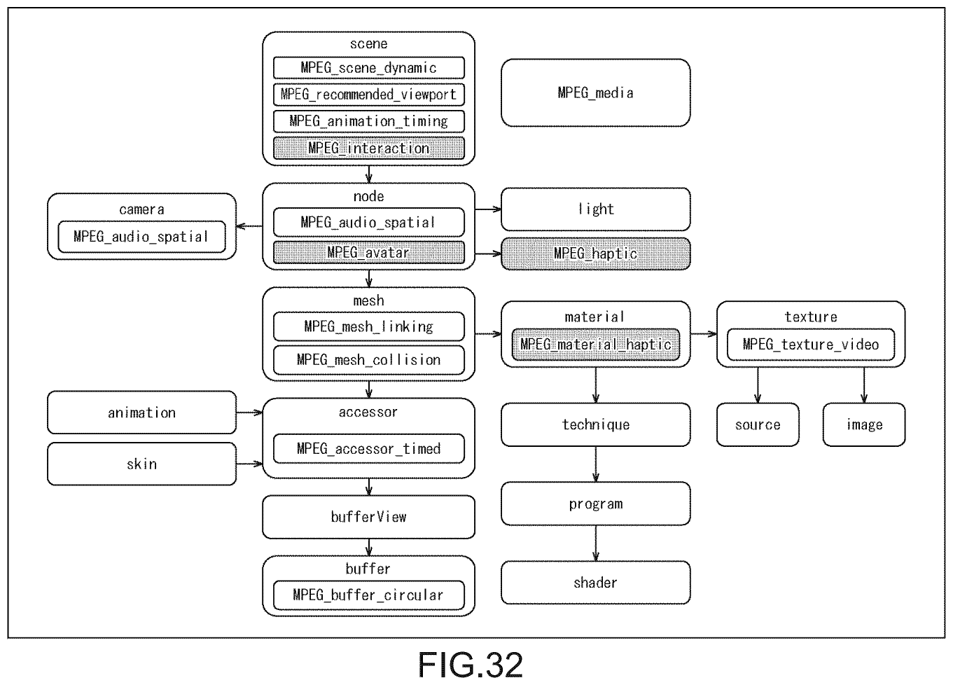

Moreover, as in described in Non-Patent Literature 4, technology research and consideration for handling the haptic media in the MPEG-I Scene Description has begun in parallel with standardization of an encoding and transmission technology for the haptic media. In Non-Patent Literature 4, four gLTFextensions MPEG_haptic, MPEG_material_haptic, MPEG_avatar, and MPEG_interaction as shown in FIG. 32 have been proposed in order to support the haptic media in the scene description.

MPEG_haptic is information (e.g., link information) for referencing data about the haptic media (also referred to as haptic data) to be referenced from the scene description. This haptic data is present as independent data as in data about sounds, images, and the like. Moreover, this haptic data may be encoded (may be encoded data).

MPEG_material_haptic that is mesh/material extension of an already defined 3D object defines haptic material information (e.g., where in the 3D object (mesh) which haptic media is associated). Information about the static haptic media is defined in this material information. Moreover, information for accessing MPEG_haptic (e.g., link information) can also be defined in this haptic material information.

MPEG_avatar defines a 3D shape (avatar) of a user who moves in a three-dimensional space. MPEG_interaction lists up conditions that the avatar (user) is able to execute (those that the user can do) and possible actions (reaction methods for the object). For example, MPEG_interaction defines interaction (i.e., event) to occur between the user (MPEG_avatar) and the 3D object and actions that occurs as a result (e.g., a vibration occurs when the user touches the 3D object).

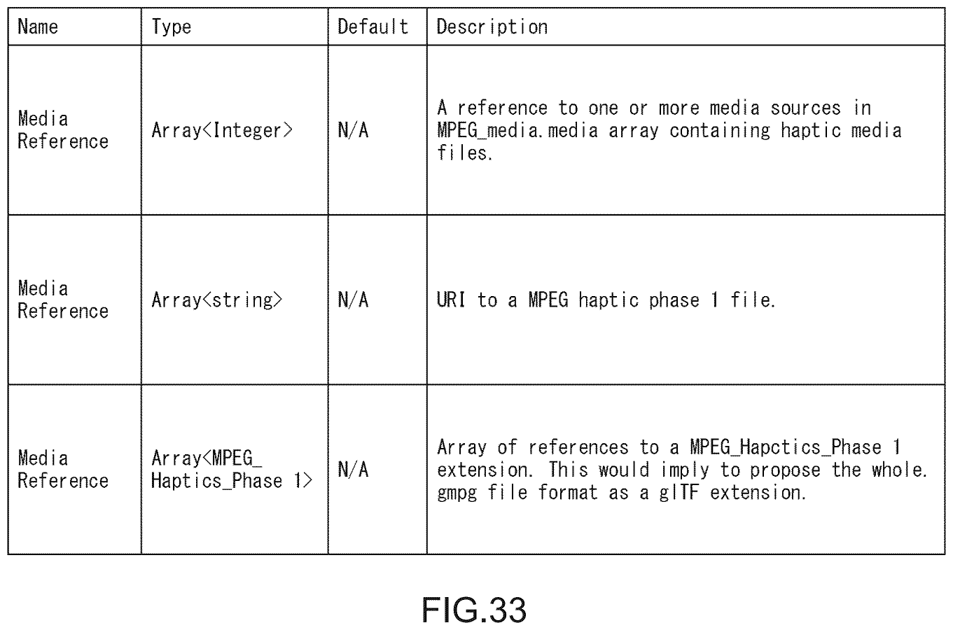

For example, when an avatar defined in MPEG_avatar causes an interaction (event) defined in MPEG_interaction, static haptic media depending on a location where the interaction is generated and the like is generated and played (e.g., a vibration output by a vibration device is rendered) in accordance with material information in MPEG_material_haptics so as to take an action corresponding to the interaction. MPEG_material_haptic is static information tied to texture information of the scene description. Otherwise, haptic data to be referenced by MPEG_haptic shown in MPEG_materal haptics is read out and dynamic haptic media is generated and played. That is, MPEG_haptic is activated from media control of the action by a trigger (execution condition) of the interactivity. An example of semantics of MPEG_haptic is shown in FIG. 33.

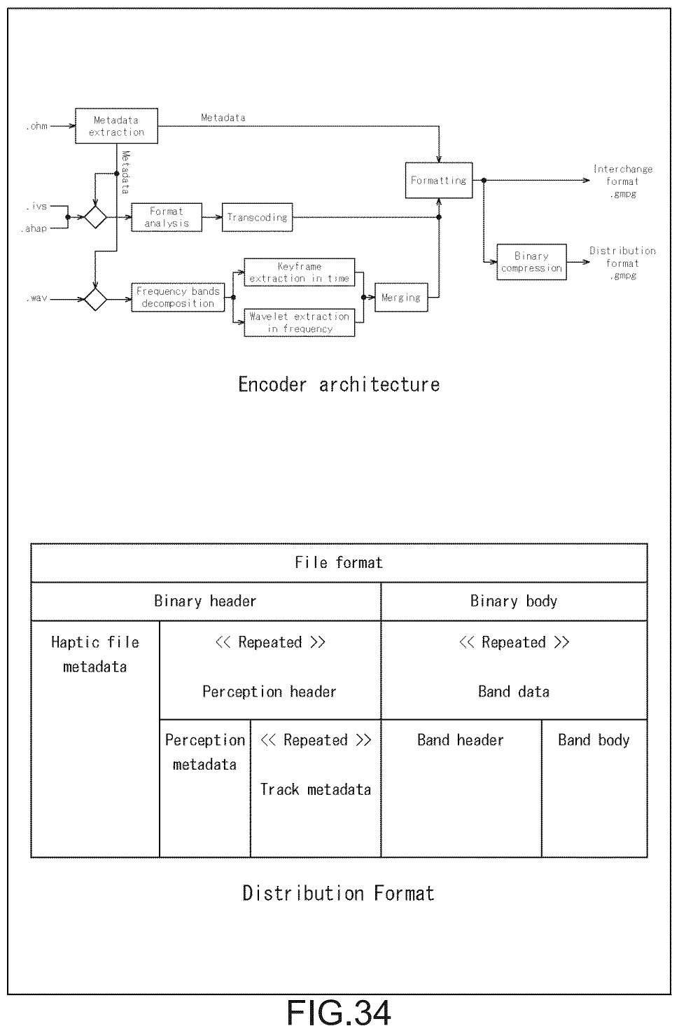

In Non-Patent Literature 3, an encoding method for such haptic media has been proposed. In this method, by using an architecture as shown in the upper side of FIG. 34, a haptic signal (wav) and a haptic signal description (ivs, ahap) are encoded and an interchange format (gmap) and a distribution format (mpg) are generated. The table on the lower side of FIG. 34 indicates a configuration example of the distribution format. As shown in this table, a bitstream of the haptic media is constituted by a binary header and a binary body. In the binary header, properties of encoded data (haptic stream) of the haptic media, a rendering device, information about an encoding method, and the like are stored. Moreover, in the binary body, the encoded data (haptic stream) of the haptic media is stored.

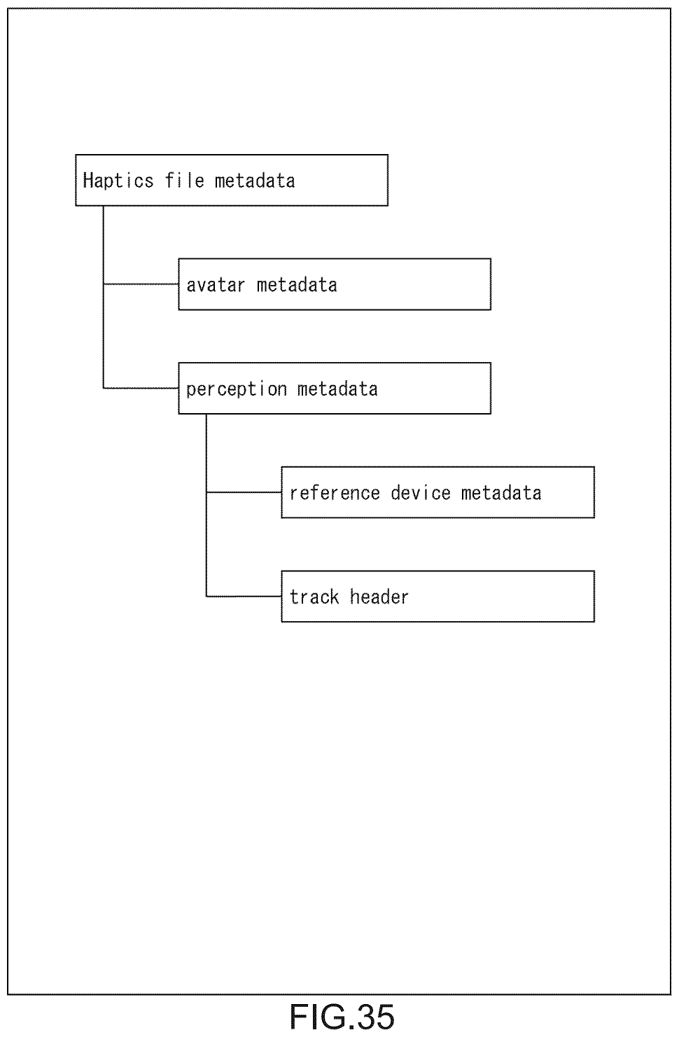

The binary header includes, for example, as shown in FIG. 35, haptic file metadata, avatar metadata, perception metadata, reference device metadata, and track header and has a layered structure as shown in FIG. 35.

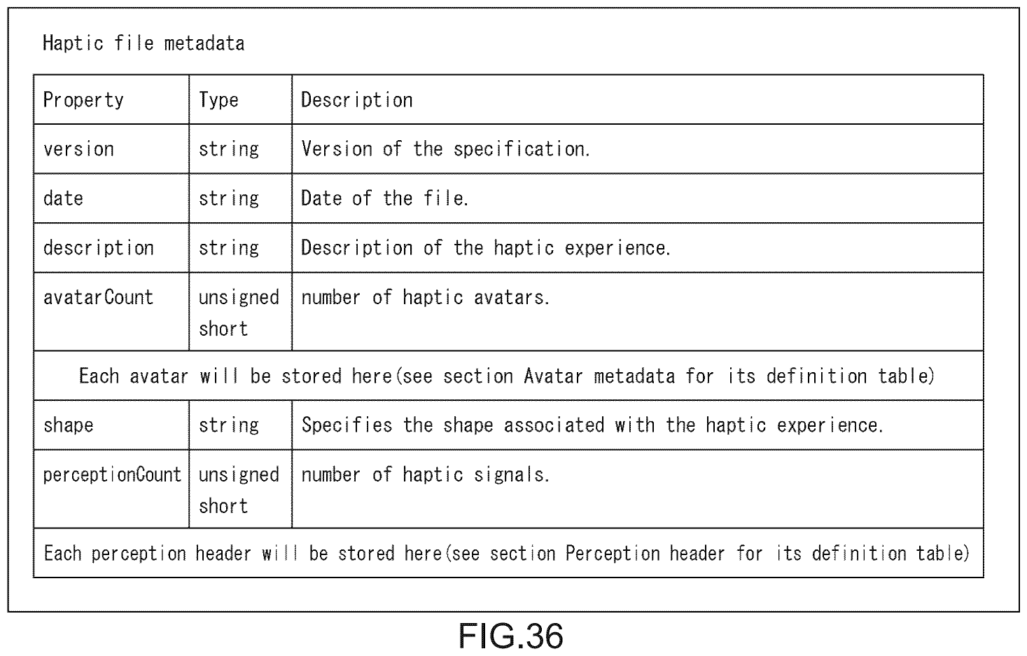

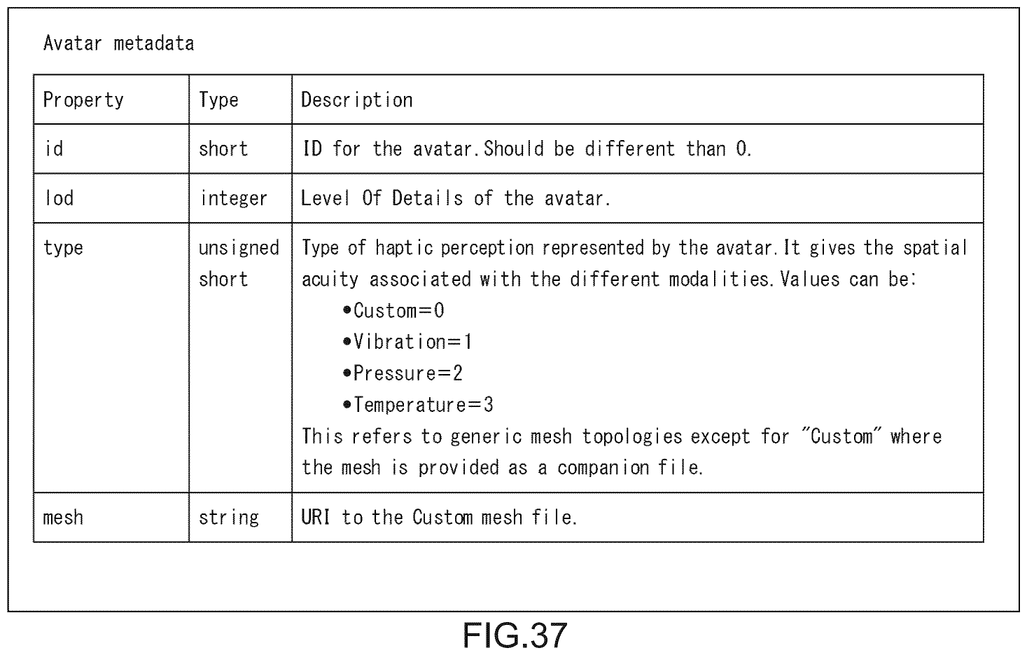

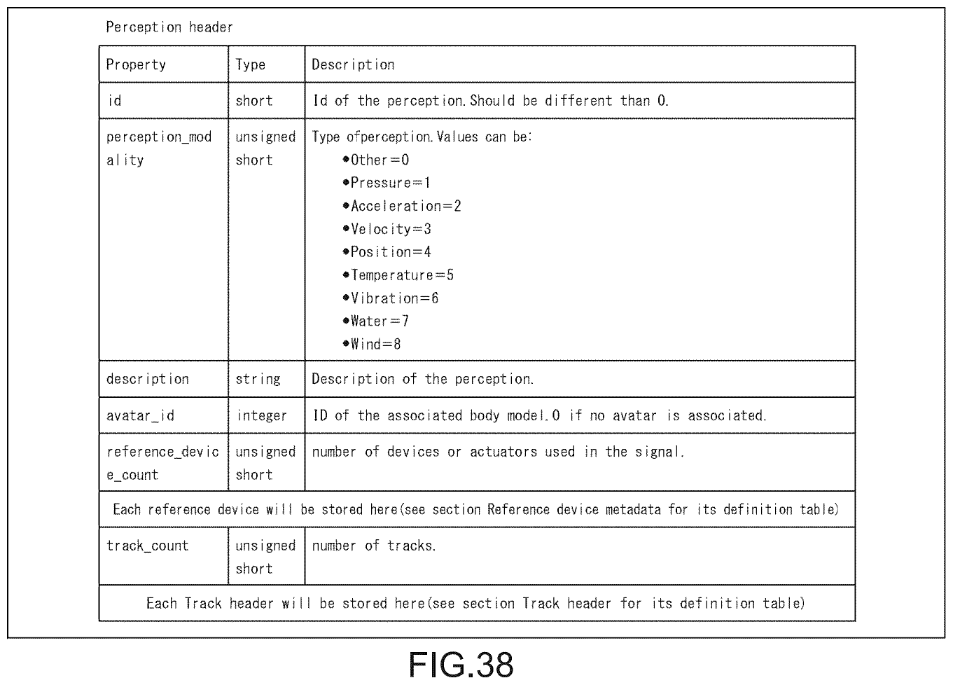

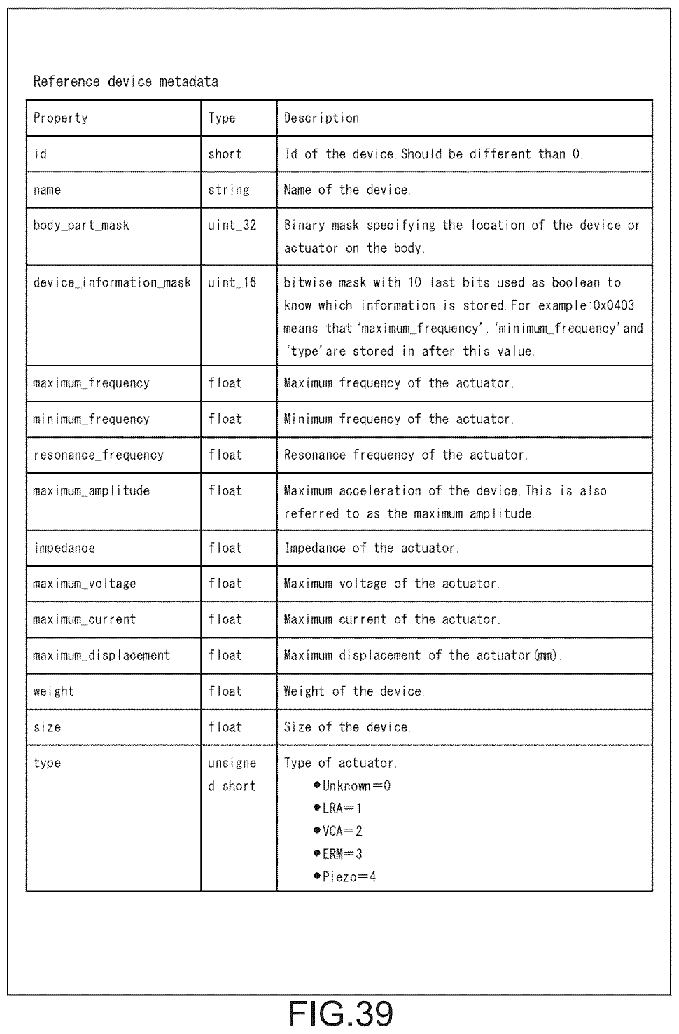

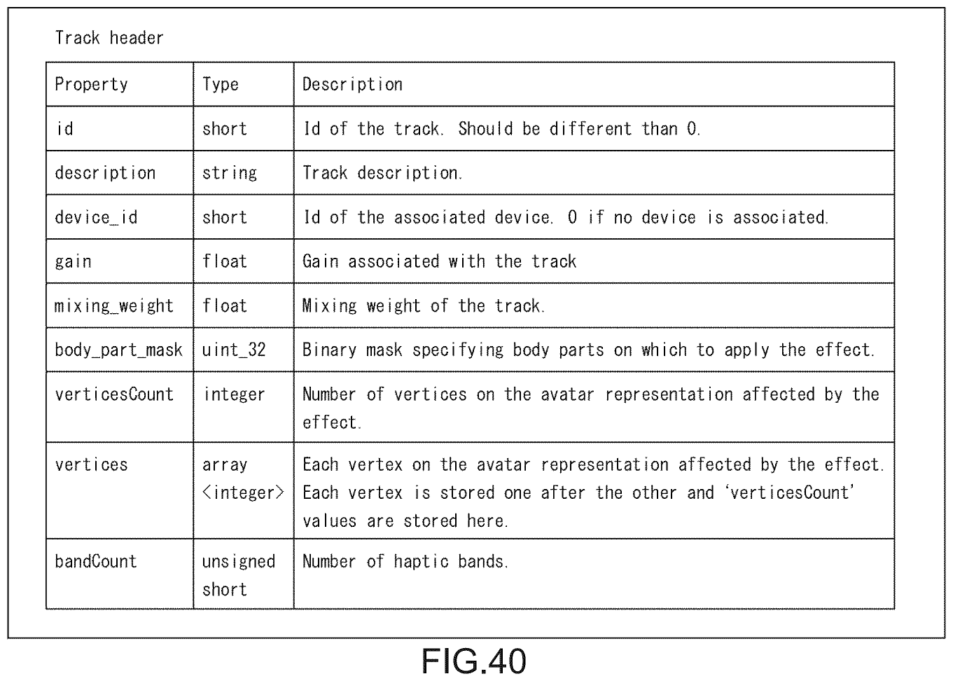

The haptic file metadata includes information regarding the haptic media. An example of semantics of that haptic file metadata is shown in FIG. 36. The avatar metadata includes information regarding the avatar. An example of semantics of that avatar metadata is shown in FIG. 37. The perception metadata includes information regarding how an item behaves. An example of semantics of that perception metadata is shown in FIG. 38. The reference device metadata includes information regarding a reference device (which device is moved and how to move it). An example of semantics of that reference device metadata is shown in FIG. 39. The track header includes a track in which binary data of the item is stored and information regarding playing that binary data. An example of semantics of that track header is shown in FIG. 40.

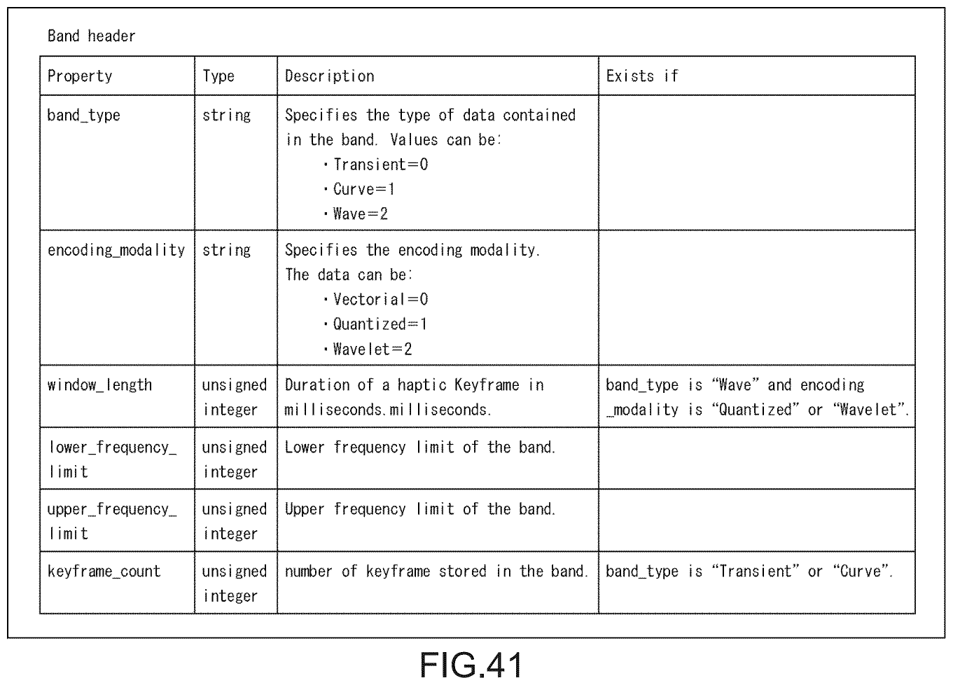

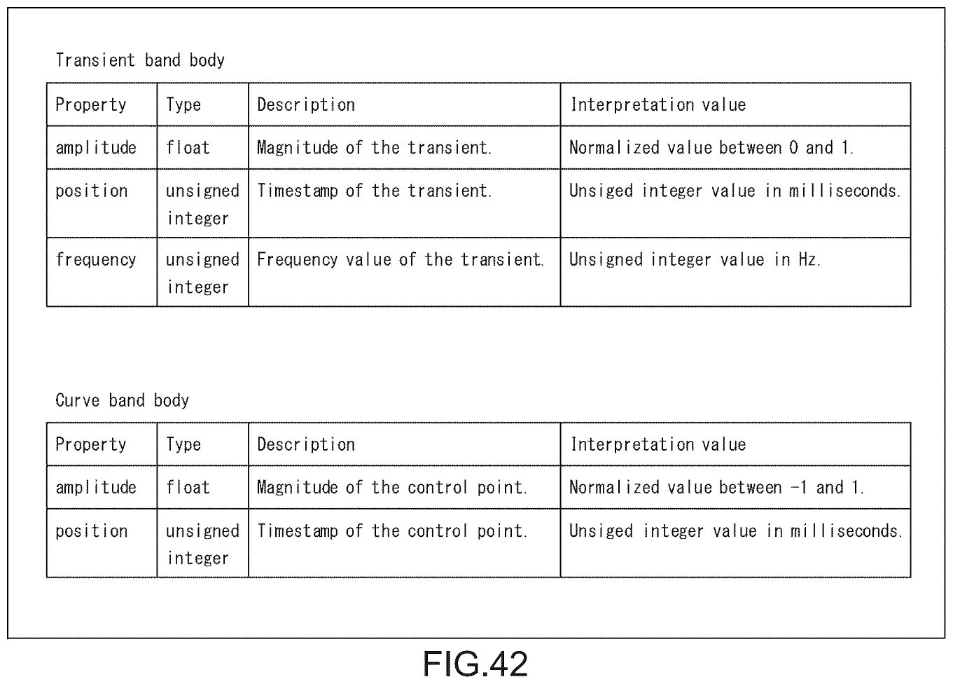

The binary body includes a band header, a transient band body, a curve band body, and a wave band body. An example of semantics of that band header is shown in FIG. 41. Moreover, an example of semantics of the transient band body and the curve band body is shown in FIG. 42.

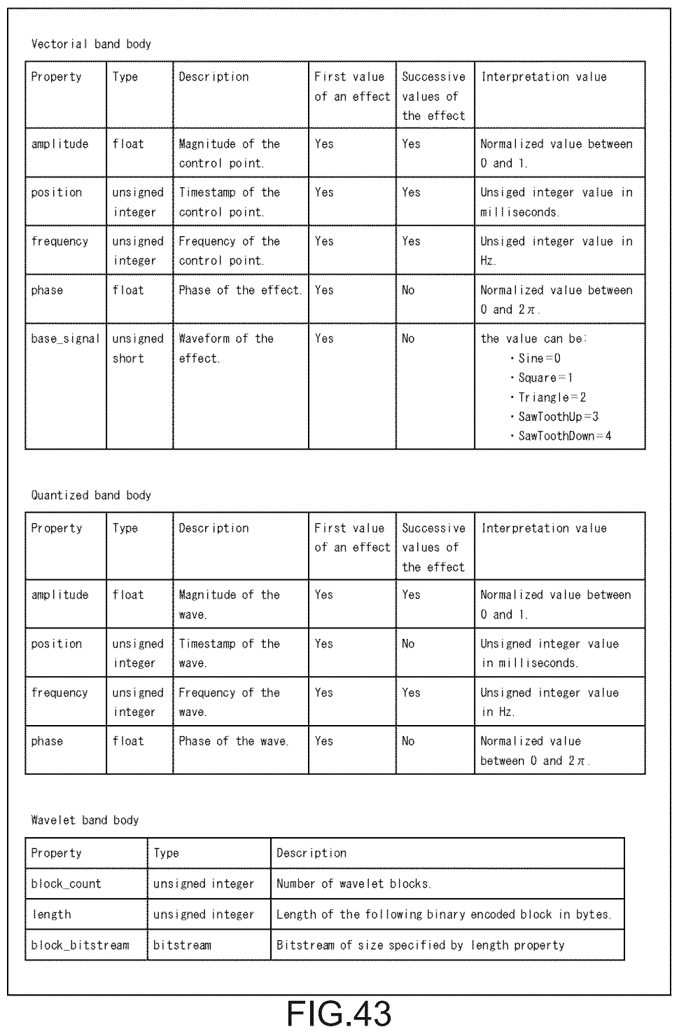

The wave band body is encoded with any of a vectorial band body, a quantized band body, and a wavelet band body. An example of those semantics is shown in FIG. 43.

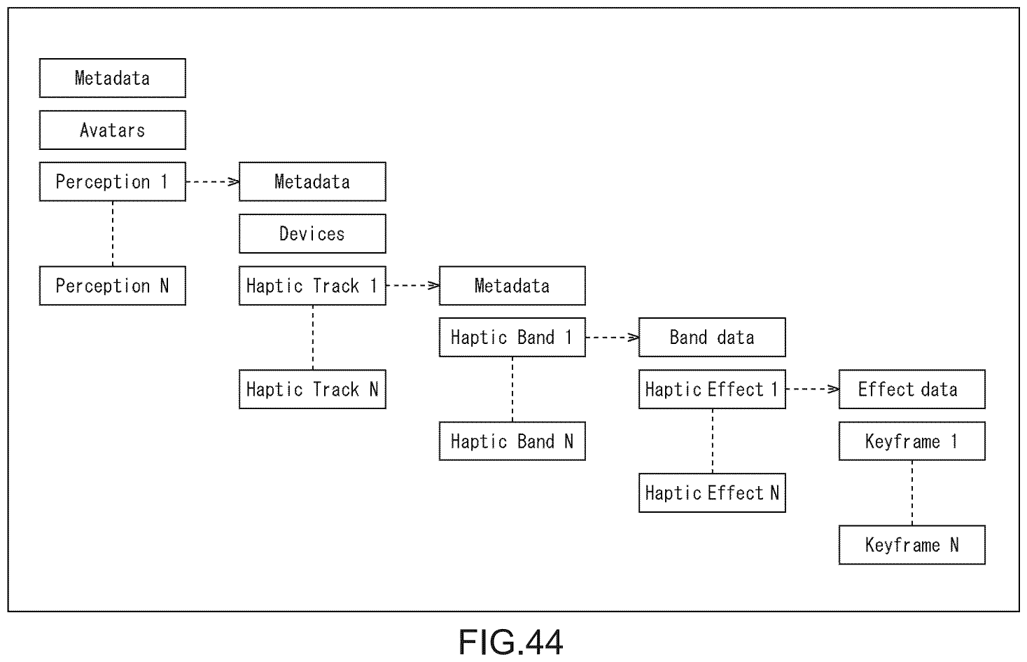

A data structure about the haptic media that has such information generally has a layered structure as shown in FIG. 44.

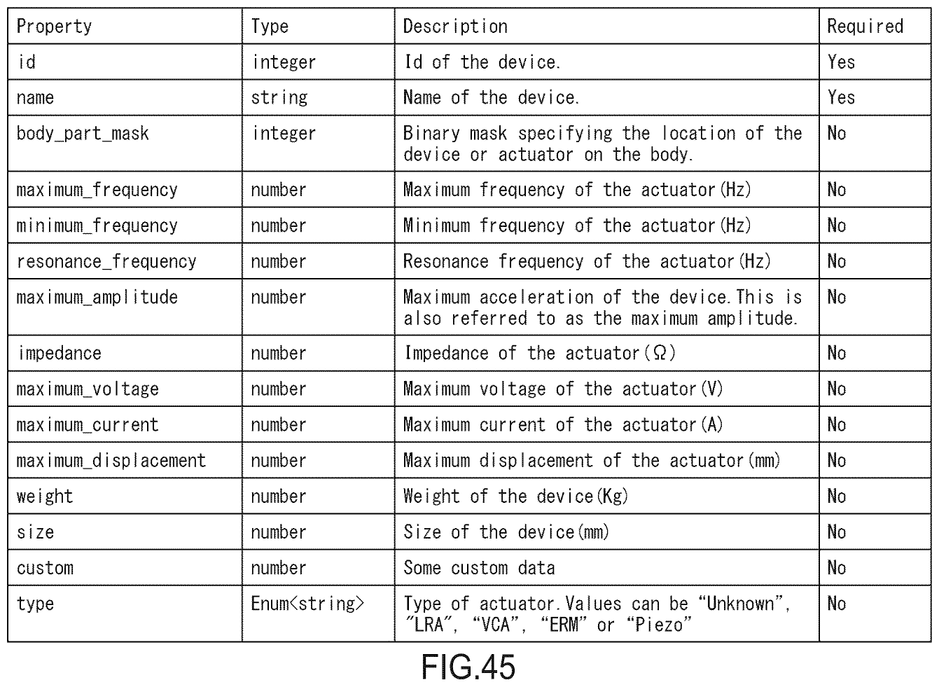

As shown in FIG. 45, the reference device is defined by an ID, a name, and a body location. Optionally, particular properties can be specified for each device.

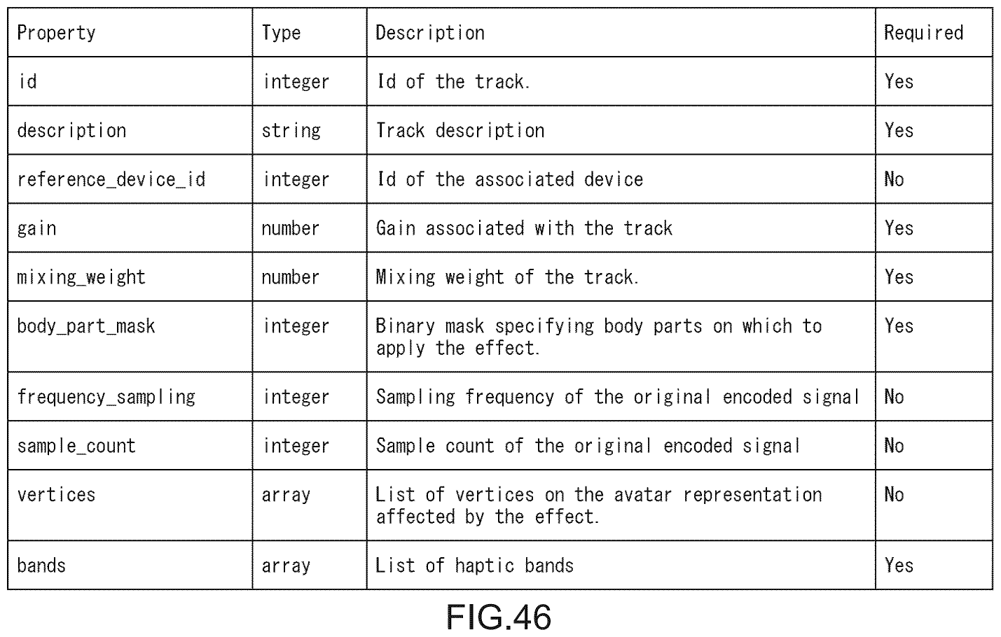

As shown in FIG. 46, a track is defined by an ID, a description, a body part (body_part), a mixing weight, a gain value, and a list of haptic bands. Various additional properties such as reference device ID, desired sampling frequency, and a sample count can also be specified.

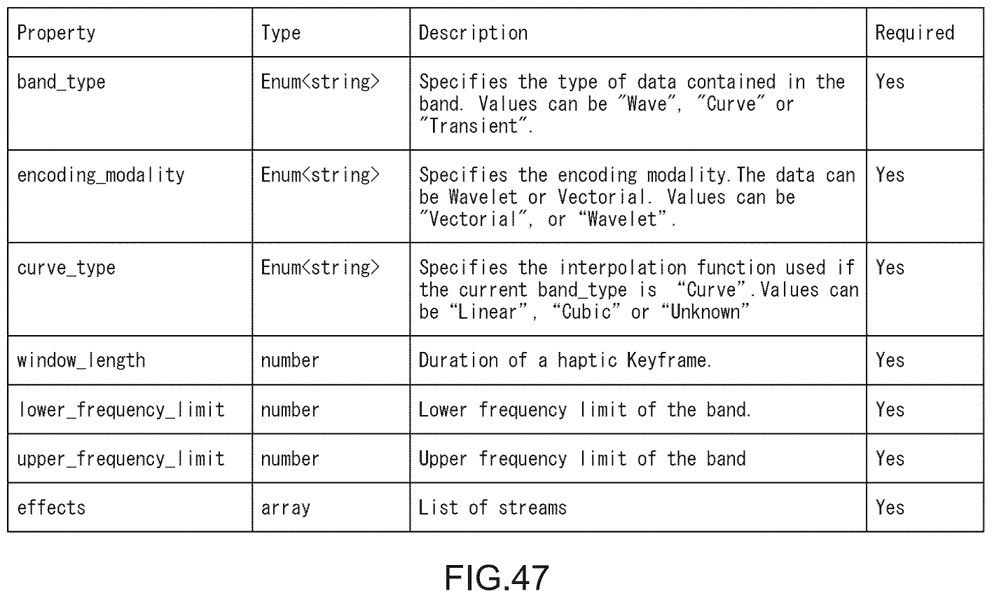

As shown in FIG. 47, the haptic band is defined by the type of the band, encoding modality, an interpolation function, a window length, a frequency range, and a list of haptic effects.

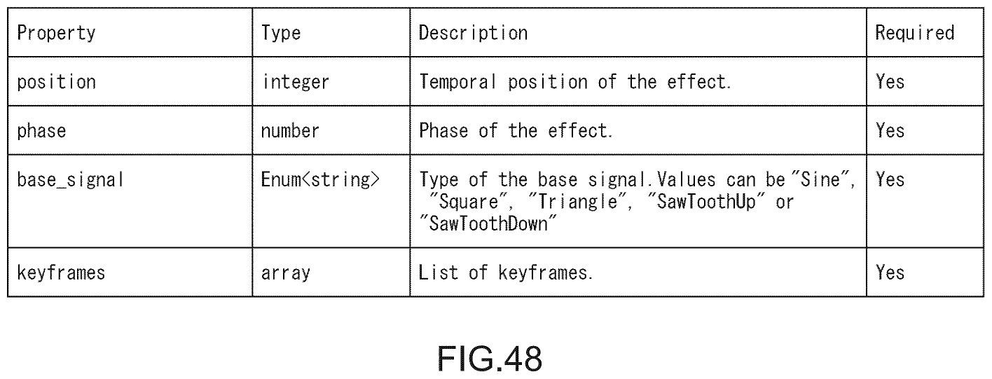

As shown in FIG. 48, the effect is defined by its position (time stamp), its phase, its signal type, and a list of keyframes.

### <Interactive Play of Media>

As described above, in the interactivity framework described in Non-Patent Literature 3, a trigger is defined as an interaction generating condition and an action is defined as an interaction to be generated. In addition, a behavior that enumerates a plurality of triggers and a plurality of actions is defined. For example, there has been playing the MPEG media (MPEG_media) that is an interactive processing target in such a framework. In this specification, a play method of playing media as interactive processing will be also referred to as interactive play. That is, in this framework, the interactive play of the MPEG media has also been set as a target.

However, in the MPEG-I Scene Description described in Non-Patent Literature 2, there have been only startTime and autoPlay as definitions of the MPEG media as described above. Therefore, it has been difficult to interactively play the MPEG media from the scene description by using the interactivity framework described in Non-Patent Literature 3.

### 3. MEDIA DEFINITION EXTENSION FOR INTERACTIVE PLAY

### <Method 1>

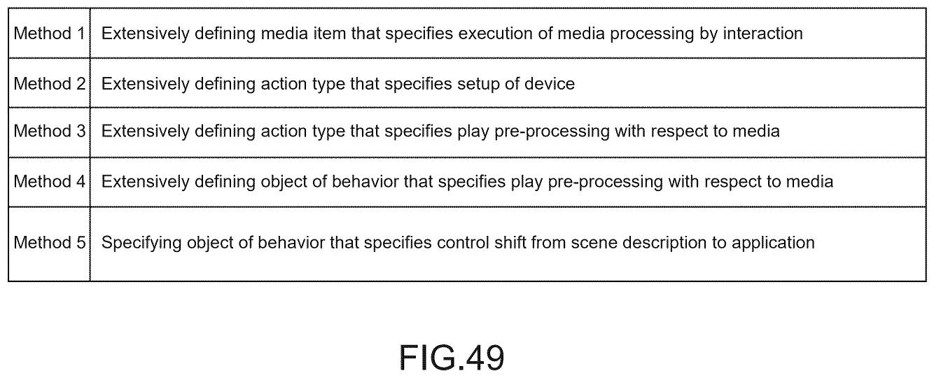

In view of this, as shown in the top line of the table in FIG. 49, a media item that specifies execution of media processing by interaction is extensively defined (Method 1).

For example, a first information processing apparatus is configured to include a play unit that interactively plays the interactive media specified to be interactively played in the scene description in accordance with the processing contents of the interactive play specified in the scene description in a case where the execution condition of the interactive play specified in the scene description has been met.

For example, in a first information processing method to be executed by the first information processing apparatus, the interactive media specified to be interactively played in the scene description are interactively played in accordance with the processing contents of the interactive play specified in the scene description in a case where the execution condition of the interactive play specified in the scene description has been met.

It should be noted that interactive play is a play method of playing media as interactive processing. Moreover, the interactive processing is interaction-type processing that executes processing contents specified in the scene description in a case where the execution condition specified in the scene description has been met. Moreover, the interactive media refer to media to be interactively played. This interactive media may be any types of media. For example, the interactive media may be visual information such as images (moving images), may be auditory information such as sounds, may be haptic information such as vibrations, and may be other information.

By extensively defining the media in this manner, the first information processing apparatus is capable of interactively processing media on the basis of the scene description. That is, the first information processing apparatus can correspond to all media operations that happen in the scene description. Therefore, the first information processing apparatus is capable of interactively playing the MPEG media from the scene description by using, for example, the interactivity framework described in Non-Patent Literature 3.

Moreover, a second information processing apparatus is configured to include a providing unit that provides a scene description in which a description to specify that interactive media are to be interactively played and a description to specify the execution condition and the processing contents of the interactive play are present.

For example, in the second information processing method to be executed by the second information processing apparatus, a scene description in which a description to specify that interactive media are to be interactively played and a description to specify the execution condition and the processing contents of the interactive play are present is provided.

It should be noted that the interactive play is a play method of playing media as interactive processing. Moreover, the interactive processing is interaction-type processing of executing processing contents specified in the scene description in a case where the execution condition specified in the scene description has been met. Moreover, the interactive media refer to media to be interactively played. This interactive media may be any types of media. For example, the interactive media may be visual information such as images (moving images), may be auditory information such as sounds, may be haptic information such as vibrations, and may be other information.

By extensively defining the media in this manner and the second information processing apparatus providing such a scene description, the apparatus (e.g., first information processing apparatus) to which the scene description is to be provided is capable of interactively processing the media on the basis of the scene description. That is, the apparatus to which it is to be provided can correspond to all media operations that happen in the scene description. For example, the apparatus to which it is to be provided is capable of interactively playing the MPEG media from the scene description by using, for example, the interactivity framework described in Non-Patent Literature 3.

It should be noted that the method of specifying that the interactive media are interactively played in the scene description may be any method. An example thereof will be described below.

### Extension Example 1

The items used in the media array of the MPEG media may be extensively defined and it may be specified that the media are interactively played.

For example, in the scene description, any one of start time specification, autoplay specification, or interactive play specification may be present as a description with respect to the media to be referenced in accordance with the scene description and it may be specified that the interactive media are interactively played by using the interactive play specification whose value is true. The providing unit of the second information processing apparatus may provide such a scene description. On the basis of such a scene description, the play unit of the first information processing apparatus may interactively play the interactive media in accordance with the processing contents of the interactive play in a case where the execution condition of the interactive play has been met. It should be noted that the start time specification is a description to specify a play start time of the media. The autoplay specification is a description to specify whether to start playing the media as soon as the media are ready. The interactive play specification is a description to specify whether to interactively plays the media.

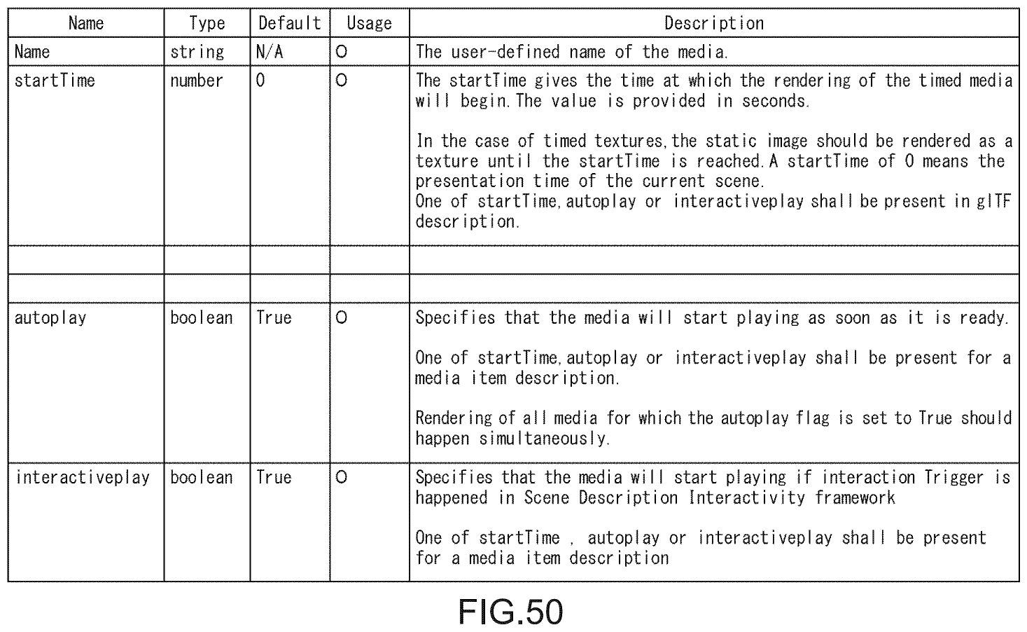

FIG. 50 shows an example thereof. As shown in this example, “interactiveplay” may be added as an item for the media array. This interactiveplay specifies that the media are started playing in a case where the execution condition of the interactive processing has been satisfied in a scene description interactivity framework. Any one of startTime, autoplay, or interactiveplay is present as a description (media item) with respect to media to be referenced in accordance with the scene description.

That is, in this case, by describing interactiveplay with respect to the media in the scene description, it is specified that the media are media to be interactively played (i.e., interactive media). Therefore, the second information processing apparatus (e.g., a client apparatus) that plays the content is capable of interactively playing the interactive media by such a description.

### Extension Example 2

Moreover, in a state in which the media are not automatically played, the media may be enabled to be interactively played.

For example, in the scene description, as a description with respect to the media to be referenced in accordance with the scene description, the interactive play specification is capable of being present in a case where the value of the autoplay specification is false, it may be specified that the interactive media are interactively played by using the autoplay specification whose value is false and the interactive play specification whose value is true. The providing unit of the second information processing apparatus may provide such a scene description. On the basis of such a scene description, the play unit of the first information processing apparatus may interactively play the interactive media in accordance with the processing contents of the interactive play in a case where the execution condition of the interactive play has been met. It should be noted that the autoplay specification is a description to specify whether to start playing the media as soon as the media are ready. The interactive play specification is a description to specify whether to interactively plays the media.

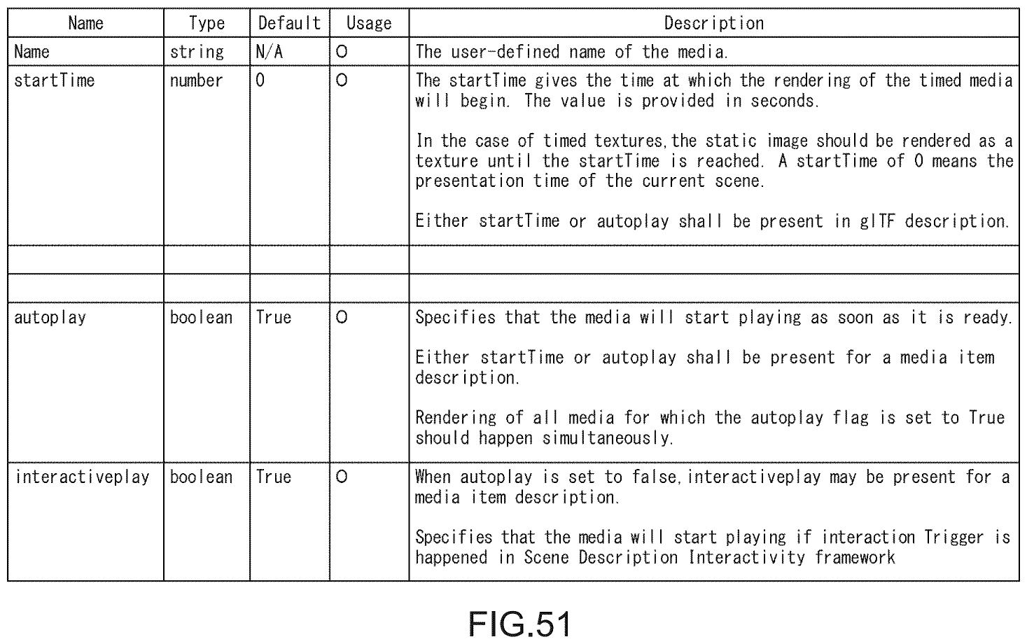

FIG. 51 shows an example thereof. As shown in this example, in a case where autoplay=true, autoplay (play method in which the media are started playing as soon as the media are ready) may be applied, and in a case where autoplay=false, interactiveplay (i.e., interactive play) may be enabled to be applied.

Moreover, in a state in which the media are not automatically played, the media may be enabled to be played by autoplay specified by autoplay or by a play method (other method) other than the specified-time play specified by startTime. Then, the interactive play may be enabled to be applied as one of the other methods.

For example, in the scene description, as a description with respect to the media to be referenced in accordance with the scene description, other method specification is capable of being present in a case where the value of the autoplay specification is false, it may be specified that the interactive media are interactively played by using the autoplay specification whose value is false and the interactive play specification whose value is true. The providing unit of the second information processing apparatus may provide such a scene description. On the basis of such a scene description, the play unit of the first information processing apparatus may interactively play the interactive media in accordance with the processing contents of the interactive play in a case where the execution condition of the interactive play has been met. It should be noted that the autoplay specification is a description to specify whether to start playing the media as soon as the media are ready. The other method specification is a description to specify whether to apply a play method other than specified-time play and autoplay. The specified-time play is a play method of starting playing the media at a specified time. Autoplay is a play method of starting playing the media as soon as the media are ready. The interactive play specification is one of the other method specification and is a description to specify whether to interactively play the media.

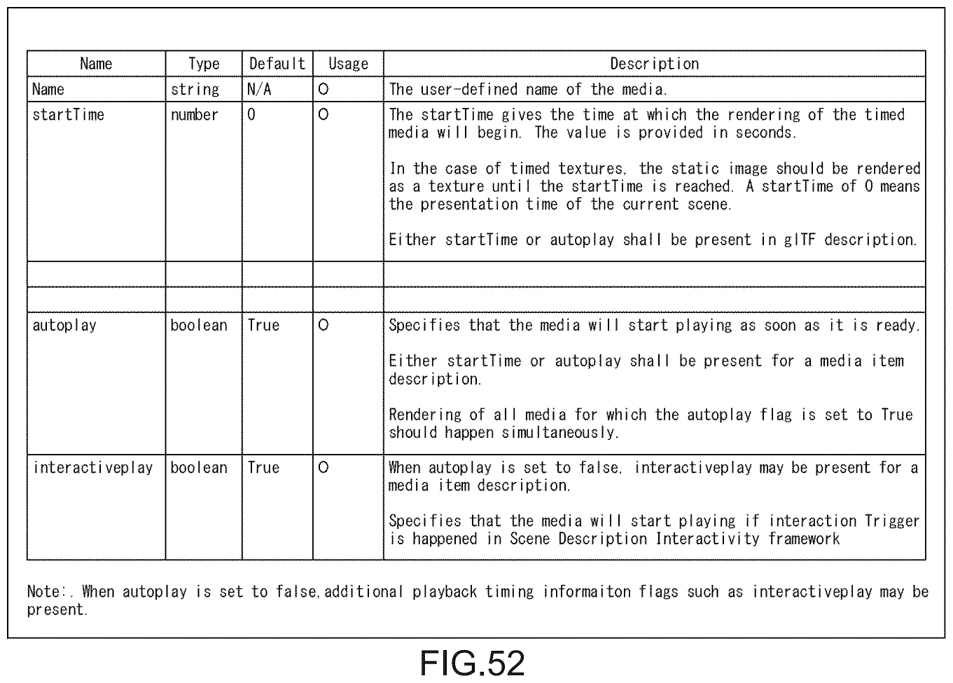

FIG. 52 shows an example thereof. As shown in Note in this example, in a case where autoplay=true, autoplay (play method in which the media are started playing as soon as the media are ready) can be applied, and in a case where autoplay=false, another method can be applied. Then, in that case, the media can be interactively played by applying interactiveplay.

That is, in a case of this example, if autoplay=false, a play method other than interactive play (interactiveplay) can be applied (the play method that can be applied is not limited to interactive play). Here, an applicable play method may be any play method. For example, as an item for the media array, “interruptplay” to specify that media processing when an interrupt event, which is controlled outside the scene description although it is an object in the scene description, has been generated is started may be added. For example, in a case where interruptplay is described with respect to the media, while another application controls an object in scene that is a metaverse space, an event that influences the scene is generated, and the PE of the scene description is notified of the interrupt from an external application, such that the media may be played in the scene.

### Extension Example 3

Moreover, in a state in which the media are not automatically played, it may be considered to interactively play the media.

For example, in the scene description, as a description with respect to the media to be referenced in accordance with the scene description, in a case where the value of the autoplay specification is false, it may be considered that it has been specified to play the media as the interactive processing, and it may be specified that the interactive media are interactively played by using the autoplay specification whose value is false. The providing unit of the second information processing apparatus may provide such a scene description. On the basis of such a scene description, the play unit of the first information processing apparatus may interactively play the interactive media in accordance with the processing contents of the interactive play in a case where the execution condition of the interactive play has been met. It should be noted that the autoplay specification is a description to specify whether to start playing the media as soon as the media are ready.

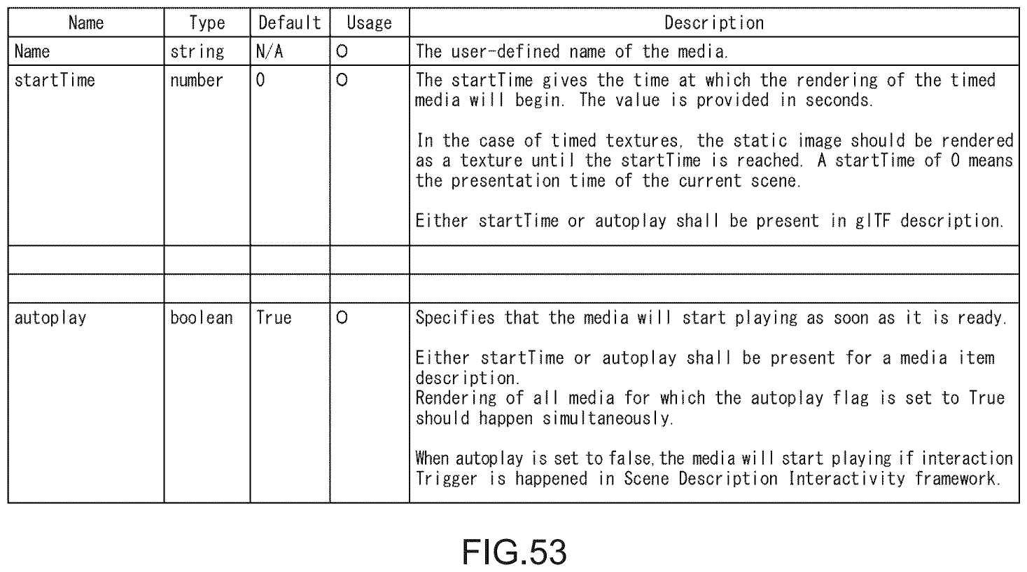

FIG. 53 shows an example thereof. In a case of this example, although interactiveplay is not additionally defined, if autoplay=false, (it is considered that) the media are interactively played. That is, the media are considered as the interactive media and the interactive play is applied. That is, even if interactiveplay has not been described with respect to the media, in a case where the execution condition defined by the trigger has been satisfied, the processing contents defined by the action are executed. By defining autoplay in this manner, the media can be interactively played without adding a new item (interactiveplay) (while suppressing the increase of portions changed from the conventional method). It is thus possible to more easily interactively play the media.

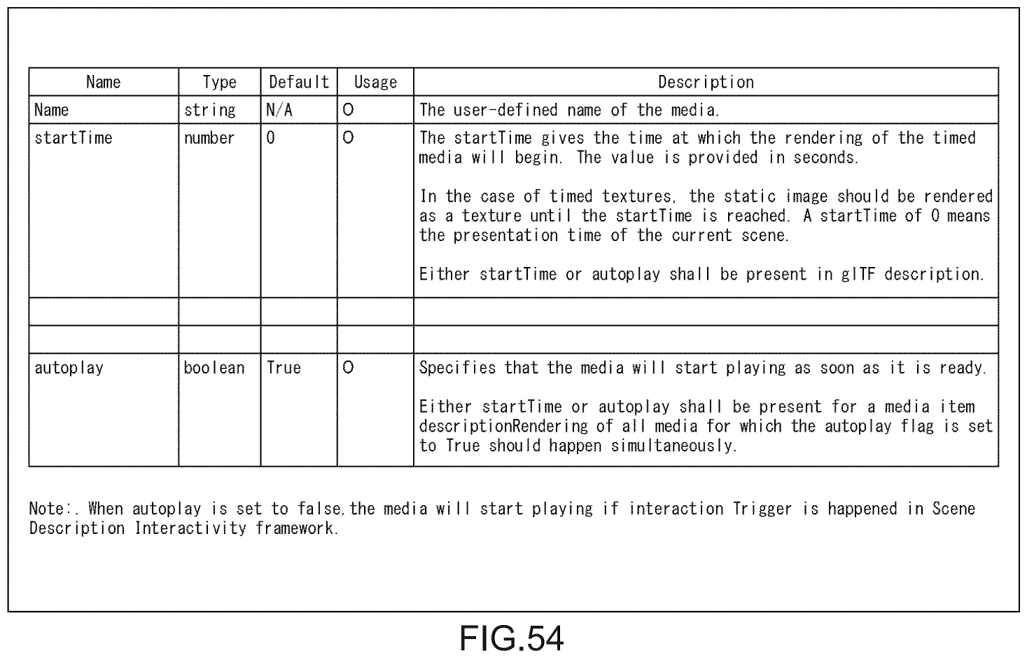

It should be noted that as shown in FIG. 54, such definition may be performed in Note, not as a definition of autoplay. By definition in Note, it becomes unnecessary to change the definition of autoplay. Moreover, in that case, in a state in which the media are not automatically played as in the example of FIG. 52, the media may be considered to be played by autoplay specified by autoplay or a play method (other method) other than the specified-time play specified by startTime. That is, the play method considered to be applied may also include a play method other than interactive play (interactiveplay). For example, the interruptplay described above may be considered to be applied.

### Extension Example 4

Moreover, in a case where the specification of the play start time of the media is unsuitable, the media may be enabled to be interactively played.

For example, in the scene description, as a description with respect to the media to be referenced in accordance with the scene description, the interactive play specification is capable of being present in a case where start time specification is a negative value, and it may be specified that the interactive media are interactively played by using the start time specification that is the negative value and the interactive play specification whose value is true. The providing unit of the second information processing apparatus may provide such a scene description. On the basis of such a scene description, the play unit of the first information processing apparatus may interactively play the interactive media in accordance with the processing contents of the interactive play in a case where the execution condition of the interactive play has been met. It should be noted that the start time specification is a description to specify a play start time of the media. The interactive play specification is a description to specify whether to interactively plays the media.

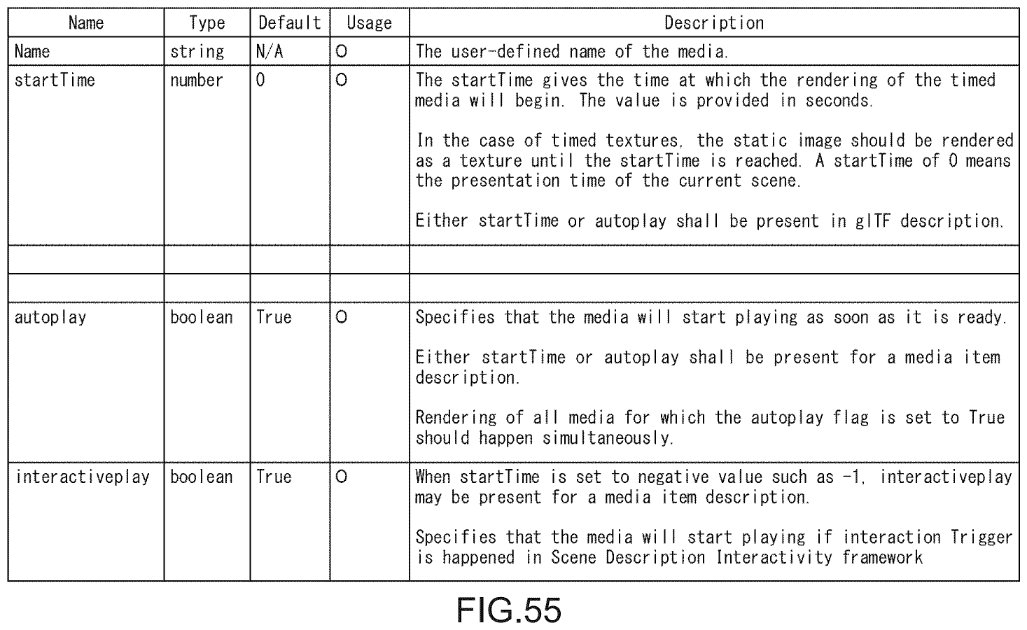

FIG. 55 shows an example thereof. StartTime is an item that specifies the play start time of the media, and therefore its value is zero or a positive value (zero or a positive value is a normal value). In other words, the negative value is inappropriate as the value of startTime (the time cannot be correctly specified). Therefore, the media is not normally played. In view of this, in such a case, the interactive play may be enabled to be applied. That is, as shown in the example of FIG. 55, in a case where startTime is not a negative value (is zero or a positive value), the specified-time play (play method of starting playing the media at a specified time) is applied, and in a case where startTime is a negative value, interactiveplay (i.e., interactive play) may be enabled to be applied.

Moreover, in a case where the specification of the play start time of the media is unsuitable, the media may be enabled to be played by autoplay specified by autoplay or a play method (other method) other than the specified-time play specified by startTime. Then, the interactive play may be enabled to be applied as one of the other methods.

For example, in the scene description, as a description with respect to the media to be referenced in accordance with the scene description, other method specification is capable of being present in a case where the start time specification is a negative value, and it may be specified that the interactive media are interactively played by using the start time specification that is the negative value and the interactive play specification whose value is true. The providing unit of the second information processing apparatus may provide such a scene description. On the basis of such a scene description, the play unit of the first information processing apparatus may interactively play the interactive media in accordance with the processing contents of the interactive play in a case where the execution condition of the interactive play has been met. It should be noted that the start time specification is a description to specify a play start time of the media. The other method specification is a description to specify whether to apply a play method other than specified-time play and autoplay. The specified-time play is a play method of starting playing the media at a specified time. Autoplay is a play method of starting playing the media as soon as the media are ready. The interactive play specification is one of the other method specification and is a description to specify whether to interactively play the media.

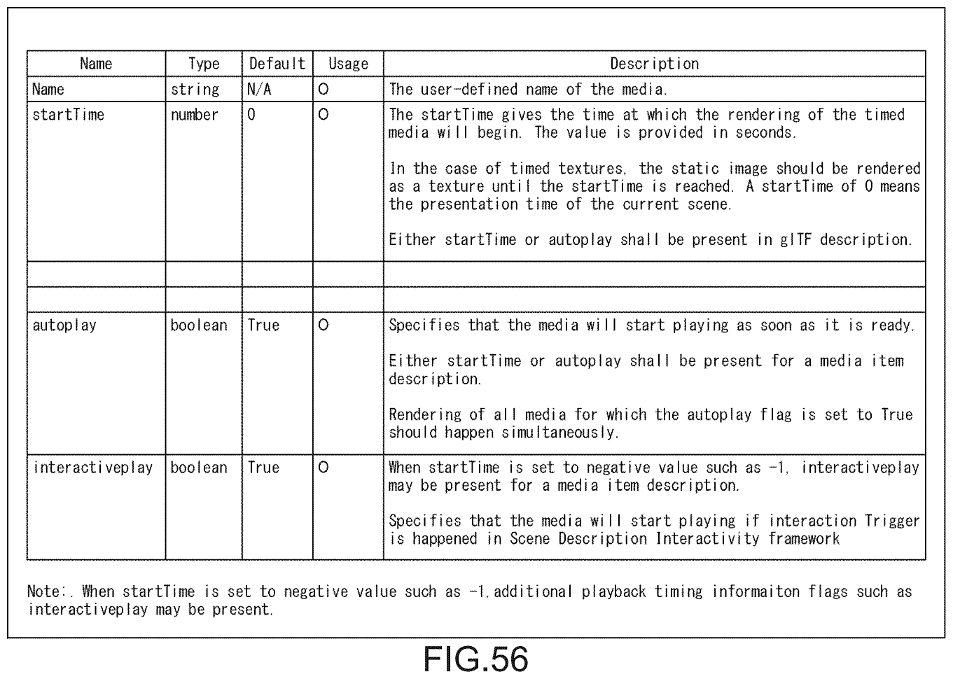

FIG. 56 shows an example thereof. As shown in Note in this example, in a case where startTime is zero or a positive value, the specified-time play (play method of starting playing the media at a specified time) can be applied, and in a case where startTime is a negative value (e.g., “−1”), another method can be applied. Then, in that case, the media can be interactively played by applying interactiveplay.

That is, in a case of this example, if startTime is a negative value, a play method other than interactive play (interactiveplay) can be applied (the play method that can be applied is not limited to interactive play). Here, an applicable play method may be any play method. For example, as in the above-mentioned case, interruptplay may be applied.

### Extension Example 5

Moreover, in a case where the specification of the play start time of the media is unsuitable, the media may be considered to be interactively played.

For example, in the scene description, as a description with respect to the media to be referenced in accordance with the scene description, in a case where the start time specification is a negative value, it may be considered that it has been specified to play the media as the interactive processing, and it may be specified that the interactive media are interactively played by using the start time specification that is the negative value. The providing unit of the second information processing apparatus may provide such a scene description. On the basis of such a scene description, the play unit of the first information processing apparatus may interactively play the interactive media in accordance with the processing contents of the interactive play in a case where the execution condition of the interactive play has been met. It should be noted that the start time specification is a description to specify a play start time of the media.

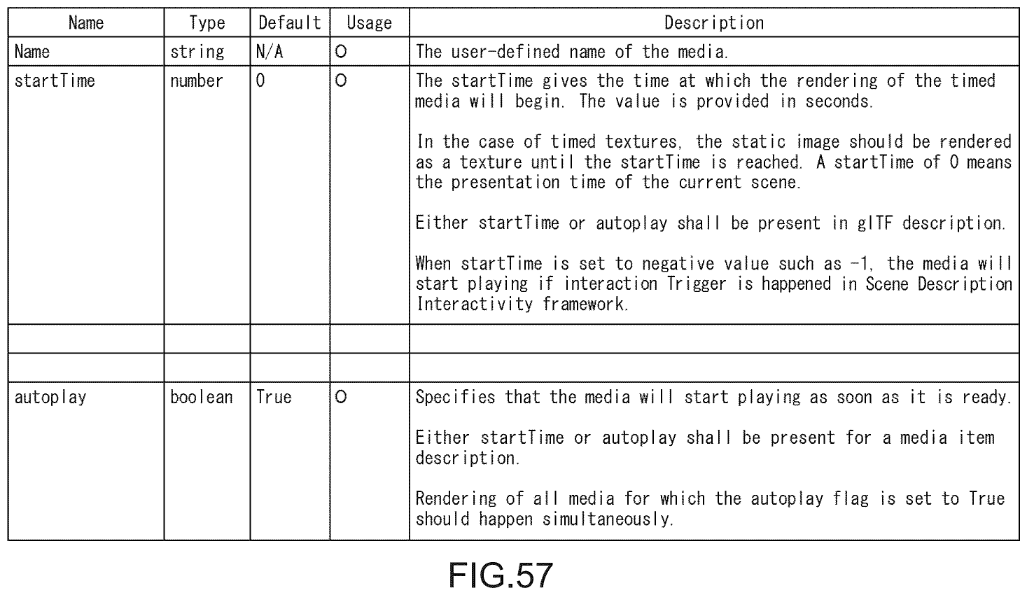

FIG. 57 shows an example thereof. In a case of this example, although interactiveplay is not additionally defined, if startTime is a negative value, (it is considered that) the media are interactively played. That is, the media are considered as the interactive media and the interactive play is applied. That is, even if interactiveplay has not been described with respect to the media, in a case where the execution condition defined by the trigger has been satisfied, the processing contents defined by the action are executed. By defining startTime in this manner, the media can be interactively played without adding a new item (interactiveplay) (while suppressing the increase of portions changed from the conventional method). It is thus possible to more easily interactively play the media.

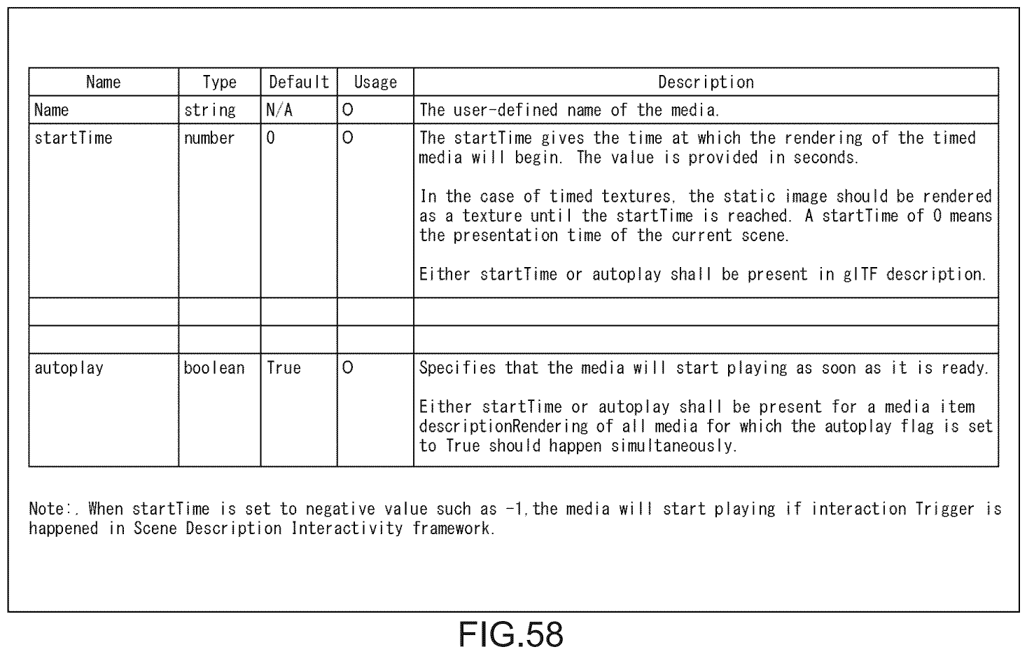

It should be noted that as shown in FIG. 58, such definition may be performed in Note, not as a definition of startTime. By definition in Note, it becomes unnecessary to change the definition of startTime. Moreover, in that case, as in the example of FIG. 56, in a case where the specification of the play start time of the media is unsuitable, the media may be considered to be played by autoplay specified by autoplay or a play method (other method) other than the specified-time play specified by startTime. That is, the play method considered to be applied may also include a play method other than interactive play (interactiveplay). For example, the interruptplay described above may be considered to be applied.

### <Method 2>

The played media is output by a certain output device. For example, haptic data (haptic information) played as an action is rendered and output by a haptics device. Moreover, image data (visual information) played as an action is displayed as an image by a display device such as a monitor. Moreover, audio data (auditory information) played as an action is output as a sound by an audio output device such as a loudspeaker. Such an output device needs to perform setup, e.g., powering and setting an operation mode, and therefore that the information is enabled to be output. Such setup requires a constant time.

Therefore, it is necessary to perform setup at a suitable timing (in accordance with properties of the device) before executing the action so that the information can be output with no delay at the time of executing the action.

However, in the framework (MPEG-I Scene Description Interactivity Framework) described in Non-Patent Literature 3, as described above, it has been difficult to execute such setup of the device as interactive processing because there are no definitions for such setup of the device in the action.

In view of this, as shown in the second line from above of the table in FIG. 49, an action type that specifies the setup of the device may be extensively defined (Method 2).

For example, in the scene description, as the type of the processing contents of the interactive processing, setup of a device that outputs the interactive media may be specified. The providing unit of the second information processing apparatus may provide such a scene description. In a case where the execution condition of that interactive processing described in such a scene description has been met, the play unit of the first information processing apparatus may set up the device in accordance with the processing contents of that interactive processing.

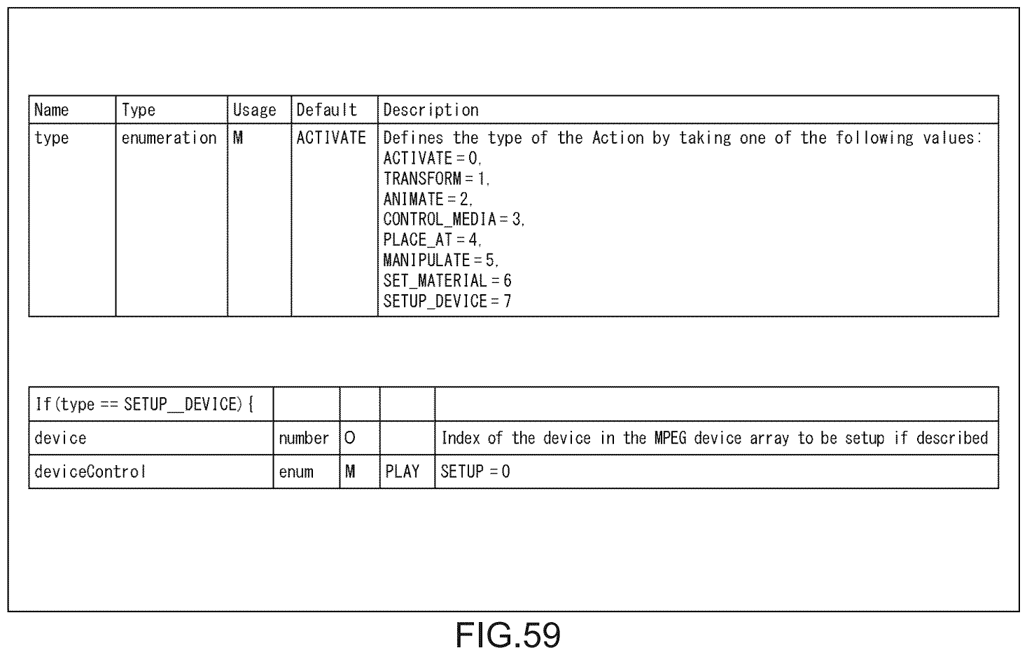

For example, as shown in FIG. 59, SETUP_DEVICE may be additionally defined in the type of the action (processing contents). SETUP_DEVICE is an action related to the setup of the device. In a case where this type is specified, processing related to the setup of the device is executed as the interactive processing (on the basis of the trigger).

Moreover, in the scene description, the execution condition of the setup of the device may be set to be met preceding the execution condition of the interactive play. The providing unit of the second information processing apparatus may provide such a scene description. The play unit of the first information processing apparatus may set up the device in accordance with such an execution condition.

As described above, in general, it is desirable that the setup of the device be set to be performed before the media are played. In view of this, the execution condition of the setup of the device may be set to be met preceding the execution condition of the interactive play of the media. For example, in a case where the execution condition is a temperature condition and the interactive media are played when a target temperature is equal to or higher than 30° C., a setting that the setup of the device is executed when the target temperature is equal to or higher than 25° C. may be made. Moreover, in a case where the execution condition is a distance condition and the interactive media are played when the object approaches within 1 meter, a setting that the setup of the device is executed in a phase in which the object approaches within 5 meters may be made. As a matter of course, both the execution condition of the media processing and the execution condition of the device setup may be any condition or may be other than these examples.

A setting that setup is executed as an action with respect to a suitable execution condition (trigger) is made before the execution condition of the media processing has been actually met or before the action is generated, such that the interactive media can be output with no delay by the device setup. Accordingly, reduction of the quality of the user experience can be suppressed. In addition, as compared to a case of executing the device setup at a predetermined timing determined in advance, e.g., when the scene is initialized, the total power consumption of the device during this time can be reduced.

It should be noted that the device that is set up may be any device. Moreover, the contents of the setup may be any contents. For example, the device drive apparatus (amplifier, fan, compressor, etc.) may be a setup target device. Moreover, processing of powering on the device drive apparatus may be executed as setup. Moreover, a thermal sensation presentation device may be the setup target device. Moreover, in the thermal sensation presentation device, temperature setting processing such as Pre-heating processing and Pre-cooling processing may be executed as setup. Moreover, a tactile sense presentation device may be set as the setup target device. Moreover, in the tactile sense presentation device, processing such as slightly inflating as an air pressure setting may be executed as setup.

This setup target device and the contents of the setup may be enabled to be specified.

For example, in the scene description, a processing target of the setup may be specified by using an index of the device. The providing unit of the second information processing apparatus may provide such a scene description. The play unit of the first information processing apparatus may set up the device specified as the processing target in such a scene description.

Moreover, in the scene description, it may be specified that the device is enabled to output the interactive media as the contents of the setup. The providing unit of the second information processing apparatus may provide such a scene description. The play unit of the first information processing apparatus may set up the device so that the interactive media are enabled to be played in accordance with the specification of the processing contents of the interactive processing described in such a scene description.

For example, as shown in FIG. 59, in a case where SETUP_DEVICE is specified as the type of the action, device and deviceControl can be set as an option. Device is an item that specifies a device that is a setup target. The device that is set up can be specified by using an index of the device. DeviceControl is an item that specifies the contents of the setup. That is, by this item, how to set up is specified. For example, by specifying SETUP as deviceControl, the device is set up to be enabled to play the interactive media (the device is enabled to immediately execute the action).

By doing so, desired contents can be set up as the interactive processing with respect to a desired device.

It should be noted that the setup may be executed other than the time at which the device is initialized. For example, when and how setup is performed may be enabled to be specified by using deviceControl.

For example, in the scene description, it may be specified that the initialized device is set up as the contents of the setup. The providing unit of the second information processing apparatus may provide such a scene description. The play unit of the first information processing apparatus may set up the initialized device in accordance with the specification of the processing contents of the interactive processing described in such a scene description.

Moreover, in the scene description, it may be specified that processing contents and a processing mode to be executed by the device are updated as the contents of the setup. The providing unit of the second information processing apparatus may provide such a scene description. The play unit of the first information processing apparatus may set up the device to update processing contents and a processing mode to be executed by the device in accordance with the specification of the processing contents of the interactive processing described in such a scene description.

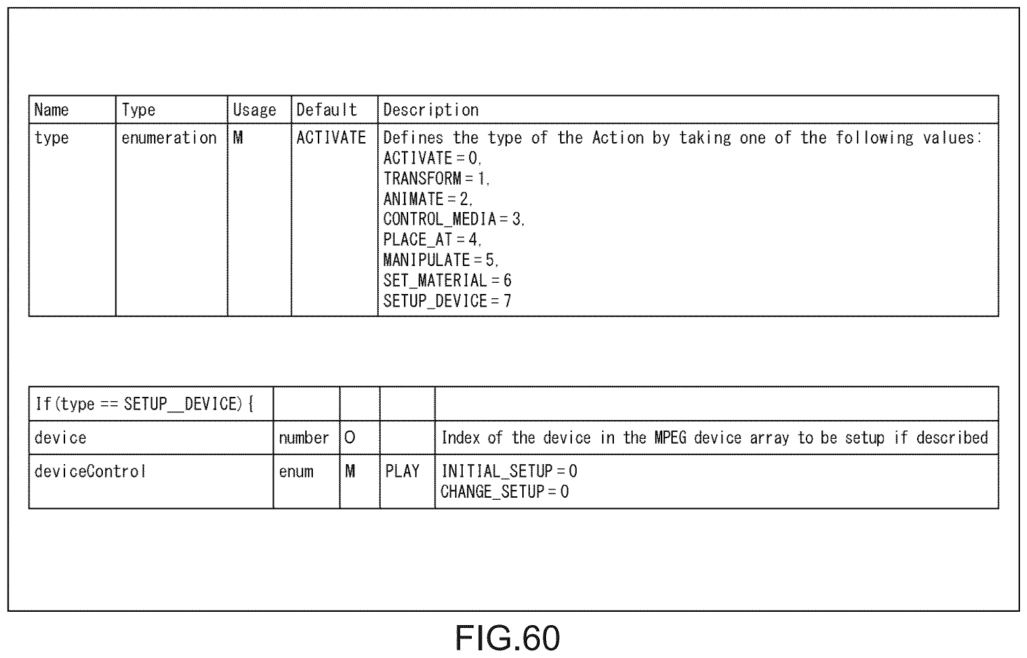

In the example shown in FIG. 60, INITIAL_SETUP and CHANGE_SETUP may be provided as deviceControl. INITIAL_SETUP specifies such setup that the initialized device is enabled to immediately execute the action. CHANGE_SETUP specifies such setup that the device is enabled to execute a desired action in a plurality of types of actions that can be executed or setup to switch the operation mode to a desired mode.

By applying the option in this manner, more detailed control (more specific operation specification) becomes possible.

### <Method 3>

For example, in a case where interactive media that are an interactive play target are present in another apparatus (e.g., a server such as a CDN), it is necessary to acquire the interactive media before the interactive play. For the interactively play with no delay, the interactive media needs to be acquired at a suitable timing before the play. Moreover, depending on configuration and function of the output device, there can be a case where it is necessary to set the media data to the output device.

However, in the framework (MPEG-I Scene Description Interactivity Framework) described in Non-Patent Literature 3, as described above, it has been difficult to execute such preliminary processing as the interactive processing because there are no definitions for such processing before the play (also referred to as preliminary processing) in the action.

In view of this, as shown in the third line from above of the table in FIG. 49, an action type that specifies play pre-processing with respect to the media may be extensively defined (Method 3).

For example, in the scene description, as the type of the processing contents of the interactive processing, it may be specified that the preliminary processing is executed with respect to the interactive media before the interactive media are interactively played. The providing unit of the second information processing apparatus may provide such a scene description. The first information processing apparatus may further include a preliminary processing unit that executes the preliminary processing in accordance with the processing contents of that interactive processing in a case where the execution condition of the interactive processing has been met in such a scene description.

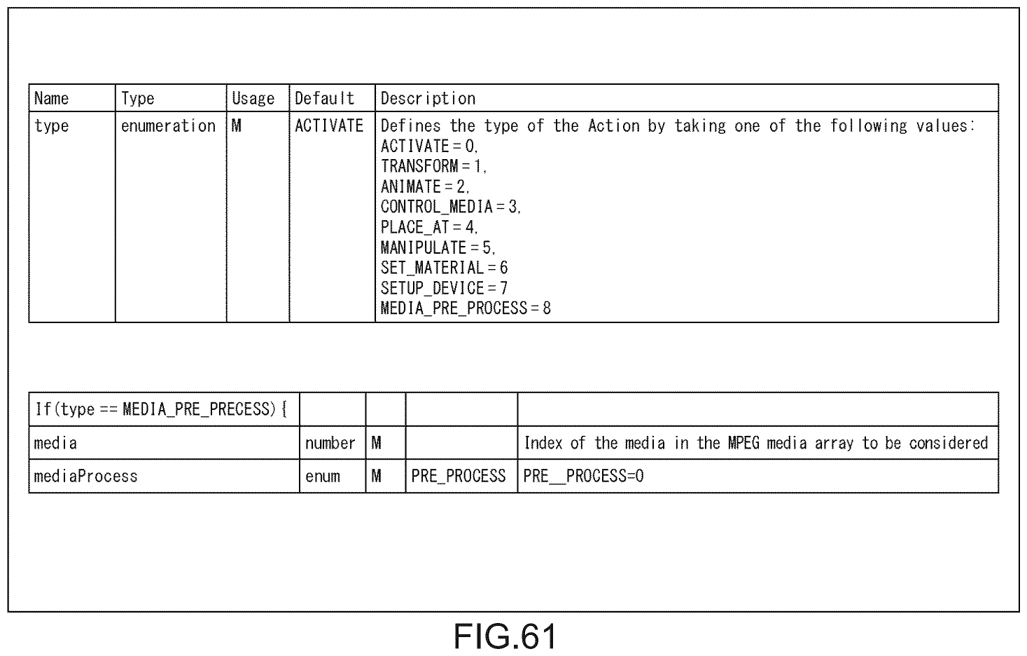

For example, as shown in FIG. 61, MEDIA_PRE_PROCESS may be additionally defined in the type of the action (processing contents). MEDIA_PRE_PROCESS is an action related to the preliminary processing with respect to the media (the processing executed before the media are played). In a case where this type is specified, the preliminary processing is executed as the interactive processing (on the basis of the trigger).

The target media of this preliminary processing and the contents of the preliminary processing may be enabled to be specified.

For example, in the scene description, a processing target of the preliminary processing may be specified by using an index of the media. The providing unit of the second information processing apparatus may provide such a scene description. The preliminary processing unit of the first information processing apparatus may execute the preliminary processing with respect to the interactive media specified as the processing target in such a scene description.

For example, as shown in FIG. 61, in a case where MEDIA PRE PROCESS is specified as the type of the action, the media can be set as an option. The media are an item that specifies media that are a target of the preliminary processing. Media to be preliminarily processed can be specified by using an index of the media.

Moreover, in a case where MEDIA PRE PROCESS is specified as the type of the action, mediaProcess can be set as an option. MediaProcess is an item that specifies the contents of the preliminary processing. That is, by this item, which type of processing is to be performed is specified.

By doing so, with respect to desired media, preliminary processing of desired contents can be executed as the interactive processing.

This mediaProcess may be any value.

For example, in the scene description, as contents of the preliminary processing, acquisition of the interactive media may be specified. The providing unit of the second information processing apparatus may provide such a scene description. The preliminary processing unit of the first information processing apparatus may acquire the encoded data of the interactive media as the preliminary processing in accordance with the specification of the contents of the preliminary processing in such a scene description.

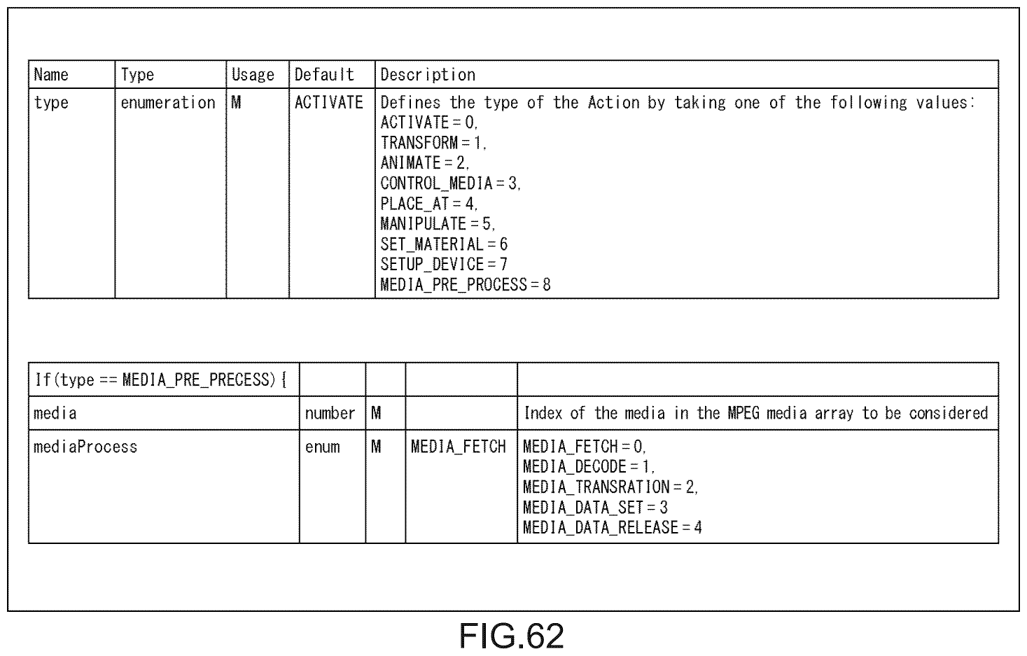

For example, as shown in FIG. 62, MEDIA_FETCH may be provided as mediaProcess. MEDIA_FETCH specifies processing of acquiring the media locally at a terminal as the preliminary processing. That is, by setting this MEDIA_FETCH as mediaProcess in the scene description, the media can be acquired from, for example, a server or the like as the preliminary processing.

Moreover, in the scene description, as contents of the preliminary processing, acquisition and decoding of the interactive media may be specified. The providing unit of the second information processing apparatus may provide such a scene description. The preliminary processing unit of the first information processing apparatus may acquire and decode the encoded data of the interactive media as the preliminary processing in accordance with the specification of the contents of the preliminary processing in such a scene description.

For example, as shown in FIG. 62, MEDIA_DECODE may be provided as mediaProcess. MEDIA_DECODE specifies processing to decoding of the media as the preliminary processing. That is, by setting this MEDIA DECODE as mediaProcess in the scene description, it is possible to acquire the encoded data of the media from, for example, a server or the like, decode it, and generate data about the media as the preliminary processing.

Moreover, in the scene description, as contents of the preliminary processing, acquisition, decoding, and transformation of the interactive media may be specified. The providing unit of the second information processing apparatus may provide such a scene description. The preliminary processing unit of the first information processing apparatus may acquire and decode the encoded data of the interactive media as the preliminary processing in accordance with the specification of the contents of the preliminary processing in such a scene description and transform the decoded interactive media in accordance with properties of the device that outputs the interactive media.

For example, as shown in FIG. 62, MEDIA_TRANSRATION may be provided as mediaProcess. MEDIA_TRANSRATION specifies processing to transforming the decoded media in accordance with the device properties as the preliminary processing. That is, in the scene description, by setting this MEDIA_TRANSRATION as mediaProcess, it is possible to acquire the encoded data of the media and decode the encoded data to generate data about the media as the preliminary processing. Then, it is possible to transform the generated data about the media in accordance with properties of the device that outputs the media.

Moreover, in the scene description, as contents of the preliminary processing, the setting of the interactive media may be specified. The providing unit of the second information processing apparatus may provide such a scene description. The preliminary processing unit of the first information processing apparatus may set the interactive media as a memory of a device that outputs the interactive media as the preliminary processing in accordance with the specification of the contents of the preliminary processing in such a scene description.

For example, as shown in FIG. 62, MEDIA_DATA_SET may be provided as mediaProcess. MEDIA_DATA_SET specifies processing of setting media to (the memory of) the output device as the preliminary processing. That is, by setting this MEDIA_DATA_SET as mediaProcess in the scene description, the memory of the output device can be set to the media as the preliminary processing. That is, the device can be enabled to output (play) the media.

Moreover, in the scene description, as contents of the preliminary processing, deletion of the interactive media may be specified. The providing unit of the second information processing apparatus may provide such a scene description. The preliminary processing unit of the first information processing apparatus may delete the interactive media set to the memory of the device that outputs the interactive media in accordance with the specification of the contents of the preliminary processing in such a scene description as the preliminary processing.

For example, as shown in FIG. 62, MEDIA_DATA_RELEASE may be provided as mediaProcess. MEDIA_DATA_RELEASE specifies processing of releasing (deleting) the media set to the memory of the output device as the preliminary processing. That is, by setting this MEDIA_DATA_RELEASE as mediaProcess in the scene description, the media can be released (deleted) from the memory of the output device as the preliminary processing.

By applying the option in this manner, more detailed control (more specific operation specification) becomes possible.

### <Method 4>

The setup described in <Method 2> and the preliminary processing described in <Method 3> may be executed before the scene is rendered. That is, in a case where such processing is set as the interactive processing, in the scene description, there are a behavior executed when the scene is rendered and a behavior executed before the rendering. Therefore, unnecessary processing may increase because there is a need for checking behaviors not executed.

In view of this, as shown in the fourth line from above of the table in FIG. 49, an object of a behavior that specifies play pre-processing with respect to the media may be extensively defined (Method 4).

For example, in the scene description, a behavior specified to indicate the execution condition and the processing contents of the preliminary processing executed with respect to the interactive media before the interactive media are interactively played may be described. The providing unit of the second information processing apparatus may provide such a scene description. The first information processing apparatus may further include a preliminary processing unit that executes the preliminary processing in accordance with the behavior described in such a scene description.

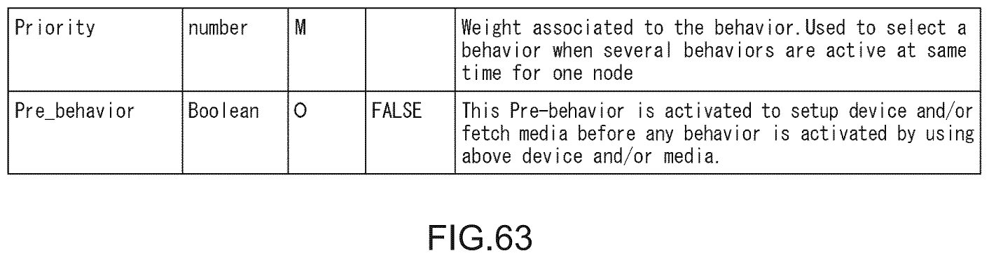

For example, as shown in FIG. 63, the behavior for the preliminary processing “Pre_behavior” may be provided as an object of the behavior. Pre_behavior is a behavior for defining the preliminary processing and ties a trigger of the preliminary processing to an action of the preliminary processing. Here, the preliminary processing refers to processing performed before rendering the scene. The processing contents may be any processing contents, and not only the above-mentioned preliminary processing, but also the setup of the device can also be included. For example, the setup of the initialized device may be included in this preliminary processing.

By defining “Pre-behavior” of the behavior, it is possible to clearly indicate that it is necessary to execute processing (behavior) relative to the scene description before performing the rendering operation of the scene of the scene description. It should be noted that this Pre-behavior can be applied to each example of Methods 2 and 3 described above.

By specifying that the behavior is for the preliminary processing in this manner, the play apparatus is capable of easily grasping that the behavior is for the preliminary processing. Therefore, for example, it is possible to prevent referencing the behavior for the preliminary processing and analyzing at the time of rendering the scene, and an increase in load of the play processing can be suppressed.

It should be noted that the trigger and the action for the preliminary processing may be provided in place of providing the behavior for the preliminary processing.

For example, in the scene description, an execution condition in which it is specified that it is for the preliminary processing executed with respect to the interactive media before the interactive media are interactively played and processing contents which have been specified to be for the preliminary processing may be described. The providing unit of the second information processing apparatus may provide such a scene description. The first information processing apparatus may further include a preliminary processing unit that executes the preliminary processing in accordance with the processing contents for the preliminary processing in a case where the execution condition for the preliminary processing described in such a scene description has been met.

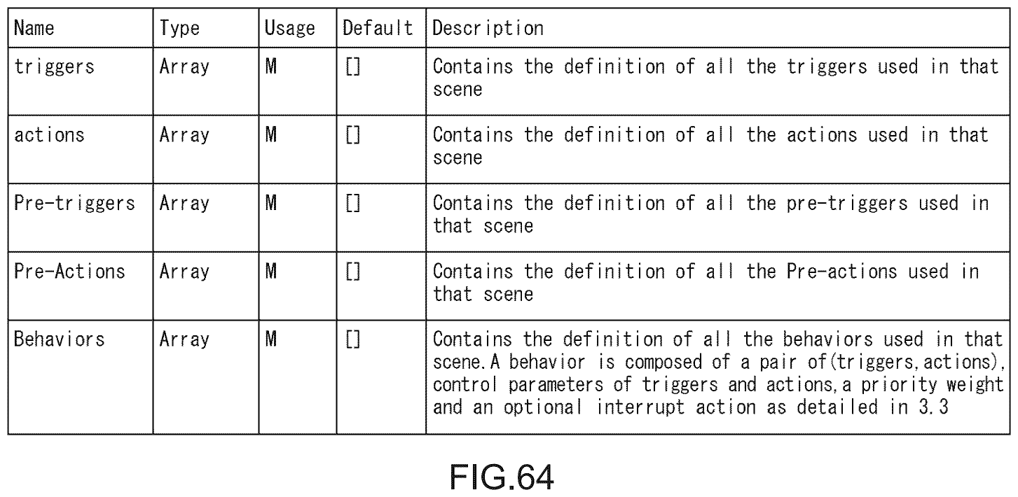

For example, as shown in FIG. 64, “Pre-triggers” and “Pre-Actions” may be provided. The Pre-triggers is a trigger for the preliminary processing and specifies the execution condition of the preliminary processing. In other words, the execution condition specified as the Pre-triggers is the execution condition of the preliminary processing. The Pre-Actions specifies the processing contents (action) of the preliminary processing. In other words, the processing contents specified as the Pre-Actions are the processing contents of the preliminary processing.

By specifying that it is the trigger for the preliminary processing and the action in this manner, whether it is the preliminary processing or processing performed in rendering the scene can be easily identified in the scene description. Therefore, the API processing becomes easy. It should be noted that the Pre-triggers and Pre-Actions can be applied to each example of Methods 2 and 3 described above.

### <Method 5>

In a case of controlling the trigger and the action of the behavior as a scene (i.e., in a case of controlling the interactive processing by using the scene description), depending on the operation contents of the action, there can be a case where an operation as intended by the content author cannot be obtained. For example, in a situation where a device operation with a low delay is requested, the processing delay may lower the quality of the user experience under the control of the scene description.

In view of this, as shown in the fourth line from above of the table in FIG. 49, an object of a behavior that specifies shift of control from the scene description to the application may be specified (Method 5). That is, the interactive media may be interactively played under the control of the application outside the scene description. Then, control to do so may be performed in the scene description. For example, such a control function may be added to the behavior.

For example, in the scene description, a behavior specified to control the interactive processing in an application may be described. The providing unit of the second information processing apparatus may provide such a scene description. The play unit of the first information processing apparatus may cause the application to control that interactive processing in accordance with the behavior described in such a scene description.

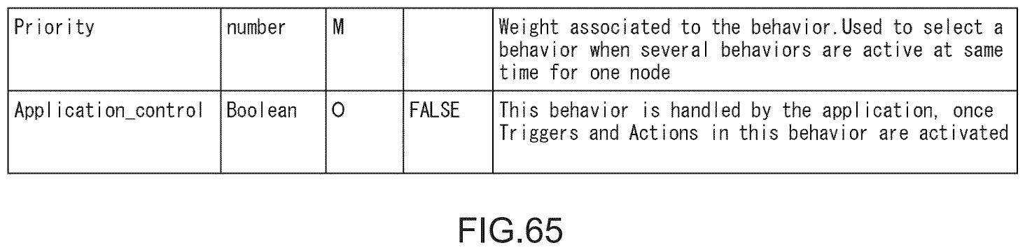

For example, as shown in FIG. 65, “Application_control” may be provided as an object of the behavior. This Application_control specifies that this behavior is processed by the application when the trigger and the action of this behavior are activated. That is, the interactive processing indicated by this behavior is not controlled in the scene description. For example, in a case where Application_control has been set, the execution condition (trigger) is sensed, media are set to a device that executes that processing contents (action), and an action operation is executed. With this function, the content author's intension that executing the processing outside the scene description is active can be indicated.

For example, it is assumed that a trigger (execution condition) of a first behavior is that the fingers approach the trigger of a pistol-type controller beyond a threshold, and the action (processing contents) is a tactile feedback. Moreover, in this behavior, it is assumed that Application_control has been set to true (=1). Moreover, it is assumed that the trigger (execution condition) of the second behavior is pulling the trigger of the pistol-type controller with the fingers and the action (processing contents) is a vibration feedback that expresses a state in which the pistol has been fired. Moreover, it is assumed that in this behavior, Application_control has been set to false (=0).

Since the first behavior is set as Application_control=1, it becomes out of control of the scene description after it is executed once, and the interactive media are input to a tactile device when the trigger happens. Therefore, it is possible to realize a tactile feedback with an ultra low delay. That is, this first behavior is not controlled in the scene description. On the other hand, since the second behavior is a feedback that does not require an ultra low delay, the trigger and the action are controlled by the scene description. In this manner, it is possible to perform play which is suitable for the content author's intension.

It should be noted that this “Application_control” may be defined as the type of the action in place of the behavior.

### <Combination>

Methods 1 to 5 described above may be applied alone or may be applied in appropriate combination. Moreover, these methods may be applied in combination with a method other than those described above.

### 4. FIRST EMBODIMENT

### <File Generation Apparatus>

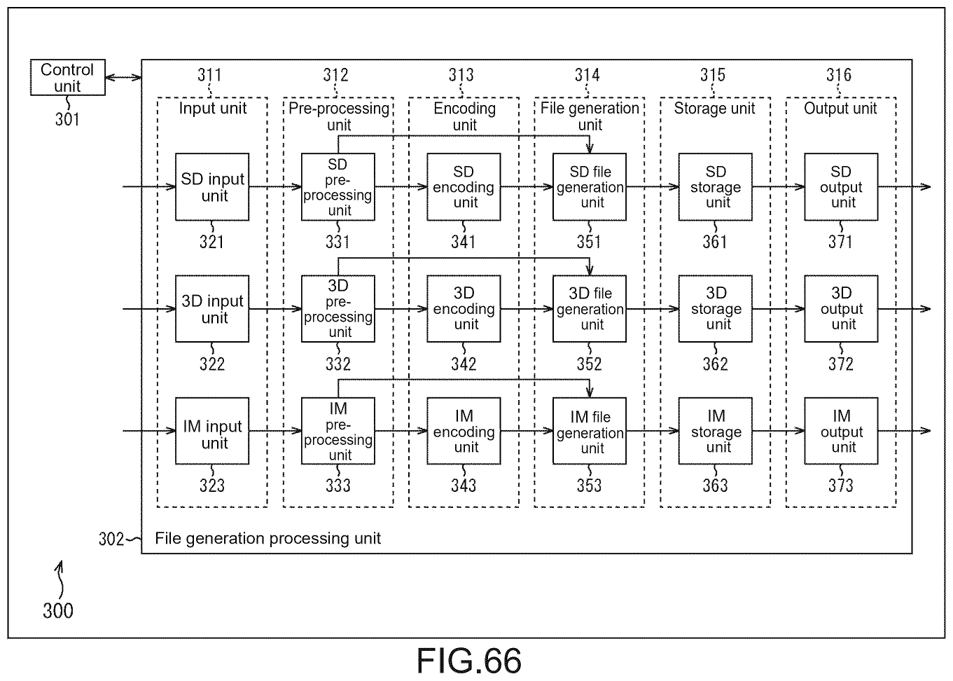

The present technology described above can be applied to any apparatus. FIG. 66 is a block diagram showing an example of a configuration of a file generation apparatus that is an aspect of the information processing apparatus to which the present technology is applied. A file generation apparatus 300 shown in FIG. 66 is an apparatus that encodes 3D object content with which interactive media such as haptic media have been associated (e.g., 3D data such as a point cloud) and stores a file. Moreover, the file generation apparatus 300 generates a scene description file of the 3D object content.

It should be noted that FIG. 66 shows main elements such as processing units and flows of data and all elements may not be shown in FIG. 66. That is, in the file generation apparatus 300, processing units not shown as blocks in FIG. 66 may be present and processing and flows of data not shown as the arrows and the like in FIG. 66 may be present.

As shown in FIG. 66, the file generation apparatus 300 includes a control unit 301 and a file generation processing unit 302. The control unit 301 controls the file generation processing unit 302. The file generation processing unit 302 is controlled by the control unit 301 to perform processing related to generation of the file.

The file generation processing unit 302 includes an input unit 311, a pre-processing unit 312, an encoding unit 313, a file generation unit 314, a storage unit 315, and an output unit 316.

The input unit 311 performs processing related to acquisition of data provided from the outside of the file generation apparatus 300. Therefore, it can also be said that the input unit 311 is an acquisition unit. The input unit 311 includes an SD input unit 321, a 3D input unit 322, and an IM input unit 323. The SD input unit 321 acquires scene configuration data (data used for scene description generation) provided to the file generation apparatus 300. The SD input unit 321 generates a scene description by using the acquired scene configuration data. Therefore, it can also be said that the SD input unit 321 is a generation unit (or an SD generation unit) that generates a scene description. It should be noted that the scene description may be provided from the outside of the file generation apparatus 300. In that case, the SD input unit 321 only needs to acquire a scene description and skip (omit) the scene description generation. Therefore, it can also be said that the SD input unit 321 is an acquisition unit (or an SD acquisition unit) that acquires scene configuration data or a scene description. The SD input unit 321 provides the acquired or generated scene description to an SD pre-processing unit 331 of the pre-processing unit 312. The 3D input unit 322 acquires 3D data provided to the file generation apparatus 300. The 3D input unit 322 provides the acquired 3D data to a 3D pre-processing unit 332 of the pre-processing unit 312. Therefore, it can also be said that the 3D input unit 322 is an acquisition unit (or a 3D acquisition unit) that acquires 3D data. The IM input unit 323 acquires data (also referred to as IM data) of interactive media provided to the file generation apparatus 300. The IM input unit 323 provides the acquired IM data to an IM pre-processing unit 333 of the pre-processing unit 312. Therefore, it can also be said that the IM input unit 323 is an acquisition unit (or an IM acquisition unit) that acquires IM data.

The pre-processing unit 312 executes processing related to pre-processing, which is performed before encoding, with respect to data provided from the input unit 311. The pre-processing unit 312 includes the SD pre-processing unit 331, the 3D pre-processing unit 332, and the IM pre-processing unit 333. The SD pre-processing unit 331 acquires, for example, from a scene description provided from the SD input unit 321, information necessary for generating a file (also referred to as SD file) that stores the scene description and provides the information to an SD file generation unit 351 of the file generation unit 314. Moreover, the SD pre-processing unit 331 stores information regarding the 3D data provided from the 3D pre-processing unit 332, information regarding the IM data provided from the IM pre-processing unit 333, and information regarding the alternative media data in the scene description. At that time, the SD pre-processing unit 331 may generate new information on the basis of the provided information and store the new information in the scene description. Moreover, the SD pre-processing unit 331 provides the scene description to an SD encoding unit 341 of the encoding unit 313. The 3D pre-processing unit 332 acquires, for example, from the 3D data provided from the 3D input unit 322, information necessary for generating a file (also referred to as 3D file) that stores the 3D data and provides the file to a 3D file generation unit 352 of the file generation unit 314. Moreover, the 3D pre-processing unit 332 extracts, from the 3D data, information to be stored in the scene description and information for generating the information to be stored in the scene description and provides them to the SD pre-processing unit 331 as information regarding the 3D data. Moreover, the 3D pre-processing unit 332 provides the 3D data to a 3D encoding unit 342 of the encoding unit 313. The IM pre-processing unit 333 acquires, for example, from the IM data provided from the IM input unit 323, information necessary for generating a file (also referred to as IM file) that stores the IM data and provides the information to an IM file generation unit 353 of the file generation unit 314. Moreover, the IM pre-processing unit 333 extracts, from the IM data, the information to be stored in the scene description and information for generating the information to be stored in the scene description and provides them the SD pre-processing unit 331 as information regarding the IM data. Moreover, the IM pre-processing unit 333 provides the IM data to an IM encoding unit 343 of the encoding unit 313.

The encoding unit 313 executes processing related to encoding of the data provided from the pre-processing unit 312. The encoding unit 313 includes the SD encoding unit 341, the 3D encoding unit 342, and the IM encoding unit 343. The SD encoding unit 341 encodes a scene description provided from the SD pre-processing unit 331 and provides the encoded data to the SD file generation unit 351 of the file generation unit 314. The 3D encoding unit 342 encodes 3D data provided from the 3D pre-processing unit 332 and provides the encoded data to the 3D file generation unit 352 of the file generation unit 314. The IM encoding unit 343 encodes IM data provided from the IM pre-processing unit 333 and provides the encoded data to the IM file generation unit 353 of the file generation unit 314.

The file generation unit 314 performs processing related to generation of the file and the like. The file generation unit 314 includes the SD file generation unit 351, the 3D file generation unit 352, and the IM file generation unit 353. The SD file generation unit 351 generates an SD file that stores the scene description on the basis of information provided from the SD pre-processing unit 331 and the SD encoding unit 341. The SD file generation unit 351 provides the SD file to an SD storage unit 361 of the storage unit 315. The 3D file generation unit 352 generates a 3D file that stores the encoded data of the 3D data on the basis of information provided from the 3D pre-processing unit 332 and the 3D encoding unit 342. The 3D file generation unit 352 provides the 3D file to a 3D storage unit 362 of the storage unit 315. The IM file generation unit 353 generates an IM file that stores the encoded data of the IM data on the basis of information provided from the IM pre-processing unit 333 and the IM encoding unit 343. The IM file generation unit 353 provides the IM file to an IM storage unit 363 of the storage unit 315.

The storage unit 315 includes any storage medium, e.g., a hard disk or a semiconductor memory, and executes processing related to data storage. The storage unit 315 includes the SD storage unit 361, the 3D storage unit 362, and the IM storage unit 363. The SD storage unit 361 stores an SD file provided from the SD file generation unit 351. Moreover, the SD storage unit 361 provides the SD file to the SD output unit 371 in accordance with a request from an SD output unit 371 or the like of the output unit 316 or at a predetermined timing. The 3D storage unit 362 stores a 3D file provided from the 3D file generation unit 352. Moreover, the 3D storage unit 362 provides the 3D file to the 3D output unit 372 in accordance with a request from a 3D output unit 372 or the like of the output unit 316 or at a predetermined timing. The IM storage unit 363 stores an IM file provided from the IM file generation unit 353. Moreover, the IM storage unit 363 provides the IM file to the IM output unit 373 in accordance with a request from an IM output unit 373 or the like of the output unit 316 or at a predetermined timing.

The output unit 316 acquires a file and the like provided from the storage unit 315 and outputs the file and the like to the outside of the file generation apparatus 300 (e.g., a distribution server or a play apparatus). The output unit 316 includes the SD output unit 371, the 3D output unit 372, and the IM output unit 373. The SD output unit 371 acquires an SD file read out from the SD storage unit 361 and outputs the SD file to the outside of the file generation apparatus 300. The 3D output unit 372 acquires a 3D file read out from the 3D storage unit 362 and outputs the 3D file to the outside of the file generation apparatus 300. The IM output unit 373 acquires an IM file read out from the IM storage unit 363 and outputs the IM file to the outside of the file generation apparatus 300.

That is, it can also be said that the output unit 316 is a providing unit that provides a file to the other apparatus. It can also be said that the SD output unit 371 is a providing unit (or an SD file providing unit) that provides an SD file to the other apparatus. It can also be said that the 3D output unit 372 is a providing unit (or a 3D file providing unit) that provides a 3D file to the other apparatus. Moreover, it can also be said that the IM output unit 373 is a providing unit (or an IM file providing unit) that provides an IM file to the other apparatus.

In the file generation apparatus 300 with the above-mentioned configuration, the above-mentioned second information processing apparatus is employed and in <3. Media Definition Extension for Interactive Play>, the present technology described above may be applied. For example, any one or more of Methods 1 to 5 described above may be applied to this file generation apparatus 300.

By doing so, the media is enabled to be interactively processed by the scene description.

### <Flow 1 of File Generation Processing>

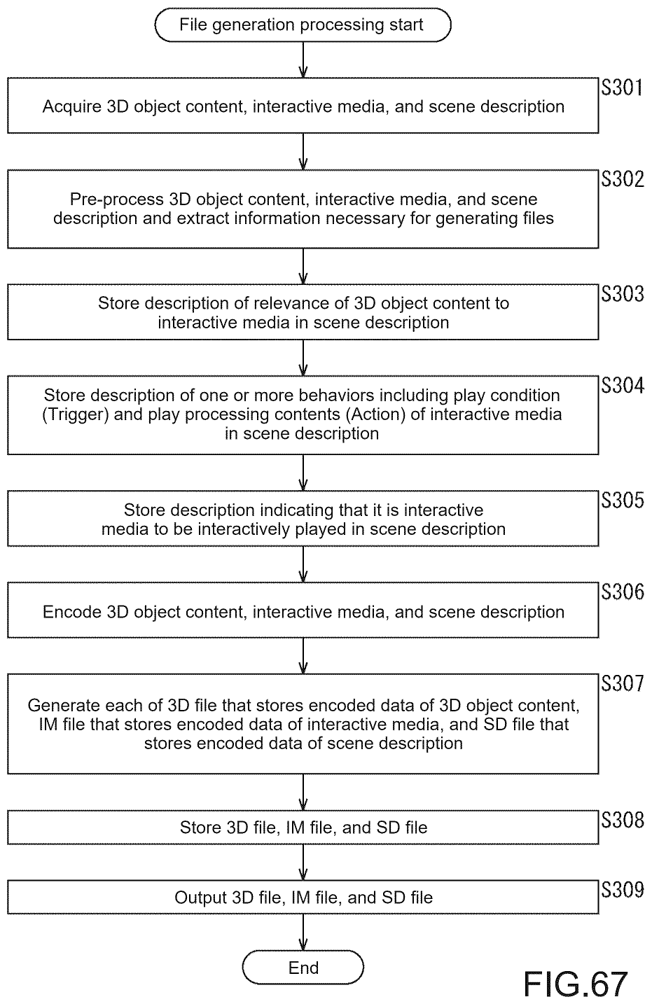

Next, a flow of file generation processing executed by the file generation apparatus 300 will be described. As described above, Method 1 described above may be applied to the file generation apparatus 300. An example of the flow of the file generation processing in that case will be described with reference to the flowchart in FIG. 67.

When the file generation processing has been started, in Step S301, the SD input unit 321 acquires a scene description. It should be noted that the SD input unit 321 may acquire scene configuration data and generate a scene description by using the scene configuration data. The 3D input unit 322 acquires 3D object content (3D data). The IM input unit 323 acquires interactive media (IM data).

In Step S302, the SD pre-processing unit 331 performs pre-processing on the scene description and extracts information necessary for generating an SD file from the scene description. The 3D pre-processing unit 332 performs pre-processing on the 3D data and extracts information necessary for generating a 3D file from the 3D data. The IM pre-processing unit 333 performs pre-processing on the IM data and extracts information necessary for generating an IM file from the IM data.

In Step S303, the 3D pre-processing unit 332 generates information regarding the 3D data. Moreover, the IM pre-processing unit 333 generates information regarding the IM data. The SD pre-processing unit 331 generates, on the basis of such information and the like, a description of the relevance of the 3D object content (3D data) to the interactive media (IM data) and stores the description in the scene description.

In Step S304, the SD pre-processing unit 331 generates a description of one or more behaviors including a play condition (trigger) of the interactive media (IM data) and its play processing contents (action) and stores the description in the scene description.

In Step S305, the SD pre-processing unit 331 generates a description indicating that it is interactive media (IM data) to be interactively played and stores the description in the scene description.

In Step S306, the SD encoding unit 341 encodes the scene description to generate encoded data of the scene description. The 3D encoding unit 342 encodes the 3D object content (3D data) to generate encoded data of the 3D data. The IM encoding unit 343 encodes the interactive media (IM data) to generate encoded data of the IM data.

In Step S307, the SD file generation unit 351 generates an SD file that stores the encoded data of the scene description. The 3D file generation unit 352 generates a 3D file that stores the encoded data of the 3D data. The IM file generation unit 353 generates an IM file that stores the encoded data of the IM data.

In Step S308, the SD storage unit 361 stores the SD file. The 3D storage unit 362 stores the 3D file. The IM storage unit 363 stores the IM file.

In Step S309, the SD output unit 371 outputs the SD file and provides the SD file to the other apparatus (e.g., a client apparatus). The 3D output unit 372 outputs the 3D file and provides the 3D file to the other apparatus (e.g., a client apparatus). The IM output unit 373 outputs the IM file and provides the IM file to the other apparatus (e.g., a client apparatus).

When the processing in Step S309 ends, the file generation processing ends.

By executing the respective processing in this manner, the file generation apparatus 300 is capable of applying Method 1 of the present technology. Therefore, the media is enabled to be interactively processed by the scene description.

### <Flow 2 of File Generation Processing>

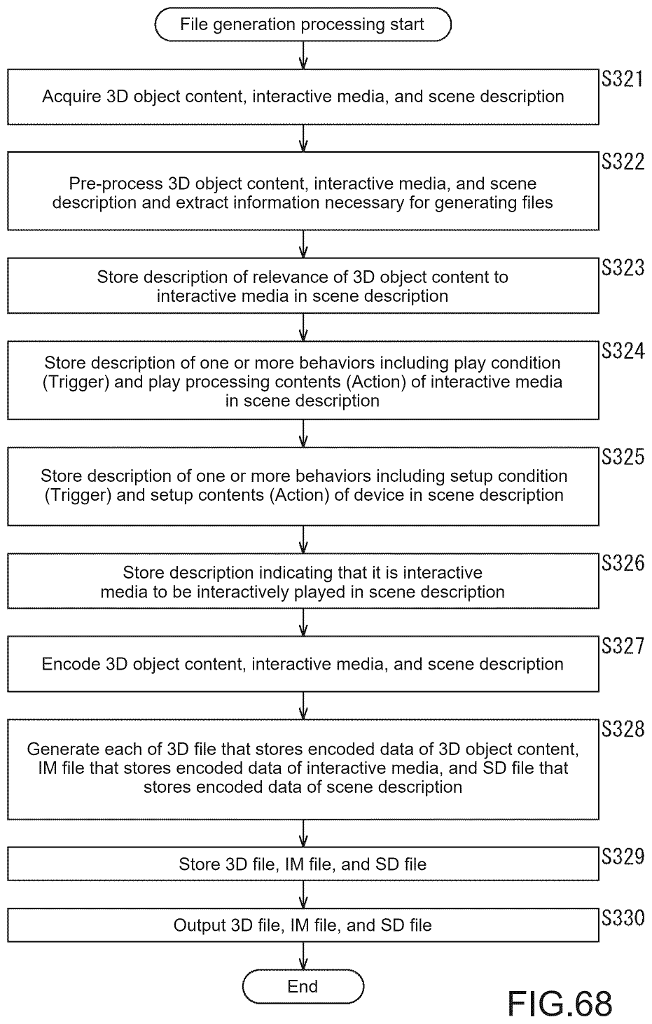

Moreover, Methods 1 and 2 described above may be applied to the file generation apparatus 300. An example of the flow of the file generation processing in that case will be described with reference to the flowchart in FIG. 68.

When the file generation processing has been started, the respective processing in Steps S321 to S324 is executed as in the respective processing in Steps S301 to S304 (FIG. 67).

In Step S325, the SD pre-processing unit 331 generates a description of one or more behaviors including a setup condition (trigger) of the device and its setup contents (action) and stores the description in the scene description.

The respective processing in Steps S326 to S330 is executed as in the respective processing in Steps S305 to S309 (FIG. 67).

When the processing in Step S330 ends, the file generation processing ends.

By executing the respective processing in this manner, the file generation apparatus 300 is capable of applying Methods 1 and 2 of the present technology. Therefore, the media is enabled to be interactively processed by the scene description.

### <Flow 3 of File Generation Processing>

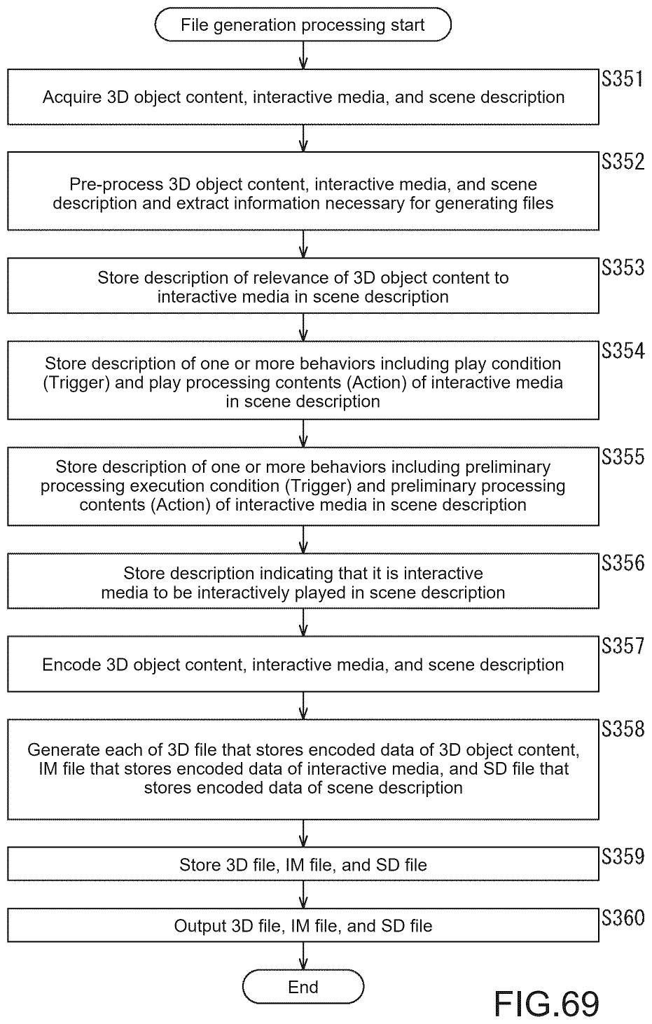

Moreover, Methods 1 and 3 described above may be applied to the file generation apparatus 300. An example of the flow of the file generation processing in that case will be described with reference to the flowchart in FIG. 69.

When the file generation processing has been started, the respective processing in Steps S351 to S354 is executed as in the respective processing in Steps S301 to S304 (FIG. 67).

In Step S355, the SD pre-processing unit 331 generates a description of one or more behaviors including a preliminary processing execution condition (trigger) of the interactive media and its preliminary processing contents (action) and stores the description in the scene description.

The respective processing in Steps S356 to S360 is executed as in the respective processing in Steps S305 to S309 (FIG. 67).

When the processing in Step S360 ends, the file generation processing ends.

By executing the respective processing in this manner, the file generation apparatus 300 is capable of applying Methods 1 and 3 of the present technology. Therefore, the media is enabled to be interactively processed by the scene description.

### <Flow 4 of File Generation Processing>

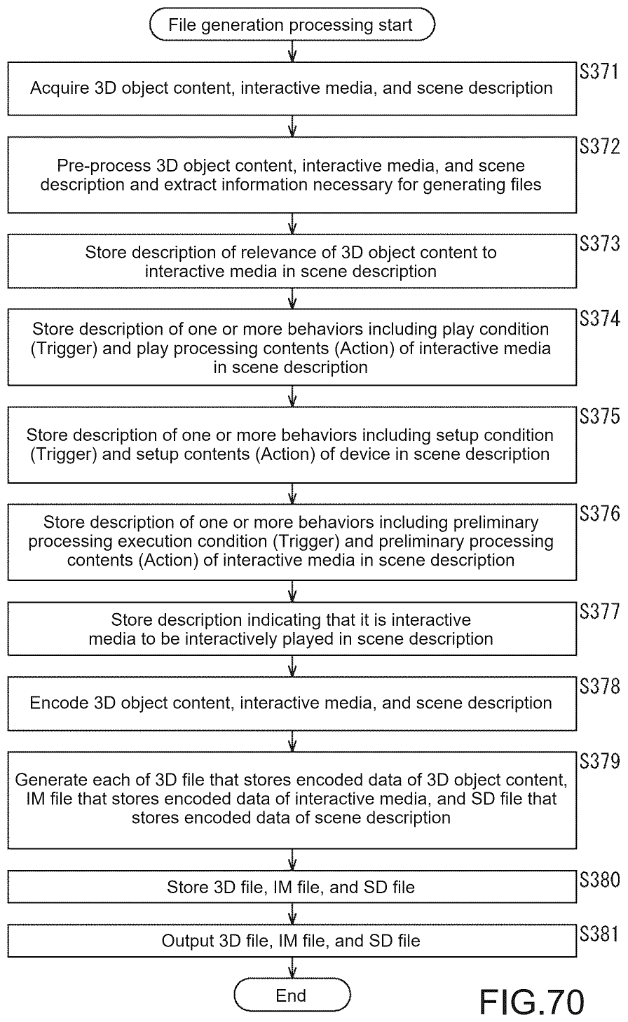

Moreover, Methods 1 to 3 described above may be applied to the file generation apparatus 300. An example of the flow of the file generation processing in that case will be described with reference to the flowchart in FIG. 70.

When the file generation processing has been started, the respective processing in Steps S371 to S375 is executed as in the respective processing in Steps S321 to S325 (FIG. 68).

The respective processing in Steps S376 to S381 is executed as in the respective processing in Steps S355 to S360 (FIG. 69).

When the processing in Step S381 ends, the file generation processing ends.

By executing the respective processing in this manner, the file generation apparatus 300 is capable of applying Methods 1 to 3 of the present technology. Therefore, the media is enabled to be interactively processed by the scene description.

### <Flow 5 of File Generation Processing>

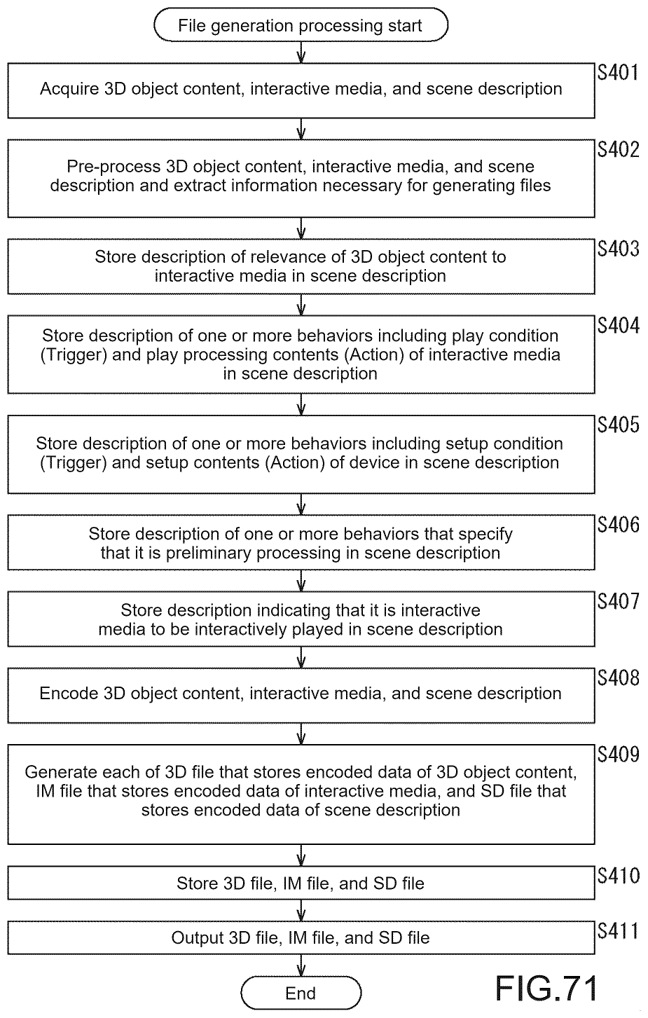

Moreover, Methods 1, 2, and 4 described above may be applied to the file generation apparatus 300. An example of the flow of the file generation processing in that case will be described with reference to the flowchart in FIG. 71.

When the file generation processing has been started, the respective processing in Steps S401 to S405 is executed as in the respective processing in Steps S371 to S375 (FIG. 70).

In Step S406, the SD pre-processing unit 331 generates a description of one or more behaviors that specifies that it is preliminary processing, and stores the description in the scene description.

The respective processing in Steps S407 to S411 is executed as in the respective processing in Steps S377 to S381 (FIG. 70).

When the processing in Step S411 ends, the file generation processing ends.

By executing the respective processing in this manner, the file generation apparatus 300 is capable of applying Methods 1, 2, and 4 of the present technology. Therefore, the media is enabled to be interactively processed by the scene description.

### <Flow 6 of File Generation Processing>

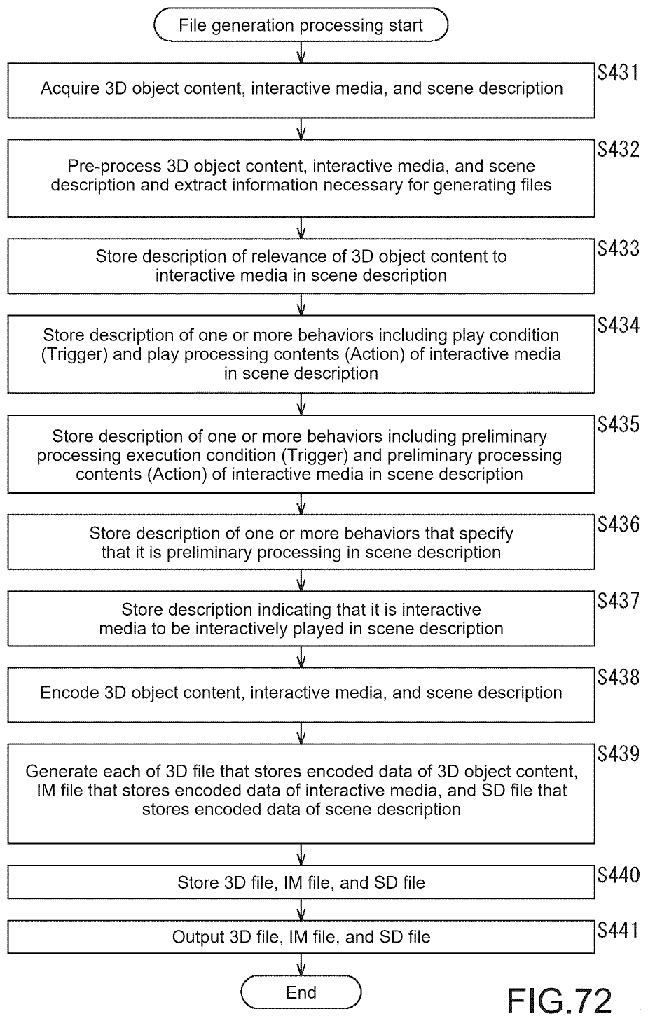

Moreover, Methods 1, 3, and 4 described above may be applied to the file generation apparatus 300. An example of the flow of the file generation processing in that case will be described with reference to the flowchart in FIG. 72.

When the file generation processing has been started, the respective processing in Steps S431 to S434 is executed as in the respective processing in Steps S401 to S404 (FIG. 71).

In Step S435, the SD pre-processing unit 331 generates a description of one or more behaviors including a preliminary processing execution condition (trigger) of the interactive media and its preliminary processing contents (action) and stores the description in the scene description.

The respective processing in Steps S436 to S441 is executed as in the respective processing in Steps S406 to S411 (FIG. 71).

When the processing in Step S441 ends, the file generation processing ends.

By executing the respective processing in this manner, the file generation apparatus 300 is capable of applying Methods 1, 3, and 4 of the present technology. Therefore, the media is enabled to be interactively processed by the scene description.

### <Flow 7 of File Generation Processing>

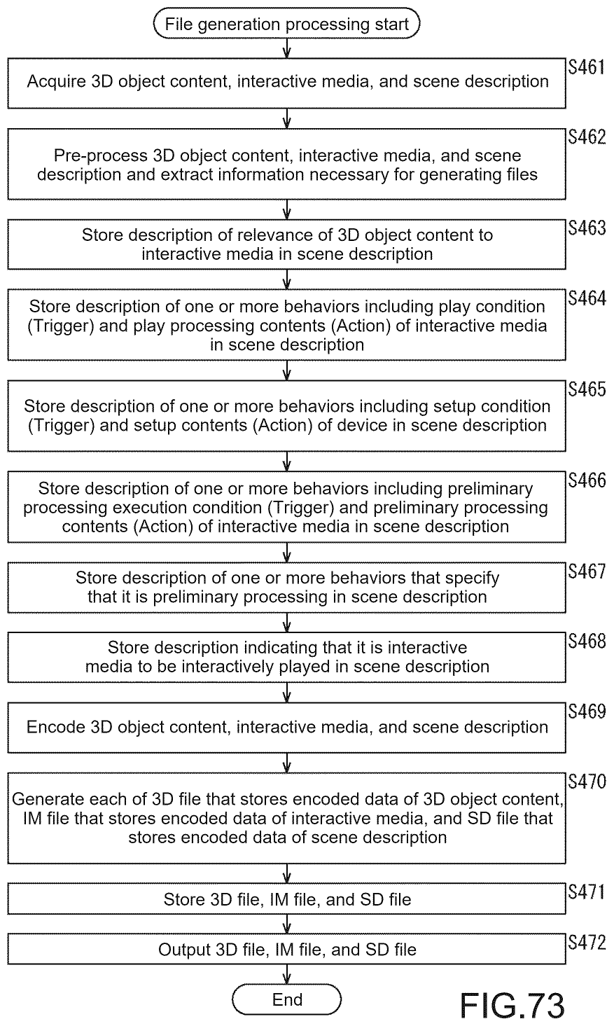

Moreover, Methods 1 to 4 described above may be applied to the file generation apparatus 300. An example of the flow of the file generation processing in that case will be described with reference to the flowchart in FIG. 73.

When the file generation processing has been started, the respective processing in Steps S461 to S464 is executed as in the respective processing in Steps S431 to S434 (FIG. 72).

In Step S465, the SD pre-processing unit 331 generates a description of one or more behaviors including a setup condition (trigger) of the device and setup contents (action) and stores the description in the scene description.

The respective processing in Steps S466 to S472 is executed as in the respective processing in Steps S435 to S441 (FIG. 72).

When the processing in Step S472 ends, the file generation processing ends.

By executing the respective processing in this manner, the file generation apparatus 300 is capable of applying Methods 1 to 4 of the present technology. Therefore, the media is enabled to be interactively processed by the scene description.

### <Flow 8 of File Generation Processing>

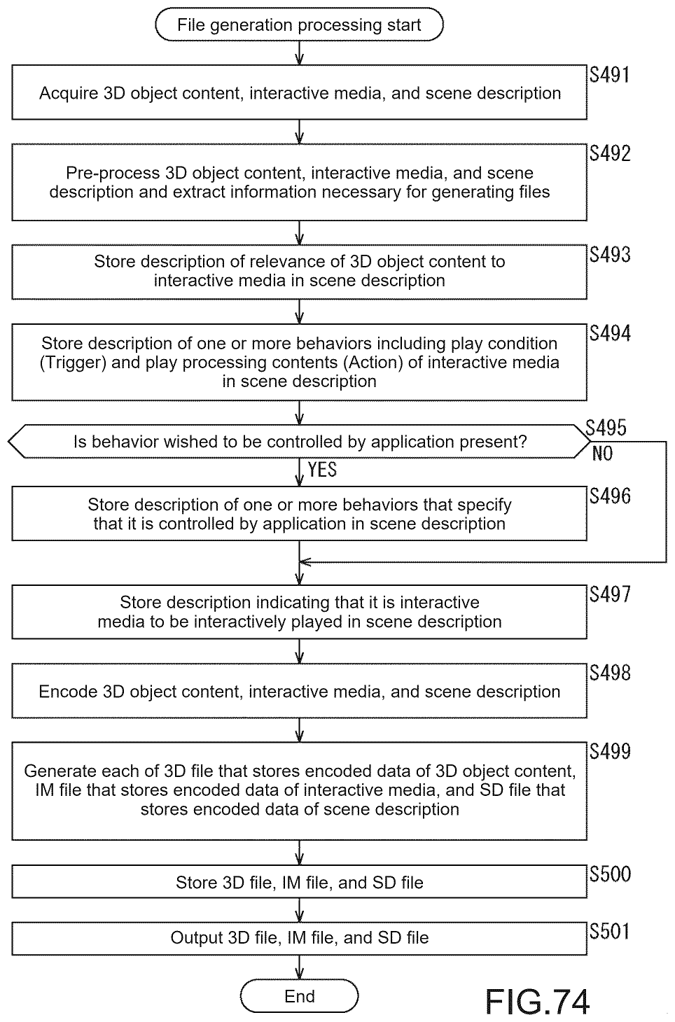

Moreover, Methods 1 and 5 described above may be applied to the file generation apparatus 300. An example of the flow of the file generation processing in that case will be described with reference to the flowchart in FIG. 74.

When the file generation processing has been started, the respective processing in Steps S491 to S494 is executed as in the respective processing in Steps S301 to S304 (FIG. 67).

In Step S495, the SD pre-processing unit 331 determines whether or not a behavior wished to be controlled by the application is present. In a case where Application_control has been set to true and it is determined that the behavior wished to be controlled by the application is present, the processing proceeds to Step S496.

In Step S496, the SD pre-processing unit 331 generates a description of one or more behaviors that specify that they are controlled by the application and stores the description in the scene description.

When the processing in Step S496 ends, the processing proceeds to Step S497. Moreover, in a case where it is, in Step S495, determined that the behavior wished to be controlled by the application is not present, the processing in Step S496 is skipped and the processing proceeds to Step S497.

The respective processing in Steps S497 to S501 is executed as in the respective processing in Steps S305 to S309 (FIG. 67).

When the processing in Step S501 ends, the file generation processing ends.

By executing the respective processing in this manner, the file generation apparatus 300 is capable of applying Methods 1 and 5 of the present technology. Therefore, the media is enabled to be interactively processed by the scene description.

The combination of the methods of the present technology described above are examples and the combination of the methods of the present technology may have any pattern and is not limited to these examples.

### 5. SECOND EMBODIMENT

### <Client Apparatus>

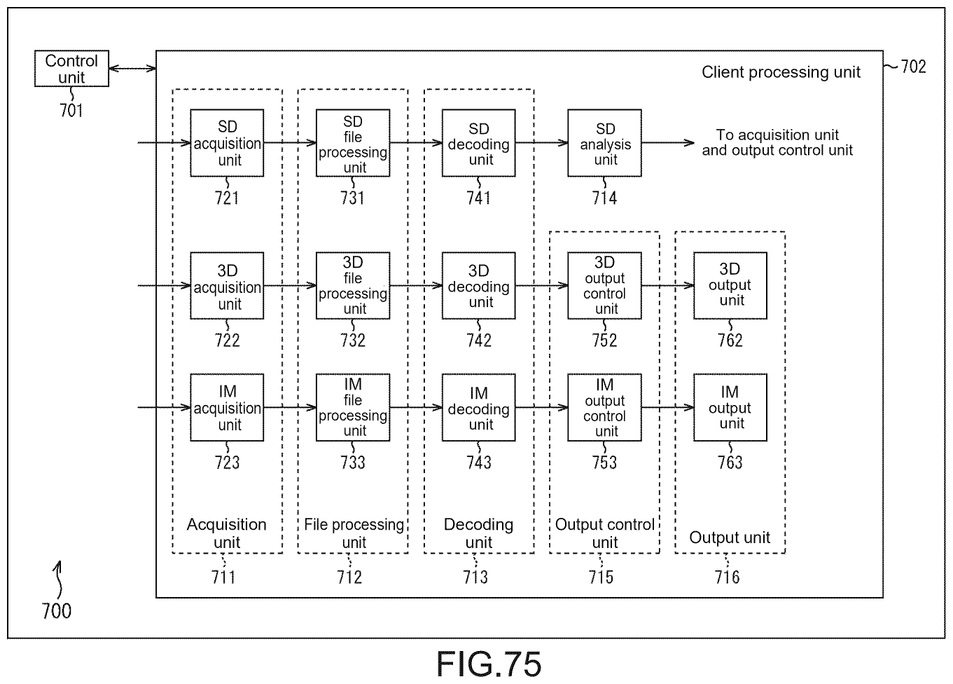

The present technology described above can be applied to any apparatus. FIG. 75 is a block diagram showing an example of a configuration of a client apparatus that is an aspect of the information processing apparatus to which the present technology is applied. A client apparatus 700 shown in FIG. 75 is a play apparatus that performs play processing of 3D data or IM data associated with the 3D data on the basis of the scene description. For example, the client apparatus 700 acquires a file generated by the file generation apparatus 300 and plays the 3D data or the IM data stored in the file.

It should be noted that FIG. 75 shows main elements such as processing units and flows of data and all elements may be provided not be shown in FIG. 75. That is, in the client apparatus 700, processing units not shown as blocks in FIG. 75 may be present and processing and flows of data not shown as the arrows and the like in FIG. 75 may be present.

As shown in FIG. 75, the client apparatus 700 includes a control unit 701 and a client processing unit 702. The control unit 701 performs processing related to control of the client processing unit 702. The client processing unit 702 performs processing related to play of the 3D data or the IM data.

The client processing unit 702 includes an acquisition unit 711, a file processing unit 712, a decoding unit 713, an SD analysis unit 714, an output control unit 715, and an output unit 716.

The acquisition unit 711 performs processing related to acquisition of the data provided from a distribution server, the file generation apparatus 300, or the like to the client apparatus 700. For example, the acquisition unit 711 includes an SD acquisition unit 721, a 3D acquisition unit 722, and an IM acquisition unit 723. The SD acquisition unit 721 acquires an SD file provided from the outside of the client apparatus 700 and provides the SD file to an SD file processing unit 731 of the file processing unit 712. The 3D acquisition unit 722 acquires a 3D file provided from the outside of the client apparatus 700 and provides the 3D file to a 3D file processing unit 732 of the file processing unit 712. The IM acquisition unit 723 acquires an IM file provided from the outside of the client apparatus 700 and provides the IM file to an IM file processing unit 733 of the file processing unit 712.

The file processing unit 712 performs processing related to a file acquired by the acquisition unit 711. For example, the file processing unit 712 may extract data stored in the file. The file processing unit 712 includes the SD file processing unit 731, the 3D file processing unit 732, and the IM file processing unit 733. The SD file processing unit 731 acquires an SD file provided from the SD acquisition unit 721, extracts encoded data of the scene description from the SD file, and provides the encoded data to an SD decoding unit 741. The 3D file processing unit 732 acquires a 3D file provided from the 3D acquisition unit 722, extracts encoded data of the 3D data from the 3D file, and provides the encoded data to a 3D decoding unit 742. The IM file processing unit 733 acquires an IM file provided from the IM acquisition unit 723, extracts encoded data of the IM data from the IM file, and provides the encoded data to an IM decoding unit 743.

The decoding unit 713 performs processing related to decoding of the encoded data provided from the file processing unit 712. The decoding unit 713 includes the SD decoding unit 741, the 3D decoding unit 742, and the IM decoding unit 743. The SD decoding unit 741 decodes the encoded data of the scene description provided from the SD file processing unit 731 to generate (restore) the scene description and provides the decoded data to the SD analysis unit 714. The 3D decoding unit 742 decodes the encoded data of the 3D data provided from the 3D file processing unit 732 to generate (restore) the 3D data and provides the decoded data to a 3D output control unit 752. The IM decoding unit 743 decodes the encoded data of the IM data provided from the IM file processing unit 733 to generate (restore) the IM data and provides the decoded data to an IM output control unit 753.

The SD analysis unit 714 performs processing related to analysis of the scene description. For example, the SD analysis unit 714 acquires a scene description provided from the SD decoding unit 741 and analyzes the scene description. Moreover, the SD analysis unit 714 provides the analysis result or information derived or acquired on the basis of the analysis result to the acquisition unit 711 and the output control unit 715 and controls acquisition of the information and play of the content. That is, the acquisition unit 711 (the 3D acquisition unit 722 and the IM acquisition unit 723) and the output control unit 715 (the 3D output control unit 752 and the IM output control unit 753) execute processing under the control of the SD analysis unit 714. Therefore, it can also be said that the SD analysis unit 714 is a control unit (or an acquisition control unit or a play control unit).

The output control unit 715 performs processing related to output control of the 3D data, the IM data, or the like. For example, the output control unit 715 is capable of performing processing such as rendering by using the 3D data or the IM data. The output control unit 715 includes the 3D output control unit 752 and the IM output control unit 753. The 3D output control unit 752 performs rendering and the like by using the 3D data provided from the 3D decoding unit 742 to generate information (e.g., an image) to be output and provides the information to a 3D output unit 762 of the output unit 716. The IM output control unit 753 performs rendering and the like by using the IM data provided from the IM decoding unit 743 to generate information (e.g., vibration information) to be output and provides the information to an IM output unit 763 of the output unit 716.

It can also be said that the output control unit 715 plays 3D data and IM data. That is, it can also be said that the output control unit 715 is a play unit that plays such data. It can also be said that the 3D output control unit 752 plays the 3D data. That is, it can also be said that the 3D output control unit 752 is a play unit (or a 3D play unit) that plays the 3D data. It can also be said that the IM output control unit 753 plays the IM data. That is, it can also be said that the IM output control unit 753 is a play unit (or an IM play unit) that plays the IM data.

It should be noted that in a case where a behavior related to the preliminary processing is present in the scene description, the IM acquisition unit 723, the IM file processing unit 733, the IM decoding unit 743, and the IM output control unit 753 (which may also include the IM output unit 763) executes preliminary processing related to the interactive media in accordance with the description. Therefore, it can also be said that these processing units are preliminary processing units.

The output unit 716 includes a display device, an audio output device, a haptics device (e.g., a vibration device), and the like and performs processing related to output of the information (image display, audio output, haptic media output (e.g., vibration output), and the like). The output unit 716 includes the 3D output unit 762 and the IM output unit 763. The 3D output unit 762 includes, for example, an image display device such as a display, an audio output device such as a loudspeaker, and the like and outputs information to be output (e.g., a display image and output audio information) of the 3D data provided from the 3D output control unit 752 by using those devices. The IM output unit 763 includes, for example, an output device for the haptic media and the interaction-type media, such as the vibration device, and outputs information to be output (e.g., vibration information) of the media data provided from the IM output control unit 753 by using the output device.

In the client apparatus 700 with the above-mentioned configuration, the above-mentioned first information processing apparatus is employed and in <3. Media Definition Extension for Interactive Play>, the present technology described above may be applied. For example, any one or more of Methods 1 to 5 described above may be applied to this client apparatus 700.

By doing so, the media is enabled to be interactively processed by the scene description.

### <Flow of Play Processing>

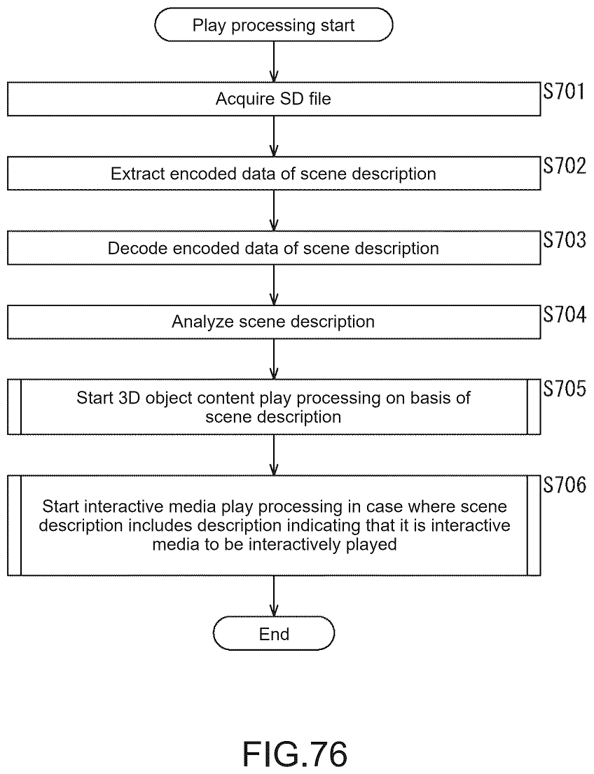

An example of a flow of play processing executed by this client apparatus 700 will be described with reference to the flowchart in FIG. 76.

When the play processing has been started, the SD acquisition unit 721 acquires an SD file in Step S701.

In Step S702, the SD file processing unit 731 extracts encoded data of the scene description stored in the SD file.

In Step S703, the SD decoding unit 741 decodes the extracted encoded data of the scene description to generate (restore) the scene description.

In Step S704, the SD analysis unit 714 analyzes the scene description.

In Step S705, the 3D acquisition unit 722 to the 3D output unit 762 start the 3D object content play processing on the basis of the analyzed scene description.

In Step S706, the IM acquisition unit 723 to the IM output unit 763 start interactive media play processing in a case where a description indicating that it is interactive media to be interactively played is included in the scene description.

When the processing in Step S706 ends, the play processing ends.

### <Flow of 3D Object Content Play Processing>

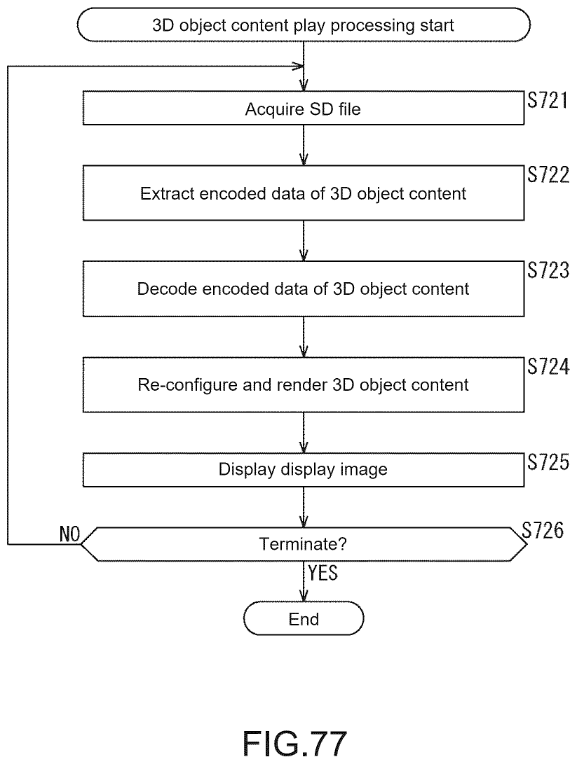

Next, an example of a flow of the 3D object content play processing executed in Step S705 of FIG. 76 will be described with reference to the flowchart in FIG. 77.

When the 3D object content play processing has been started, the 3D acquisition unit 722 acquires a 3D file in Step S721. In Step S722, the 3D file processing unit 732 extracts encoded data of the 3D object content (3D data) from the 3D file. In Step S723, the 3D decoding unit 742 decodes the encoded data of the 3D object content (3D data). In Step S724, the 3D output control unit 752 re-configures the 3D object content (3D data), renders it, and generates a display image. In Step S725, the 3D output unit 762 displays the display image.

In Step S726, the control unit 701 determines whether or not to terminate the 3D object content play processing. In a case where it is determined not to terminate it, the processing returns to Step S721 and such processing and the processing following such processing are repeated. In a case where it is determined to terminate the 3D object content play processing, the 3D object content play processing ends and the processing returns to FIG. 76.

### <Flow 1 of Interactive Media Play Processing>

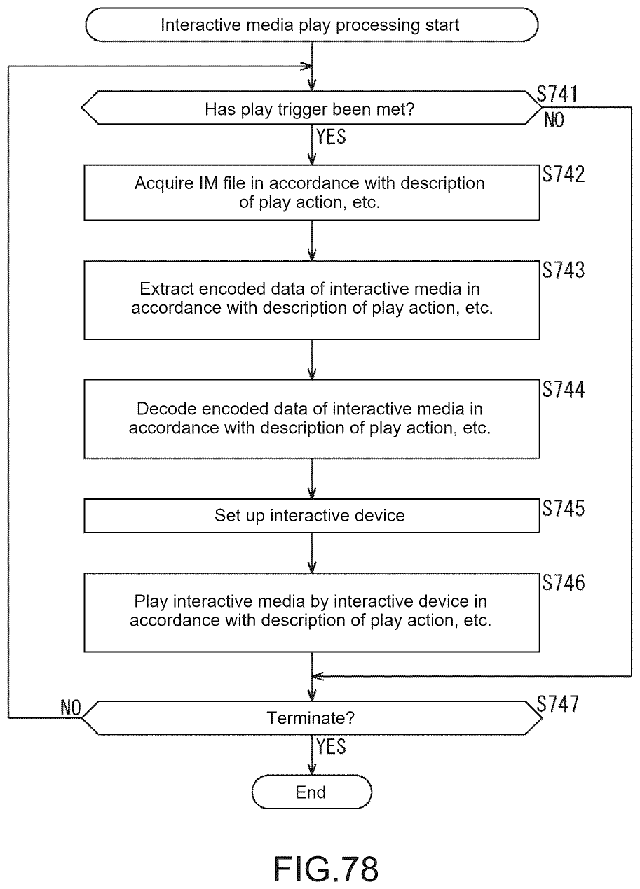

Next, a flow of the interactive media play processing executed in Step S706 of FIG. 76 will be described. As described above, Method 1 described above may be applied to the client apparatus 700. An example of a flow of the interactive media play processing in that case will be described with reference to the flowchart in FIG. 78.

When the interactive media play processing has been started, in Step S741, the IM acquisition unit 723 determines whether or not the execution condition of the interactive play (trigger) has been met on the basis of the analysis result of the scene description by the SD analysis unit 714. In a case where the execution condition of the interactive play which has been described in the scene description has been met, the processing proceeds to Step S742.

In Step S742, the IM acquisition unit 723 acquires the IM file from the outside of the client apparatus 700 in accordance with a description of the processing contents (action) of the interactive play and the like.

In Step S743, the IM file processing unit 733 extracts the encoded data of the interactive media (IM data) from the IM file in accordance with the description of the processing contents (action) of the interactive play and the like.

In Step S744, the IM decoding unit 743 decodes the encoded data in accordance with the description of the processing contents (action) of the interactive play and the like to generate (restore) the interactive media (IM data).

In Step S745, the IM output control unit 753 sets up an interactive device of the IM output unit 763.

In Step S746, in accordance with the description of the processing contents (action) of the interactive play and the like, the IM output control unit 753 plays the generated interactive media (IM data), generates output information, and causes the output information to be output from the interactive device of the IM output unit 763.

When the processing in Step S746 ends, the processing proceeds to Step S747. Moreover, in a case where it is, in Step S741, determined that the execution condition of the interactive play (trigger) has not been met, the processing in Steps S741 to S746 is skipped (omitted) and the processing proceeds to Step S747.

In Step S747, the control unit 701 determines whether or not to terminate the interactive media play processing. In a case where it is determined not to terminate it, the processing returns to Step S741 and such processing and the processing following such processing are repeated. Moreover, in a case where it is, in Step S747, determined to terminate the interactive media play processing, the interactive media play processing ends and the processing returns to FIG. 76.

By executing the respective processing in this manner, the client apparatus 700 is capable of applying Method 1 of the present technology. Therefore, the media is enabled to be interactively processed by the scene description.

### <Flow 2 of Interactive Media Play Processing>

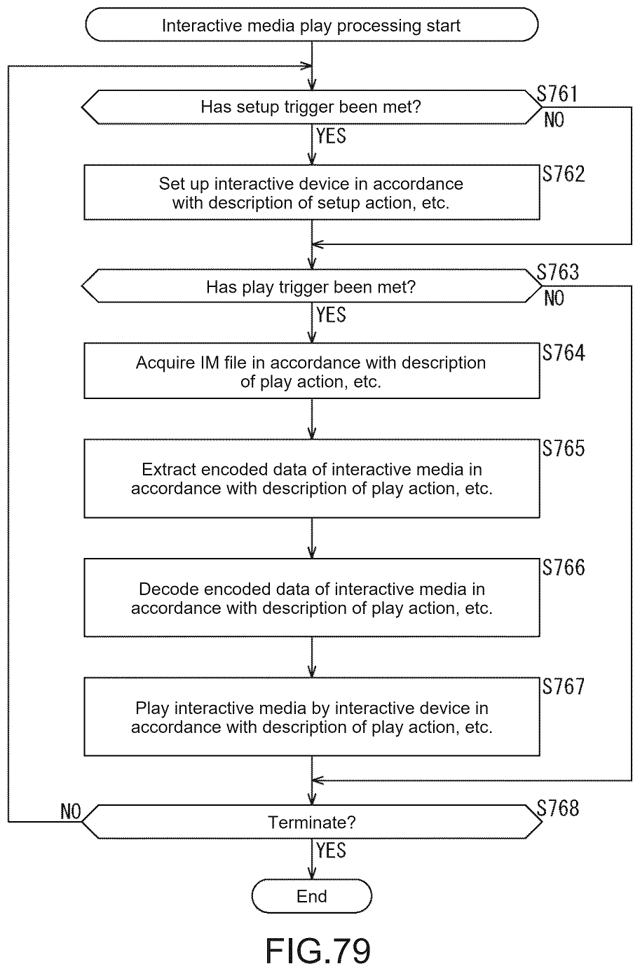

Moreover, Methods 1 and 2 described above may be applied to the client apparatus 700. An example of a flow of the interactive media play processing in that case will be described with reference to the flowchart in FIG. 79.

When the interactive media play processing has been started, in Step S761, the IM output control unit 753 determines whether or not the execution condition (trigger) of the setup of the device has been met. In a case where it is determined that it has been met, the processing proceeds to Step S762.

In Step S762, the IM output control unit 753 sets up the interactive device of the IM output unit 763 in accordance with a description of the processing contents (action) of the setup of the device and the like.

When the setup of the device has been completed, the processing proceeds to Step S763. Moreover, in a case where it is, in Step S761, determined that the execution condition (trigger) of the setup of the device has not been met, the processing in Step S762 is skipped (omitted) and the processing proceeds to Step S763.

The respective processing in Steps S763 to S767 is executed in a similar way to that of the respective processing in Steps S741 to S744 and Step S746 of FIG. 78. When the processing in Step S767 ends, the processing proceeds to Step S768. Moreover, in a case where it is, in Step S763, determined that the execution condition of the interactive play (trigger) has not been met, the processing in Steps S764 to S767 is skipped (omitted) and the processing proceeds to Step S768.

In Step S768, the control unit 701 determines whether or not to terminate the interactive media play processing. In a case where it is determined not to terminate it, the processing returns to Step S761 and such processing and the processing following such processing are repeated. Moreover, in a case where it is, in Step S768, determined to terminate the interactive media play processing, the interactive media play processing ends and the processing returns to FIG. 76.

By executing the respective processing in this manner, the client apparatus 700 is capable of applying Methods 1 and 2 of the present technology. Therefore, the media is enabled to be interactively processed by the scene description.

### <Flow 3 of Interactive Media Play Processing>

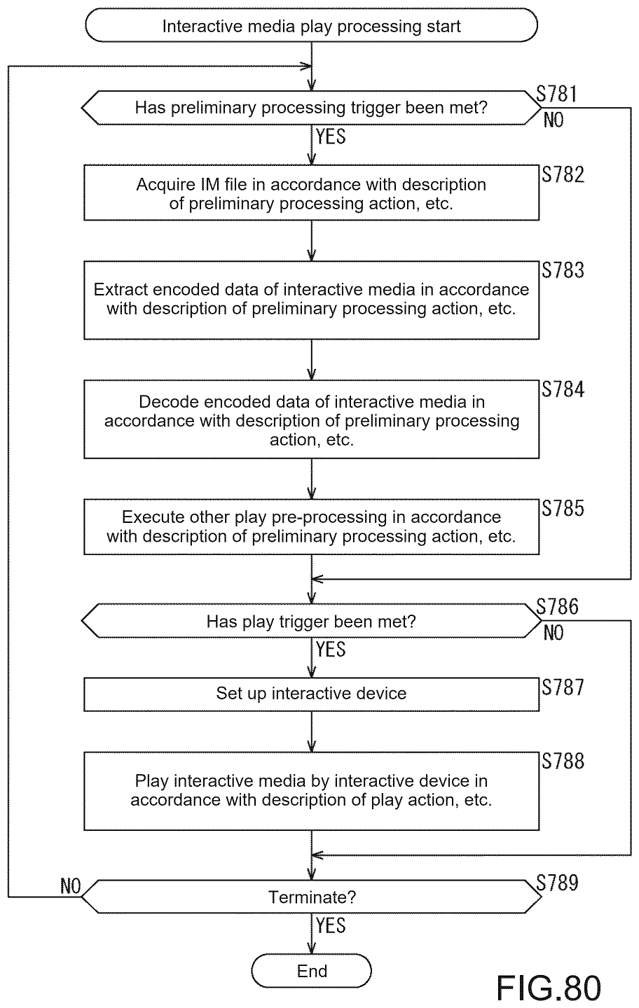

Moreover, Methods 1 and 3 described above may be applied to the client apparatus 700. An example of a flow of the interactive media play processing in that case will be described with reference to the flowchart in FIG. 80.

When the interactive media play processing has been started, in Step S781, the IM acquisition unit 723, the IM file processing unit 733, the IM decoding unit 743, and the IM output control unit 753 (which may include the IM output unit 763) determine whether or not the execution condition (trigger) of the preliminary processing has been met. In a case where it is determined that it has been met, the processing proceeds to Step S782.

In Step S782, the IM acquisition unit 723 acquires an IM file as the preliminary processing in accordance with a description of the processing contents (action) of the preliminary processing and the like. It should be noted that in a case where the processing contents of the preliminary processing do not include the acquisition of the IM file, this processing is skipped (omitted).

In Step S783, the IM file processing unit 733 extracts the encoded data of the interactive media (IM data) from the IM file as the preliminary processing in accordance with a description of the processing contents (action) of the preliminary processing and the like. It should be noted that in a case where the processing contents of the preliminary processing do not include the extraction of the encoded data of the interactive media (IM data), this processing is skipped (omitted).

In Step S784, in accordance with the description of the processing contents (action) of the preliminary processing and the like, the IM decoding unit 743 decodes the encoded data as the preliminary processing to generate (restore) the interactive media (IM data). It should be noted that in a case where the processing contents of the preliminary processing do not include the decoding of the encoded data of the interactive media (IM data), this processing is skipped (omitted).

In Step S785, the IM acquisition unit 723, the IM file processing unit 733, the IM decoding unit 743, and the IM output control unit 753 (which may include the IM output unit 763) execute other processing as the preliminary processing in accordance with the description of the processing contents (action) of the preliminary processing and the like. For example, in a case where the preliminary processing includes setting, release, and the like of the IM data, such processing is also executed. As a matter of course, other processing may be executed. It should be noted that in a case where the processing contents of the preliminary processing do not include the other processing, this processing is skipped (omitted).

When the processing in Step S785 ends, the processing proceeds to Step S786. Moreover, in a case where it is, in Step S781, determined that the execution condition (trigger) of the preliminary processing has not been met, the processing in Steps S782 to S785 is skipped (omitted) and the processing proceeds to Step S786.

The respective processing in Steps S786 to S788 is executed in a similar way to that of the respective processing in Steps S741, S745, and S746 of FIG. 78. Then, when the processing in Step S788 ends, the processing proceeds to Step S789. Moreover, in a case where it is, in Step S786, determined that the execution condition of the interactive play (trigger) has not been met, the processing in Steps S787 and S788 is skipped (omitted) and the processing proceeds to Step S789.

Then, in Step S789, the control unit 701 determines whether or not to terminate the interactive media play processing. In a case where it is determined not to terminate it, the processing returns to Step S781 and such processing and the processing following such processing are repeated. Moreover, in a case where it is, in Step S789, determined to terminate the interactive media play processing, the interactive media play processing ends and the processing returns to FIG. 76.

By executing the respective processing in this manner, the client apparatus 700 is capable of applying Methods 1 and 3 of the present technology. Therefore, the media is enabled to be interactively processed by the scene description.

### <Flow 4 of Interactive Media Play Processing>

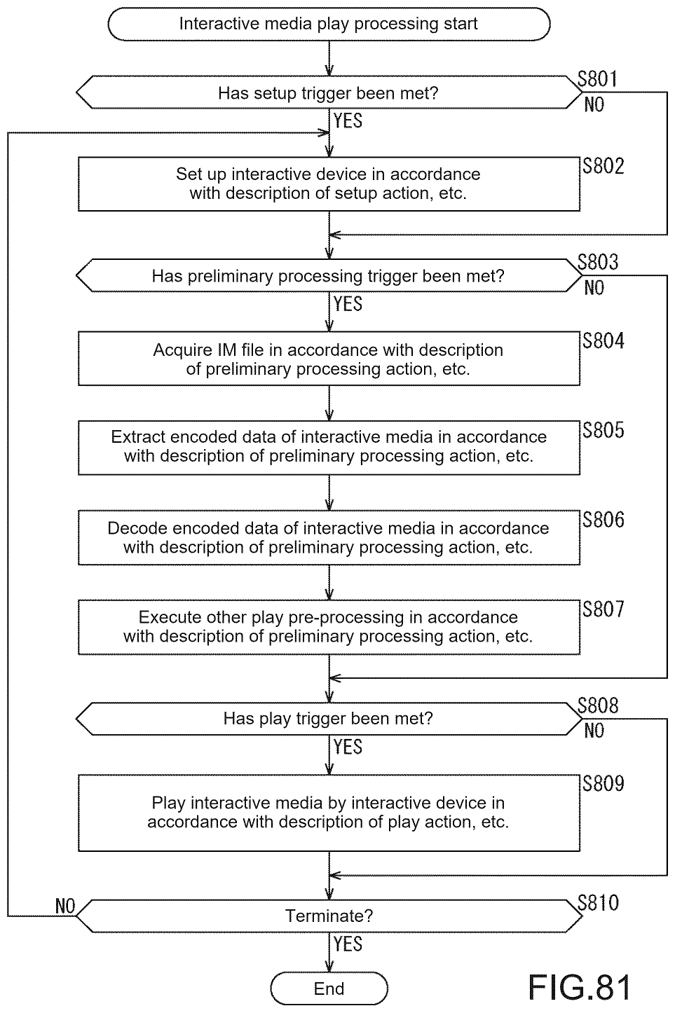

Moreover, Methods 1 to 3 described above may be applied to the client apparatus 700. An example of a flow of the interactive media play processing in that case will be described with reference to the flowchart in FIG. 81.

When the interactive media play processing has been started, the respective processing in Steps S801 and S802 is executed in a similar way to that of the respective processing in Steps S761 and S762 of FIG. 79.

Moreover, the respective processing in Steps S803 to S807 is executed in a similar way to that of the respective processing in Steps S781 to S785 of FIG. 80.

When the processing in Step S807 ends, the processing proceeds to Step S808. Moreover, in a case where it is, in Step S803, determined that the execution condition of the preliminary processing has not been met, the respective processing in Steps S804 to S807 is skipped (omitted) and the processing proceeds to Step S808.

The respective processing in Steps S808 and S809 is executed in a similar way to that of the respective processing in Steps S786 and S788 of FIG. 80. When the processing in Step S788 ends, the processing proceeds to Step S810. Moreover, in a case where it is, in Step S808, determined that the execution condition of the interactive play (trigger) has not been met, the processing in Step S809 is skipped (omitted) and the processing proceeds to Step S810.

Then, in Step S810, the control unit 701 determines whether or not to terminate the interactive media play processing. In a case where it is determined not to terminate it, the processing returns to Step S801 and such processing and the processing following such processing are repeated. Moreover, in a case where it is, in Step S810, determined to terminate the interactive media play processing, the interactive media play processing ends and the processing returns to FIG. 76.

By executing the respective processing in this manner, the client apparatus 700 is capable of applying Methods 1 to 3 of the present technology. Therefore, the media is enabled to be interactively processed by the scene description.

### <Flow 5 of Interactive Media Play Processing>

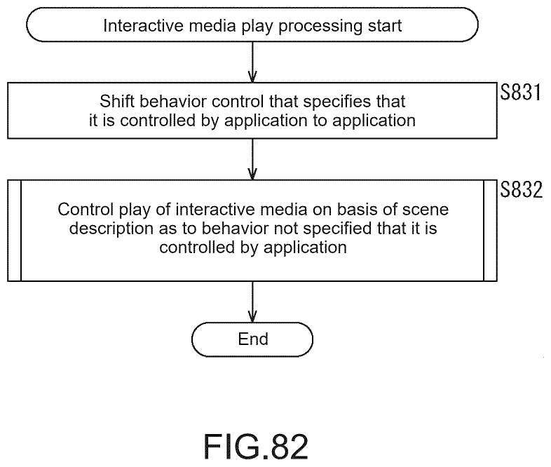

Moreover, Methods 1 and 5 described above may be applied to the client apparatus 700. An example of a flow of the interactive media play processing in that case will be described with reference to the flowchart in FIG. 82.

When the interactive media play processing has been started, in Step S831, the IM output control unit 753 shifts control on a behavior that specifies that it is controlled by the application to the application on the basis of a description of a scene description.

Then, in Step S832, the IM acquisition unit 723, the IM file processing unit 733, the IM decoding unit 743, the IM output control unit 753, and the IM output unit 763 execute the interactive media play processing as described, for example, with reference to FIG. 78, and interactively play the interactive media on the basis of the scene description as to a behavior that does not specify that it is controlled by the application.

When the processing in Step S832 ends, the interactive media play processing ends and the processing returns to FIG. 76.

By executing the respective processing in this manner, the client apparatus 700 is capable of applying Methods 1 and 5 of the present technology. Therefore, the media is enabled to be interactively processed by the scene description.

It should be noted that in Step S832, for example, the interactive media play processing as described with reference to FIG. 79 may be executed. Moreover, the interactive media play processing as described with reference to FIG. 80 may be executed. Moreover, the interactive media play processing as described with reference to FIG. 81 may be executed. That is, Method 2, Method 3, and the like may be applied.

### 6. APPENDIX

### <Combination>

The respective examples (respective methods) of the present technology may be applied in combination with other examples (other methods) as appropriate as long as no contradictions arise. Moreover, the respective examples of the present technology may be applied in combination with technologies other than those described above.

### <Computer>

The above-mentioned series of processing may be executed by hardware or may be executed by software. If the series of processing is executed by software, programs that configure the software are installed in a computer. Here, the computer includes a computer incorporated in dedicated hardware, a general-purpose personal computer, for example, capable of executing various functions by installing various programs, and the like.

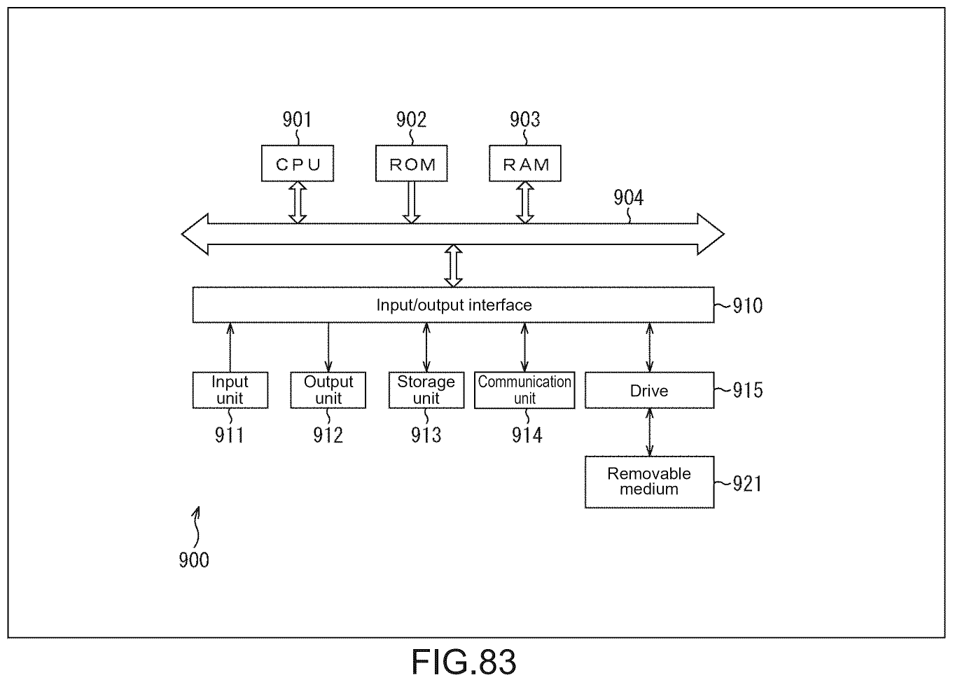

FIG. 83 is a block diagram showing a configuration example of hardware of the computer that executes the above-mentioned series of processing in accordance with the program.

In a computer 900 shown in FIG. 83, a central processing unit (CPU) 901, a read only memory (ROM) 902, and a random access memory (RAM) 903 are connected to one another through a bus 904.

An input/output interface 910 is also connected to the bus 904. An input unit 911, an output unit 912, a storage unit 913, a communication unit 914, and a drive 915 are connected to the input/output interface 910.

The input unit 911 includes, for example, a keyboard, a mouse, a microphone, a touch panel, and an input terminal. The output unit 912 includes, for example, a display, a loudspeaker, and an output terminal. The storage unit 913 includes, for example, a hard disk, a RAM disc, and a nonvolatile memory. The communication unit 914 includes, for example, a network interface. The drive 915 drives a removable medium 921 such as a magnetic disk, an optical disc, a magneto-optical disk, and a semiconductor memory.

In the thus configured computer, the CPU 901 loads, for example, programs stored in the storage unit 913 into the RAM 903 via the input/output interface 910 and the bus 904 and executes them. In this manner, the above-mentioned series of processing is performed. In the RAM 903, data necessary for the CPU 901 to execute various types of processing and the like are also stored as appropriate.

Programs executed by the computer can be, for example, provided recorded on the removable medium 921 that is a package medium. In that case, the program can be installed into the storage unit 913 via the input/output interface 910 by mounting the removable medium 921 on the drive 915.

Moreover, this program can be provided via a wired or wireless transmission medium such as a local area network, the Internet, and digital satellite broadcasting. In that case, the program can be received by the communication unit 914 and can be installed into the storage unit 913.

Otherwise, this program can be installed into the ROM 902 or the storage unit 913 in advance.

### <Applicable Targets of Present Technology>

The present technology can be applied to any encoding and decoding method.

Moreover, the present technology can be applied to any configuration. For example, the present technology can be applied to various electronic apparatuses.

Moreover, for example, the present technology can also be implemented as some configurations of the apparatus such as a processor (e.g., a video processor) serving as a system large scale integration (LSI) or the like, a module (e.g., a video module) using a plurality of processors and the like, a unit (e.g., a video unit) using a plurality of modules and the like, or a set (e.g., a video set) obtained by adding still other additional functions to the unit.

Moreover, for example, the present technology can also be applied to a network system which is constituted by a plurality of apparatuses. For example, the present technology may be implemented as cloud computing that is shared and commonly processed by the plurality of apparatuses via a network. For example, with respect to any terminal such as a computer, an audio visual (AV) apparatus, a portable information processing terminal, or an internet of things (IoT) device, the present technology may be implemented in a cloud service that provides a service related to an image (moving image).

It should be noted that in this specification, the system means a set of a plurality of components (apparatuses, modules (parts), etc.), regardless of whether or not all the components are in the same casing. Therefore, a plurality of apparatuses that has been stored in separate casings and connected via a network and a single apparatus with a casing in which a plurality of modules has been stored are both the system.

<Fields and Applications to which Present Technology can be Applied>

Systems, apparatuses, processing units, and the like to which the present technology is applied can be used in any field, e.g., traffics, medical care, crime prevention, agriculture, livestock industry, mining industry, beauty care, factories, home electronics, weather, and natural monitor. In addition, they are used for any applications.

For example, the present technology can be applied to systems and devices provided for providing content to be viewed and the like. Moreover, for example, the present technology can also be applied to systems and devices provided for traffics such as monitoring traffic conditions and self-driving control. In addition, for example, the present technology can also be applied to systems and devices provided for security. Moreover, for example, the present technology can be applied to systems and devices provided for automatic control on machines and the like. In addition, for example, the present technology can also be applied to systems and devices provided for agriculture and livestock industry. Moreover, the present technology can also be applied to systems and devices that monitor, for example, the conditions of the nature such as volcanoes, forests, and oceans, wild animals, and the like. In addition, for example, the present technology can also be applied to systems and devices provided for sports.

### <Others>

It should be noted that in this specification, the “flag” refers to information for identifying a plurality of states and includes not only information used when identifying two states of true (1) or false (0), but also information capable of identifying three or more states. Therefore, values that this “flag” can take may be, for example, binary values of I/O or may be three or more values. That is, the number of bits that constitute this “flag” is arbitrary and it may be 1 bit or may be a plurality of bits. Moreover, as to the identification information (also including the flag), it is assumed not only the identification information is included in the bitstream, but also that difference information of identification information with respect to some reference information is included in the bitstream. Therefore, in this specification, as to the “flag” and the “identification information,” not only the information, but also difference information with respect to the reference information are also encompassed.

Moreover, various types of information (metadata, etc.) regarding the encoded data (bitstream) may be transmitted or recorded in any form as long as it is associated with the encoded data. Here, the term “associated” means, for example, that one piece of data can be used (can be linked) when the other data is processed. That is, the data associated with each other may be combined as single data or may be discrete pieces of data. For example, the information associated with the encoded data (image) may be transmitted on a communication channel different from the encoded data (image). Moreover, for example, the information associated with the encoded data (image) may be recorded on a recording medium different from the encoded data (image) (or another recording area of the same recording medium). It should be noted that this “association” may be not only the entire data, but also part of the data. For example, an image and information corresponding to the image may be associated with each other in any unit such as a plurality of frames, one frame, or a part of a frame.

It should be noted that in this specification, the terms “synthesize,” “multiplex,” “add,” “integrate,” “include,” “store,” “input,” “put in,” “insert,” and the like mean combining a plurality of objects into one, for example, combining the encoded data and the metadata into a single piece of data, and mean a single method of “associating” described above.

Embodiments of the present technology are not limited to the above-mentioned embodiments and various modifications can be made without departing from the gist of the present technology.

For example, the configuration described as a single apparatus (or processing unit) may be divided to constitute it as a plurality of apparatuses (or processing units). On the contrary, configurations described above as a plurality of apparatuses (or processing units) may be combined and configured as the single apparatus (or the processing unit). Moreover, configurations other than those described above may be added to the configuration of each apparatus (or respective processing unit) as a matter of course. In addition, as long as the configurations and the operations are substantially the same as a whole of the system, some configurations of a certain apparatus (or processing unit) may be included in the configurations of the other apparatus (or the other processing unit).

Moreover, for example, the above-mentioned program may be executed in any apparatus. In that case, it is sufficient to enable the apparatus to have necessary functions (functional blocks, etc.) and be capable of obtaining necessary information.

Moreover, for example, the single apparatus may be enabled to execute the respective steps of a single flowchart so that the plurality of apparatuses shares and executes them. In addition, in a case where a single step includes a plurality of processes, the plurality of processes may be executed by the single apparatus and may be shared and executed by the plurality of apparatuses. In other words, the plurality of processes included in a single step may be executed as processing of a plurality of steps. On the contrary, the processing described as a plurality of steps may be combined and executed as a single step.

Moreover, for example, as to the program executed by the computer, the processing of the step of describing the program may be executed in chronological order according to the sequence described herein, or in parallel, or individually at a necessary timing such as when a call is made. That is, as long as no contradictions arise, the processing in the respective steps may be executed in an order different from the above-mentioned order. In addition, the processing of the step of describing this program may executed in parallel with processing of another program or may be executed in combination with the processing of the other program.

Moreover, for example, a plurality of technologies related to the present technology can be each independently implemented alone as long as no contradictions arise. As a matter of course, any plurality of the present technologies can also be implemented in combination. For example, some or all of the present technologies described in any embodiment can also be implemented in combination with some or all of the present technologies described in the other embodiments. Moreover, a part of or the entire any present technology described above can also be implemented at the same time as other technologies not described above.

It should be noted that the present technology can also take the following configurations.
(1) An information processing apparatus, including
a play unit that interactively plays, in a case where an execution condition of interactive play specified in a scene description has been met, interactive media specified to be interactively played in the scene description in accordance with processing contents of the interactive play specified in the scene description, in which
the interactive play is a play method of playing media as interactive processing, and
the interactive processing is interaction-type processing of executing the processing contents specified in the scene description in a case where the execution condition specified in the scene description has been met.
(2) The information processing apparatus according to (1), in which
in the scene description,
   as a description with respect to the media to be referenced in accordance with the scene description, any one of start time specification, autoplay specification, or interactive play specification is present, and
   the interactive media are specified to be interactively played by using the interactive play specification whose value is true,
the play unit interactively plays the interactive media in accordance with the processing contents of the interactive play in a case where the execution condition of the interactive play has been met,
the start time specification is a description to specify a play start time of the media,
the autoplay specification is a description to specify whether to start playing the media as soon as the media are ready, and
the interactive play specification is a description to specify whether to interactively play the media.
(3) The information processing apparatus according to (1), in which
in the scene description,
   as a description with respect to the media to be referenced in accordance with the scene description, the interactive play specification is capable of being present in a case where the value of the autoplay specification is false, and
   the interactive media are specified to be interactively played by using the autoplay specification whose value is false and the interactive play specification whose value is true,
the play unit interactively plays the interactive media in accordance with the processing contents of the interactive play in a case where the execution condition of the interactive play has been met,
the autoplay specification is a description to specify whether to start playing the media as soon as the media are ready, and
the interactive play specification is a description to specify whether to interactively play the media.
(4) The information processing apparatus according to (1), in which
in the scene description,
   as a description with respect to the media to be referenced in accordance with the scene description, other method specification is capable of being present in a case where the value of the autoplay specification is false, and
   the interactive media are specified to be interactively played by using the autoplay specification whose value is false and the interactive play specification whose value is true,
the play unit interactively plays the interactive media in accordance with the processing contents of the interactive play in a case where the execution condition of the interactive play has been met,
the autoplay specification is a description to specify whether to start playing the media as soon as the media are ready,
the other method specification is a description to specify whether to apply a play method other than specified-time play and autoplay,
the specified-time play is a play method of starting playing the media at a specified time,
the autoplay is a play method of starting playing the media as soon as the media are ready, and
the interactive play specification is one of the other method specification and is a description to specify whether to interactively play the media.
(5) The information processing apparatus according to (1), in which
in the scene description,
   as a description with respect to the media to be referenced in accordance with the scene description, in a case where the value of the autoplay specification is false, it is considered that it has been specified to play the media as the interactive processing,
   the interactive media are specified to be interactively played by using the autoplay specification whose value is false,
the play unit interactively plays the interactive media in accordance with the processing contents of the interactive play in a case where the execution condition of the interactive play has been met, and
the autoplay specification is a description to specify whether to start playing the media as soon as the media are ready.
(6) The information processing apparatus according to (1), in which
in the scene description,
   as a description with respect to the media to be referenced in accordance with the scene description, the interactive play specification is capable of being present in a case where start time specification is a negative value, and
   the interactive media are specified to be interactively played by using the start time specification that is the negative value and the interactive play specification whose value is true,
the play unit interactively plays the interactive media in accordance with the processing contents of the interactive play in a case where the execution condition of the interactive play has been met,
the start time specification is a description to specify a play start time of the media, and
the interactive play specification is a description to specify whether to interactively play the media.
(7) The information processing apparatus according to (1), in which
in the scene description,
   as a description with respect to the media to be referenced in accordance with the scene description, other method specification is capable of being present in a case where the start time specification is a negative value, and
   the interactive media are specified to be interactively played by using the start time specification that is the negative value and the interactive play specification whose value is true,
the play unit interactively plays the interactive media in accordance with the processing contents of the interactive play in a case where the execution condition of the interactive play has been met,
the start time specification is a description to specify a play start time of the media,
the other method specification is a description to specify whether to apply a play method other than specified-time play and autoplay,
the specified-time play is a play method of starting playing the media at a specified time,
the autoplay is a play method of starting playing the media as soon as the media are ready, and
the interactive play specification is one of the other method specification and is a description to specify whether to interactively play the media.
(8) The information processing apparatus according to (1), in which
in the scene description,
   as a description with respect to the media to be referenced in accordance with the scene description, it is considered that it has been specified to play the media as the interactive processing in a case where the start time specification is a negative value, and
   the interactive media are specified to be interactively played by using the start time specification that is the negative value,
the play unit interactively plays the interactive media in accordance with the processing contents of the interactive play in a case where the execution condition of the interactive play has been met, and
the start time specification is a description to specify a play start time of the media.
(9) The information processing apparatus according to any of (1) to (8), in which
in the scene description, setup of a device that outputs the interactive media has been specified as a type of processing contents of the interactive processing, and
the play unit sets up the device in accordance with the processing contents of the interactive processing in a case where the execution condition of the interactive processing has been met.
(10) The information processing apparatus according to (9), in which
in the scene description, the execution condition of the setup of the device has been set to be met preceding the execution condition of the interactive play.
(11) The information processing apparatus according to (9) or (10), in which
in the scene description, a processing target of the setup has been specified by using an index of the device, and
the play unit sets up the device specified as the processing target.
(12) The information processing apparatus according to any of (9) to (11), in which
in the scene description, as contents of the setup, it has been specified that the device is enabled to output the interactive media, and
the play unit sets up the device so that the interactive media are enabled to be played in accordance with the specification of the contents.
(13) The information processing apparatus according to any of (9) to (11), in which
in the scene description, as contents of the setup, it has been specified to set up the device initialized, and
the play unit sets up the initialized device in accordance with the specification of the contents.
(14) The information processing apparatus according to any of (9) to (11), in which
in the scene description, as contents of the setup, it has been specified to update processing contents and a processing mode to be executed by the device, and
the play unit sets up the device to update processing contents and a processing mode to be executed by the device in accordance with the specification of the contents.
(15) The information processing apparatus according to any of (1) to (14), in which
in the scene description, as the type of the processing contents of the interactive processing, it has been specified to execute preliminary processing on the interactive media before the interactive media are interactively played, further including
a preliminary processing unit that executes the preliminary processing in accordance with the processing contents of the interactive processing in a case where the execution condition of the interactive processing has been met.
(16) The information processing apparatus according to (15), in which
in the scene description, a processing target of the preliminary processing has been specified by using an index of the media, and
the preliminary processing unit executes the preliminary processing on the interactive media specified as the processing target.
(17) The information processing apparatus according to (15), in which
in the scene description, as contents of the preliminary processing, acquisition of the interactive media has been specified, and
the preliminary processing unit acquires encoded data of the interactive media as the preliminary processing in accordance with the specification of the contents.
(18) The information processing apparatus according to (15), in which
in the scene description, as contents of the preliminary processing, acquisition and decoding of the interactive media have been specified, and
the preliminary processing unit acquires and decodes encoded data of the interactive media as the preliminary processing in accordance with the specification of the contents.
(19) The information processing apparatus according to (15), in which
in the scene description, as contents of the preliminary processing, acquisition, decoding, and transformation of the interactive media have been specified, and
the preliminary processing unit acquires and decodes encoded data of the interactive media as the preliminary processing and transforms the decoded interactive media in accordance with properties of a device that outputs the interactive media in accordance with the specification of the contents.
(20) The information processing apparatus according to (15), in which
in the scene description, as contents of the preliminary processing, setting of the interactive media has been specified, and
the preliminary processing unit sets the interactive media to a memory of a device that outputs the interactive media as the preliminary processing in accordance with the specification of the contents.
(21) The information processing apparatus according to (15), in which
in the scene description, as contents of the preliminary processing, deletion of the interactive media has been specified, and
the preliminary processing unit deletes the interactive media set to a memory of a device that outputs the interactive media as the preliminary processing in accordance with the specification of the contents.
(22) The information processing apparatus according to any of (1) to (21), in which
in the scene description, a behavior specified to show an execution condition and processing contents of preliminary processing executed on the interactive media before the interactive media are interactively played has been described, further including
a preliminary processing unit that executes the preliminary processing in accordance with the behavior.
(23) The information processing apparatus according to any of (1) to (21), in which
in the scene description, an execution condition which has been specified to be for preliminary processing executed on the interactive media before the interactive media are interactively played and processing contents which have been specified to be for the preliminary processing have been described, further including
a preliminary processing unit that executes the preliminary processing in accordance with the processing contents for the preliminary processing in a case where the execution condition for the preliminary processing has been met.
(24) The information processing apparatus according to (1) to (23), in which
in the scene description, a behavior specified to control the interactive processing in an application has been described, and
the play unit causes the application to control the interactive processing in accordance with the behavior.
(25) An information processing method, including
interactively playing, in a case where an execution condition of interactive play specified in a scene description has been met, interactive media specified to be interactively played in the scene description in accordance with processing contents of the interactive play specified in the scene description, in which
the interactive play is a play method of playing media as interactive processing, and
the interactive processing is interaction-type processing of executing the processing contents specified in the scene description in a case where the execution condition specified in the scene description has been met.
(31) An information processing apparatus, including
a providing unit that provides a scene description in which a description to specify that interactive media are to be interactively played and a description to specify an execution condition and processing contents of the interactive play are present, in which
the interactive play is a play method of playing media as interactive processing, and
the interactive processing is interaction-type processing of executing the processing contents specified in the scene description in a case where the execution condition specified in the scene description has been met.
(32) The information processing apparatus according to (31), in which
in the scene description,
   as a description with respect to the media to be referenced in accordance with the scene description, any one of start time specification, autoplay specification, or interactive play specification is present, and
   the interactive media are specified to be interactively played by interactive play specification whose value is true,
the start time specification is a description to specify a play start time of the media,
the autoplay specification is a description to specify whether to start playing the media as soon as the media are ready, and
the interactive play specification is a description to specify whether to interactively play the media.
(33) The information processing apparatus according to (31), in which
in the scene description,
   as a description with respect to the media to be referenced in accordance with the scene description, the interactive play specification is capable of being present in a case where the value of the autoplay specification is false, and
   the interactive media are specified to be interactively played by the autoplay specification whose value is false and the interactive play specification whose value is true, and
the autoplay specification is a description to specify whether to start playing the media as soon as the media are ready, and
the interactive play specification is a description to specify whether to interactively play the media.
(34) The information processing apparatus according to (31), in which
in the scene description,
   as a description with respect to the media to be referenced in accordance with the scene description, other method specification is capable of being present in a case where the value of the autoplay specification is false, and
   the interactive media are specified to be interactively played by the autoplay specification whose value is false and the interactive play specification whose value is true,
the autoplay specification is a description to specify whether to start playing the media as soon as the media are ready,
the other method specification is a description to specify whether to apply a play method other than specified-time play and autoplay,
the specified-time play is a play method of starting playing the media at a specified time,
the autoplay is a play method of starting playing the media as soon as the media are ready, and
the interactive play specification is one of the other method specification and is a description to specify whether to interactively play the media.
(35) The information processing apparatus according to (31), in which
in the scene description,
   in a case where the value of the autoplay specification described with respect to the media to be referenced in accordance with the scene description is false, it is considered that the media has been specified to be interactively played, and
   the interactive media are specified to be interactively played by using the autoplay specification whose value is false, and
the autoplay specification is a description to specify whether to start playing the media as soon as the media are ready.
(36) The information processing apparatus according to (31), in which
in the scene description,
   as a description with respect to the media to be referenced in accordance with the scene description, the interactive play specification is capable of being present in a case where start time specification is a negative value, and
   the interactive media are specified to be interactively played by the start time specification that is the negative value and the interactive play specification whose value is true,
the start time specification is a description to specify a play start time of the media, and
the interactive play specification is a description to specify whether to interactively play the media.
(37) The information processing apparatus according to (31), in which
in the scene description,
   as a description with respect to the media to be referenced in accordance with the scene description, other method specification is capable of being present in a case where the start time specification is a negative value, and
   the interactive media are specified to be interactively played by the start time specification that is the negative value and the interactive play specification whose value is true,
the start time specification is a description to specify a play start time of the media,
the other method specification is a description to specify whether to apply a play method other than specified-time play and autoplay,
the specified-time play is a play method of starting playing the media at a specified time,
the autoplay is a play method of starting playing the media as soon as the media are ready, and
the interactive play specification is one of the other method specification and is a description to specify whether to interactively play the media.
(38) The information processing apparatus according to (31), in which
in the scene description,
   in a case where start time specification described with respect to the media to be referenced in accordance with the scene description is a negative value, it is considered that the media has been specified to be interactively played, and
   the interactive media are specified to be interactively played by using the start time specification that is the negative value, and
the start time specification is a description to specify a play start time of the media.
(39) The information processing apparatus according to any of (31) to (38), in which
in the scene description, as a type of the processing contents of the interactive processing with respect to the interactive media, setup of a device that outputs the interactive media has been specified.
(40) The information processing apparatus according to (39), in which
in the scene description, the execution condition with respect to the setup of the device has been set to be met preceding the execution condition with respect to the interactive play of the media.
(41) The information processing apparatus according to (39) or (40), in which
in the scene description, a processing target of the setup has been specified by using an index of the device.
(42) The information processing apparatus according to any of (39) to (41), in which
in the scene description, as contents of the setup, it has been specified that the device is enabled to output the interactive media.
(43) The information processing apparatus according to any of (39) to (41), in which
in the scene description, as contents of the setup, it has been specified to set up the device initialized.
(44) The information processing apparatus according to any of (39) to (41), in which
in the scene description, as contents of the setup, update processing contents and a processing mode to be executed by the device have been specified.
(45) The information processing apparatus according to any of (1) to (44), in which
in the scene description, as the type of the processing contents of the interactive processing with respect to the interactive media, it has been specified to execute the preliminary processing on the interactive media before the interactive media are interactively played.
(46) The information processing apparatus according to (45), in which
in the scene description, a processing target of the preliminary processing has been specified by using the index of the media.
(47) The information processing apparatus according to (45), in which
in the scene description, as contents of the preliminary processing, acquisition of the interactive media has been specified.
(48) The information processing apparatus according to (45), in which
in the scene description, as contents of the preliminary processing, acquisition and decoding of the interactive media has been specified.
(49) The information processing apparatus according to (45), in which
in the scene description, as contents of the preliminary processing, acquisition, decoding, and transformation of the interactive media have been specified.
(50) The information processing apparatus according to (45), in which
in the scene description, as contents of the preliminary processing, it has been specified to set the interactive media to a memory of a device that outputs the interactive media.
(51) The information processing apparatus according to (45), in which
in the scene description, as contents of the preliminary processing, deletion of the interactive media has been specified.
(52) The information processing apparatus according to any of (31) to (51), in which
in the scene description, a behavior specified to show an execution condition and processing contents of preliminary processing executed on the interactive media before the interactive media are interactively played has been described.
(53) The information processing apparatus according to any of (31) to (51), in which
in the scene description, an execution condition which has been specified to be for preliminary processing executed on the interactive media before the interactive media are interactively played and processing contents which have been specified to be for the preliminary processing have been described.
(54) The information processing apparatus according to any of (31) to (53), in which
in the scene description, a behavior specified to control the interactive processing in an application has been described.
(55) An information processing method, including
providing a scene description in which a description to specify that interactive media are to be interactively played and a description to specify an execution condition and processing contents of the interactive play are present, in which
the interactive play is a play method of playing media as interactive processing, and
the interactive processing is interaction-type processing of executing the processing contents specified in the scene description in a case where the execution condition specified in the scene description has been met.

### REFERENCE SIGNS LIST

300 file generation apparatus
301 control unit
302 file generation processing unit
311 input unit
312 pre-processing unit
313 encoding unit
314 file generation unit
315 storage unit
316 output unit
321 SD input unit
322 3D input unit
323 IM input unit
331 SD pre-processing unit
332 3D pre-processing unit
333 IM pre-processing unit
341 SD encoding unit
342 3D encoding unit
343 IM encoding unit
351 SD file generation unit
352 3D file generation unit
353 IM file generation unit
361 SD storage unit
362 3D storage unit
363 IM storage unit
371 SD output unit
372 3D output unit
373 IM output unit
700 client apparatus
701 control unit
702 client processing unit
711 acquisition unit
712 file processing unit
713 decoding unit
714 SD analysis unit
715 output control unit
716 output unit
721 SD acquisition unit
722 3D acquisition unit
723 IM acquisition unit
731 SD file processing unit
732 3D file processing unit
733 IM file processing unit
741 SD decoding unit
742 3D decoding unit
743 IM decoding unit
752 3D output control unit
753 IM output control unit
762 3D output unit
763 IM output unit
900 computer

1. An information processing apparatus, comprising
a play unit that interactively plays, in a case where an execution condition of interactive play specified in a scene description has been met, interactive media specified to be interactively played in the scene description in accordance with processing contents of the interactive play specified in the scene description, wherein
the interactive play is a play method of playing media as interactive processing, and
the interactive processing is interaction-type processing of executing the processing contents specified in the scene description in a case where the execution condition specified in the scene description has been met.

2. The information processing apparatus according to claim 1, wherein
in the scene description,
as a description with respect to the media to be referenced in accordance with the scene description, any one of start time specification, autoplay specification, or interactive play specification is present, and
the interactive media are specified to be interactively played by using the interactive play specification whose value is true,
the play unit interactively plays the interactive media in accordance with the processing contents of the interactive play in a case where the execution condition of the interactive play has been met,
the start time specification is a description to specify a play start time of the media,
the autoplay specification is a description to specify whether to start playing the media as soon as the media are ready, and
the interactive play specification is a description to specify whether to interactively play the media.

3. The information processing apparatus according to claim 1, wherein
in the scene description,
as a description with respect to the media to be referenced in accordance with the scene description, the interactive play specification is capable of being present in a case where the value of the autoplay specification is false, and
the interactive media are specified to be interactively played by using the autoplay specification whose value is false and the interactive play specification whose value is true,
the play unit interactively plays the interactive media in accordance with the processing contents of the interactive play in a case where the execution condition of the interactive play has been met,
the autoplay specification is a description to specify whether to start playing the media as soon as the media are ready, and
the interactive play specification is a description to specify whether to interactively play the media.

4. The information processing apparatus according to claim 1, wherein
in the scene description,
as a description with respect to the media to be referenced in accordance with the scene description, other method specification is capable of being present in a case where the value of the autoplay specification is false, and
the interactive media are specified to be interactively played by using the autoplay specification whose value is false and the interactive play specification whose value is true,
the play unit interactively plays the interactive media in accordance with the processing contents of the interactive play in a case where the execution condition of the interactive play has been met,
the autoplay specification is a description to specify whether to start playing the media as soon as the media are ready,
the other method specification is a description to specify whether to apply a play method other than specified-time play and autoplay,
the specified-time play is a play method of starting playing the media at a specified time,
the autoplay is a play method of starting playing the media as soon as the media are ready, and
the interactive play specification is one of the other method specification and is a description to specify whether to interactively play the media.

5. The information processing apparatus according to claim 1, wherein
in the scene description,
as a description with respect to the media to be referenced in accordance with the scene description, in a case where the value of the autoplay specification is false, it is considered that it has been specified to play the media as the interactive processing,
the interactive media are specified to be interactively played by using the autoplay specification whose value is false,
the play unit interactively plays the interactive media in accordance with the processing contents of the interactive play in a case where the execution condition of the interactive play has been met, and
the autoplay specification is a description to specify whether to start playing the media as soon as the media are ready.

6. The information processing apparatus according to claim 1, wherein
in the scene description,
as a description with respect to the media to be referenced in accordance with the scene description, the interactive play specification is capable of being present in a case where start time specification is a negative value, and
the interactive media are specified to be interactively played by using the start time specification that is the negative value and the interactive play specification whose value is true,
the play unit interactively plays the interactive media in accordance with the processing contents of the interactive play in a case where the execution condition of the interactive play has been met,
the start time specification is a description to specify a play start time of the media, and
the interactive play specification is a description to specify whether to interactively play the media.

7. The information processing apparatus according to claim 1, wherein
in the scene description,
as a description with respect to the media to be referenced in accordance with the scene description, other method specification is capable of being present in a case where the start time specification is a negative value, and
the interactive media are specified to be interactively played by using the start time specification that is the negative value and the interactive play specification whose value is true,
the play unit interactively plays the interactive media in accordance with the processing contents of the interactive play in a case where the execution condition of the interactive play has been met,
the start time specification is a description to specify a play start time of the media,
the other method specification is a description to specify whether to apply a play method other than specified-time play and autoplay,
the specified-time play is a play method of starting playing the media at a specified time,
the autoplay is a play method of starting playing the media as soon as the media are ready, and
the interactive play specification is one of the other method specification and is a description to specify whether to interactively play the media.

8. The information processing apparatus according to claim 1, wherein
in the scene description,
as a description with respect to the media to be referenced in accordance with the scene description, it is considered that it has been specified to play the media as the interactive processing in a case where the start time specification is a negative value, and
the interactive media are specified to be interactively played by using the start time specification that is the negative value,
the play unit interactively plays the interactive media in accordance with the processing contents of the interactive play in a case where the execution condition of the interactive play has been met, and
the start time specification is a description to specify a play start time of the media.

9. The information processing apparatus according to claim 1, wherein
in the scene description, setup of a device that outputs the interactive media has been specified as a type of processing contents of the interactive processing, and
the play unit sets up the device in accordance with the processing contents of the interactive processing in a case where the execution condition of the interactive processing has been met.

10. The information processing apparatus according to claim 9, wherein
in the scene description, the execution condition of the setup of the device has been set to be met preceding the execution condition of the interactive play.

11. The information processing apparatus according to claim 1, wherein
in the scene description, as the type of the processing contents of the interactive processing, it has been specified to execute preliminary processing on the interactive media before the interactive media are interactively played, further comprising
a preliminary processing unit that executes the preliminary processing in accordance with the processing contents of the interactive processing in a case where the execution condition of the interactive processing has been met.

12. The information processing apparatus according to claim 1, wherein
in the scene description, a behavior specified to show an execution condition and processing contents of preliminary processing executed on the interactive media before the interactive media are interactively played has been described, further comprising
a preliminary processing unit that executes the preliminary processing in accordance with the behavior.

13. The information processing apparatus according to claim 1, wherein
in the scene description, a behavior specified to control the interactive processing in an application has been described, and
the play unit causes the application to control the interactive processing in accordance with the behavior.

14. An information processing method, comprising
interactively playing, in a case where an execution condition of interactive play specified in a scene description has been met, interactive media specified to be interactively played in the scene description in accordance with processing contents of the interactive play specified in the scene description, wherein
the interactive play is a play method of playing media as interactive processing, and
the interactive processing is interaction-type processing of executing the processing contents specified in the scene description in a case where the execution condition specified in the scene description has been met.

15. An information processing apparatus, comprising
a providing unit that provides a scene description in which a description to specify that interactive media are to be interactively played and a description to specify an execution condition and processing contents of the interactive play are present, wherein
the interactive play is a play method of playing media as interactive processing, and
the interactive processing is interaction-type processing of executing the processing contents specified in the scene description in a case where the execution condition specified in the scene description has been met.

16. The information processing apparatus according to claim 15, wherein
in the scene description,
as a description with respect to the media to be referenced in accordance with the scene description, any one of start time specification, autoplay specification, or interactive play specification is present, and
the interactive media are specified to be interactively played by interactive play specification whose value is true,
the start time specification is a description to specify a play start time of the media,
the autoplay specification is a description to specify whether to start playing the media as soon as the media are ready, and
the interactive play specification is a description to specify whether to interactively play the media.

17. The information processing apparatus according to claim 15, wherein
in the scene description,
in a case where the value of the autoplay specification described with respect to the media to be referenced in accordance with the scene description is false, it is considered that the media has been specified to be interactively played, and
the interactive media are specified to be interactively played by using the autoplay specification whose value is false, and
the autoplay specification is a description to specify whether to start playing the media as soon as the media are ready.

18. The information processing apparatus according to claim 15, wherein
in the scene description,
in a case where start time specification described with respect to the media to be referenced in accordance with the scene description is a negative value, it is considered that the media has been specified to be interactively played, and
the interactive media are specified to be interactively played by using the start time specification that is the negative value, and
the start time specification is a description to specify a play start time of the media.

19. The information processing apparatus according to claim 15, wherein
in the scene description, a behavior specified to control the interactive processing in an application has been described.

20. An information processing method, comprising
providing a scene description in which a description to specify that interactive media are to be interactively played and a description to specify an execution condition and processing contents of the interactive play are present, wherein
the interactive play is a play method of playing media as interactive processing, and
the interactive processing is interaction-type processing of executing the processing contents specified in the scene description in a case where the execution condition specified in the scene description has been met.
